(19) United States
(12) Patent Application Publication
(10) Pub. No.: US 2024/0051874 A1
(43) Pub. Date: Feb. 15, 2024

(54) ALKALINE ACTIVATED CEMENT METHODS AND COMPOSITIONS

(71) Applicant: MATERIAL. EVOLUTION LTD., Belfast (GB)

(72) Inventors: Eric WITT, Campbell, CA (US); Elizabeth GILLIGAN, Belfast (GB)

(21) Appl. No.: 18/382,989

(22) Filed: Oct. 23, 2023

Related U.S. Application Data
(63) Continuation of application No. PCT/US2022/026207, filed on Apr. 25, 2022.
(60) Provisional application No. 63/179,141, filed on Apr. 23, 2021.

(51) Int. Cl. C04B 28/12; C04B 28/08; C04B 28/02; C04B 28/06; C04B 28/00; C04B 22/06; C04B 14/04; C04B 22/10; C04B 40/00; B28C 5/12; B28C 5/16; B01F 23/60; B01F 27/90; B01F 23/70

(52) U.S. Cl. CPC C04B 28/12; C04B 28/08; C04B 28/021; C04B 28/06; C04B 28/006; C04B 22/066; C04B 14/045; C04B 22/064; C04B 22/10; C04B 40/0042; B28C 5/1246; B28C 5/166; B01F 23/69; B01F 27/90; B01F 23/71; B01F 23/712; C04B 2103/10

(57) ABSTRACT

Provided herein are methods and compositions utilizing one or more cementitious replacement materials, one or more alkaline activating materials, and, optionally one or more bonding materials and/or one or more setting time enhancer materials.

### CROSS-REFERENCE

This application is a continuation of PCT/US2022/026207 filed Apr. 25, 2022, which claims the benefit of U.S. Provisional Application No. 63/179,141, filed Apr. 23, 2021, the contents of which are incorporated herein by reference in their entireties.

### BACKGROUND

The production of conventional cement, such as Ordinary Portland Cement (OPC) produces large amounts of carbon dioxide, in large part due to calcination reactions, which require fuel to be burned to provide heat to drive the reaction and which also in themselves release carbon dioxide. Alternatives to convention cement are needed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an exemplary process for producing an admixture.

FIG. 2 shows an exemplary system for producing an admixture.

FIG. 3 shows an exemplary method for treating starting materials to produce a treated material.

FIG. 4 shows an exemplary system for treating starting materials to produce a treated material.

FIG. 5 shows an exemplary system for treating starting materials to produce a treated material.

FIG. 6 shows an exemplary system for treating starting materials to produce a treated material.

FIG. 7 shows an exemplary system for treating starting materials to produce a treated material.

FIG. 8 shows an exemplary impact mixer.

FIG. 9 shows an exemplary treatment compartment of an impact mixer.

FIG. 10 shows an exemplary blade component of an impact mixer.

FIG. 11 shows a top view of an exemplary blade component of an impact mixer.

FIG. 12 shows a side view of an exemplary blade component of an impact mixer.

FIG. 13 shows an exemplary method for producing ultra-high strength geopolymer cement.

FIG. 14 shows 1-24 hour compressive and tensile strengths for concrete made from ultra-high strength geopolymer cement.

FIG. 15 shows an exemplary method for producing high strength geopolymer cement.

FIG. 16 shows 1-24 hour compressive and tensile strengths for concrete made from high strength geopolymer cement.

FIG. 17 shows an exemplary method for producing near carbon-neutral geopolymer cement.

FIG. 18 shows 1-24 hour compressive and tensile strengths for concrete made from a first near carbon-neutral geopolymer cement.

FIG. 19 shows 1-24 hour compressive and tensile strengths for concrete made from a second near carbon-neutral geopolymer cement.

FIG. 20 shows 1-24 hour compressive and tensile strengths for concrete made from a third near carbon-neutral geopolymer cement.

FIG. 21 shows 1-24 hour compressive and tensile strengths for concrete made from a fourth near carbon-neutral geopolymer cement.

### DETAILED DESCRIPTION

Provided herein are alkaline activated cement (geopolymer) methods and compositions. Methods of producing the alkaline activated cement can involve one or more steps to reduce the size of dry or substantially dry particles in a mixture and to combine materials together, in order to produce material in a desired size range and, in some cases, with different combinations of materials. The final cementitious product can be one that requires only addition of water to set and harden, similar to conventional cements such as OPC.

Methods and compositions provided herein can offer several advantages over existing alkaline activated cement (geopolymer) methods and compositions, such as use of a smaller amount of alkaline activator; higher strength ranges in final product, such as concrete, produced with the alkaline activated cement, such as higher compressive strength and/or higher tensile strength; a higher content of amorphous material; a wider range of materials that can be used; a repeatable and predictable process; and/or the ability to activate materials that are not in the active state. Methods and compositions provided herein can differ from existing methods in ways that include no use of grinding or milling; no addition of heat to starting materials; use of a continuous process; in some cases a one-step process that produces final product in a very short time, such as in seconds; a large reduction in carbon dioxide production compared to production of conventional cement (i.e., production of cement by calcining limestone and sintering), in some cases close to carbon neutral or even carbon neutral. Other advantages will be apparent from the description herein.

Alkali activated cement, also called geopolymer cement, comprises binders that can be aluminosilicate precursors, like blast furnace slag, fly ash, metakaolin, or other precursors, as described in more detail herein, which can be combined in different proportions. A chemical activator, also referred to as an alkaline activation material or alkaline activator herein, is added during mixing, e.g., to promote the solidification process. Alkali activators in conventional use are alkaline compounds like carbonates, hydroxides and silicates.

Alkali-activated materials (AAM) are recognized as potential alternatives to Ordinary Portland Cement (OPC) in order to limit CO₂ emissions as well as beneficiate several wastes into useful products. However, the alkaline activation process involves concentrated aqueous alkali solutions, which are corrosive, viscous, and, as such, difficult to handle and not user friendly.

Consequently, provided herein are so-called one-part or “just add water” AAMs which have greater potential than the conventional two-part AAMs, especially in cast-in-situ applications. One-part AAM include a dry mix that comprises a solid cement precursor, e.g., aluminosilicate precursor or other cement precursor, also referred to herein as a cementitious replacement material, a solid alkali source, also referred to herein as an alkaline activation material, or “alkaline activator,” or the like, and, in some embodiments, optionally, admixtures, for example one or both of a bonding material and/or a setting time enhancer material. In use, water is added to the one-part AAM, similar to the preparation of OPC. The dry mix can be prepared at room temperature or elevated temperatures to facilitate the reactivity of certain raw materials. However, in preferred embodiments, no elevated temperature is necessary. The cementitious binders can all come from waste sources and can, in some cases, form 80-100% of the material.

The one-part AAMs provided herein are different to traditional cement as they are more sustainable (e.g., lower carbon dioxide emissions during production); and can have improved compressive, durability, tensile and/or other properties. They are dissimilar to traditional geopolymers as they use a one-part alkaline activation materials that are activated using alkaline activation that are not in aqueous solutions, and the final product only require the addition of water. In some embodiments, they also can use a bonding material and/or setting time enhancer material added into the mixture.

The processes used to produce the one-part AAMs provided herein can utilize grinding, milling, or other mechanical size reduction and mechanochemical techniques to bring the materials to a desired range of sizes; the grinding, milling or other size reduction process may also be the mechanochemical technique. Without being bound by theory, it is thought that by grinding or milling the materials together, or other similar procedure, the chemical bonds between the materials are enhanced. It is dissimilar to processes for other carbon capture cements as it is changing the cement on a chemical level and not necessarily pumping in or adding CO₂ to the curing or other process. In preferred embodiments, no grinding or milling is used, e.g., impact mixing may be used.

### Materials

Alkaline activated cements provided herein typically comprise one or more cement precursors (cement replacement materials), e.g., aluminosilicate precursors, one or more alkaline activating materials, and, optionally, one or more bonding materials and/or one or more setting time enhancer materials.

Cement precursors (cement replacement materials) (e.g., aluminosilicate precursors). Any suitable cement precursor or combination of cement precursors, such as aluminosilicate precursor, also referred to as cementitious replacement material, or combination of materials, may be used, so long as it acts as an cement precursor, e.g., aluminosilicate precursor that can be activated by an alkaline activating material as described herein, e.g., to provide a cementitious material that sets and hardens into a solid composition with the desired properties such as one or more properties as described herein. Cementitious precursors may comprise one or more suitable substances, such as one or more of Silicates, Silica, Calcium aluminate, Alumina, Silicone dioxide, Aluminium oxide, calcium oxide, magnesium oxide, potassium, zeolites, kerogen, ferro sialate, iron, iron oxides calcium silicate, hydrated calcium silicate, hydrated calcium aluminate, Kaolinite, and/or Siloxo. Exemplary aluminosilicate precursors (cementitious replacement materials) include blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof.

In certain embodiments, cement precursor materials comprise one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In certain embodiments, cement precursor materials comprise one or more aluminosilicates and/or one or more poly(ferro-sialate)s, such as one or more of lagoon ash (e.g., an aqueous environment for containing ash from a power station, metal processing, mining, mineral processing, and the like), basic oxygen slag (BOS), electric arc furnace (EAF) slag, mill scale (e.g., from an electric arc furnace), desulferization slag (e.g., from an electric arc furnace, blast furnace, or the like), black/white slag (e.g., from an electric arc furnace), fly ashes (e.g., from coal, steel production, mining, and the like), blast furnace flue dust, red mud (from aluminum production), and/or iron ore agglomerate (e.g., from mining tailings).

Alkaline activating material. Any suitable alkaline activating material, also referred to herein as an alkaline activator, or combination of materials, may be used, so long as it provides alkali cations, raises the pH of the reaction mixture (in some cases reaction mixture at suitable pH without alkaline activating material, in which case this is not a necessary property), and facilitates dissolution. Generally, it is desirable that the alkaline activating material be readily soluble in water to facilitate processes when water is added to the final material. Exemplary alkaline activating materials include potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof.

The cement precursor and alkaline activator materials are generally at a water concentration of no more than 5% before and during treatment to produce a cementitious product. In certain embodiments, the process is started with dry or substantially dry materials, and in some cases water is added as necessary to allow, e.g., the grinding or milling to proceed, and/or to facilitate activation, but to no more than 5% and generally a much lower amount than that. A small amount of water added to the grinding or milling process has surprisingly been found, in some cases, to result in substantially improved properties in the final product. Processes that do not require grinding or milling may use little or no water. Materials to which water is added are considered dry, as that term is used herein, if the added water does not exceed 5%, 4%, 3%, 2%, 1%, or even just 0.5% or 0.1%. Total water added can be at least 0, 0.00001, 0.0001, 0.001, 0.01, 0.1, 0.2, 0.3, 0.4, 0.5, 0.6, 0.7, 0.8, 0.9, 1, 1.2, 1.5, 2, 2.5, 3, 3.5, 4 or 4.5% and/or not more than 0.0001, 0.001, 0.01, 0.1, 0.2, 0.3, 0.4, 0.5, 0.6, 0.7, 0.8, 0.9, 1, 1.2, 1.5, 2, 2.5, 3, 3.5, 4, 4.5, or 5.%, for example, less than 5%, in some cases less than 2%, such as less than 1%, or less than 0.5%, and even less than 0.1 or 0.01%. In some cases, total water added is 0.00001-5%, or 0.00001-1%, or 0.00001-0.1%, or 0.00001-0.01%. In certain embodiments, e.g., in certain embodiments in which no grinding or milling is used, no water is used.

Microbial activating material. In certain embodiments, a microbial activating material is used alternatively or additionally with an alkaline activating material. Any suitable microbial activating material can be used. In certain embodiments, a microbial activating material can include one or more fungi, one or more bacteria, or a combination thereof. In certain embodiments the microbes comprise alaliphilic and/or alkalitolerant bacteria and fungi. Exemplary bacteria include Ureolytic sporosarcina pasteurii, Bacillus alkalinitrilicu, Bacillus megaterium, Bacillus spaericus, Bacillus subtitlis, Bacillus pseudofirmus, Bacillus pasteurii, Escherichia coli, Bacillus cohnii, Bacillus balodurans, Bacillus halodurans. Exemplary fungi include filamentous fungi, Trichoderma reesei, Rhizopus oryza, Phanerochaete chrysosporium, Aspergillus nidulans, Aspergillus terreus, and Aspergillus oryzae, Saccharomyces cerevisiae, Paecillomyces lilacimus and Chrysosporium. Exemplary combinations include Aspergillus nidulans and Bacillus spaericus, Filamentous fungi and Bacillus halodurans, and Chrysosporium and Bacillus subtilis.

Bonding material. If a bonding material is used, any suitable bonding material or combination of bonding materials may be used. Exemplary bonding materials include plagioclase, feldspathic material, pyroxene, amphibole, quartz, diatomaceous earth, magnesium oxide, potassium oxide, methylsulfonylmethane, malic acid, zirconium dioxide, bentonite, micro silica or a combination thereof.

Setting time enhancer material. If a setting time enhancer is used, any suitable setting time enhancer material or combination of materials may be used. Exemplary setting time enhancer materials include aluminum hydroxide, VCAS (waste product of fiberglass production), cement kiln dust, zeolite, calcium oxide, aluminum oxide, dolomite calcite, montmorillonite, sodium lignosulfate, zinc oxide, sodium phosphate, phosphoric acid, sodium chloride (low accelerators/high retarders), tartaric acid, or a combination thereof. In certain embodiments, zeolite is used. In certain embodiments, a combination of aluminum hydroxide and VCAS is used.

Admixtures. In certain embodiments an admixture is provided. The admixture can be a mixture of a silicate compound and a hydroxide compound; in certain embodiments, the compounds have been allowed to combine and, potentially, react, so that the admixture can further comprise reaction products of the silicate compound and the hydroxide compound. The admixture can be used with any suitable cement mix, such as a cement mix comprising a geopolymer, e.g., one or more of the geopolymers described herein. The admixture is typically used during the production of a wet cement mix, e.g., a wet concrete mix, and can be used in an amount that produces one or more desired effects, such as accelerated rate of compressive strength development; greater compressive strength at one or more time points; accelerated rate of tensile strength development; greater tensile strength at one or more time points; modulation of initial setting time, e.g., time to reach a gelatinous consistency, such as a decrease in initial setting time; modulation of final set time, e.g., time at which a mold can be removed. Thus, a user or customer can be supplied with a dry particulate mix comprising one or more geopolymers, such as one or more geopolymers as described herein, and an admixture that allows the user/customer to fine-tune the cement composition, e.g, concrete, to be made with the dry particulate mix. The admixture can be added at any suitable time, such as added with mix water for the wet cement or concrete mix. Any suitable silicate compound can be used, such as sodium silicate or potassium silicate, or a combination thereof; in preferred embodiments, a potassium silicate is used. Any suitable hydroxide compound can be used, such as sodium hydroxide or potassium hydroxide; in preferred embodiments, a potassium hydroxide is used. Thus, in certain embodiments the admixture is a mixture of potassium silicate and potassium hydroxide; generally, the admixture will further comprise reaction products of the potassium silicate and potassium hydroxide. Any suitable ratio of silicate compound to hydroxide compound may be used, such as silicate compound and hydroxide compound at a molar ratio of between 0.5 and 3.0 silicate:hydroxide, preferably 1.0-2.0, more preferably 1.0-1.5. These ratios refer to starting materials; it will be appreciated that reactions during the combinations of the two may result in reaction products that are not silicates or hydroxides, so that ratio in the final product may be different. The admixture may be used in any suitable way, such as added with mix water to a cement mix or concrete mix. The amount of admixture used can be any suitable amount, depending on desired modulations of the cement or concrete mix, such as 0.5-40% by weight cement (bwc), preferably 1-35% bwc. In certain embodiments, e.g., production of high- or ultra high-strength concrete, a relatively high percentage may be used, e.g., 2-40% bwc, preferable 4-35% bwc, even more preferably 20-35% bwc. See Example 12. In certain embodiments, e.g., production of non-ultra high strength concrete, a relatively lower percentage may be used, e.g., 0.25-35% bwc, preferably 0.5-30%, more preferably 0.5-10%, even more preferably 0.5-5% bwc.

The admixture can be prepared in any suitable manner. In certain embodiments, a silicate compound, such as a potassium silicate compound, in aqueous medium is placed in a reaction vessel, and a hydroxide compound, such as potassium hydroxide, is added to the vessel; generally the rate of addition can be determined by, e.g., keeping the temperature of the mixture within or below a certain threshold temperature; this can depend on the materials of the reaction vessel and the temperature it can withstand. The mixing of the compounds can produce a gas, e.g., hydrogen gas, and some or all of this gas can be collected from the mixture; in certain embodiments, some or all of the gas is used in other procedures, such as in one or more cement production procedures, e.g., as described herein. For example, the hydrogen gas can be combusted to provide energy, e.g., heat energy, to one or more steps in one or more other procedures. After the desired amount of hydroxide is added, the mixture is allowed to sit for an extended period, e.g., at least 0.5, 1, 2, 4, 6, 8, 10, 12, 14, 16, 18, 20, 22, 24, 26, 28, 30, 36, 42, 48, or 72 hours, preferably at least 2 hours, more preferably at least 10 hours, even more preferably at least 20 hours. The material is then ready for use as an admixture, and can be stored, packaged, transported, or otherwise suitably processed for, e.g., sale and/or use.

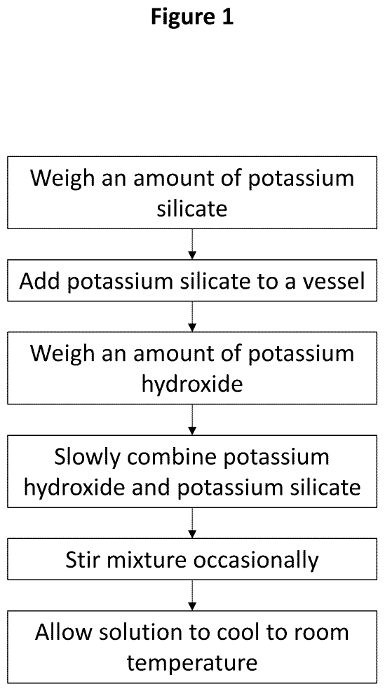

In certain embodiments (as shown in FIG. 1), provided herein are methods and systems for producing mixtures of a silicate and a hydroxide, illustrated here as potassium silicate and potassium hydroxide, i.e., admixture. In certain embodiments, (1) a desired amount of potassium silicate is weighed, (2) the potassium silicate is added into a suitable vessel, (3) a desired amount of potassium hydroxide is separately weighed, (4) the potassium hydroxide is slowly combined with the potassium silicate, (5) the mixture is stirred occasionally, and (6) the solution is allowed to cool to room temperature and to sit for an extended period, e.g., at least 2, 4, 6, 8, 10, 12, 14, 16, 18, 20, 22, 24, 26, 28, 30, 36, 42, 48, or 72 hours, preferably at least 16 hours, more preferably at least 20 hours. A gas, e.g., hydrogen gas, may be produced during the addition and/or mixing of the hydroxide, e.g., potassium hydroxide, with the silicate, and the process can further comprise collecting the gas. The gas may be used in any suitable manner, e.g., combusted to provide heat for one or more processes, such as one or more of the cement production processes described herein.

The vessel can be any suitable vessel, for example a bucket, a pail, or a vat. The vessel can comprise any suitable material so long as the material is resistant to the materials that come in contact with it. In certain embodiments, the vessel comprises a material resistant to high concentrations of hydroxide, e.g., potassium hydroxide, and temperatures ranging from 10° C. to 150° C., such as a plastic, fluoroplastic, glass, or metal material, for example, high-density linear polyethylene (HDPE), cross-linked polyethylene (XLPE), polypropylene, nylon, Tygon, polyvinyl chloride (PVC), chlorinated polyvinyl chloride (CPVC), natural rubber, PEEK, PTFE, PVDF, titanium, or carbon steel. In certain embodiments, the vessel comprises a base resistant material, wherein the pH is at least 7.5, 8, 9, 10, 11, 12, or 13 and/not more than 14, 13, 12, 11, 10, 9, or 8, for example a pH of 7.5-14.

In certain embodiments, a mixer or an agitator can be used to facilitate mixing of the silicate and the hydroxide. Any suitable mixer or agitator can be used, for example a wooden spoon, a magnetic stir bar and plate, ribbon mixer, overhead stirrer, or mix.

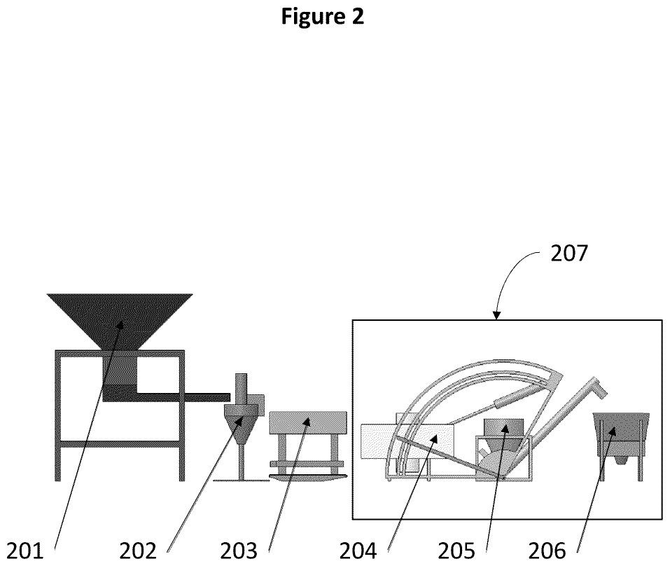

In certain embodiments, provided herein are systems for producing mixtures of a silicate and a hydroxide, illustrated here as potassium silicate and potassium hydroxide, i.e., admixture. An exemplary system for producing admixture is shown in FIG. 2. FIG. 2 illustrates a system comprising a potassium hydroxide hopper (201), a weighing unit (202), a scale (203), a mixing unit (204), a pumping unit (205), and a storage vessel (206). The potassium hydroxide hopper is configured to transfer an amount of potassium hydroxide to the weighing unit, where the weighed potassium hydroxide can be either directly transferred to the mixing unit (204) where it is contacted with a potassium silicate solution or transferred to a scale (203) for validation prior to transfer to the mixing unit (204). The mixing unit (204) is further connected to a pumping unit (205) which can transfer resulting mixed liquid from the mixing unit (204) to a admixture storage vessel (206). The potassium silicate solution can be added to the mixing unit (204) manually or via a potassium silicate transfer unit, for example a user may fill the mixing unit manually or a transfer unit comprising a pump, a calibrated flow meter, and a shut off valve can be used to transfer the solution form a potassium silicate storage vessel to the mixing unit (204).

In certain embodiments, the system further comprises a control system, e.g., comprising sources of input to a processor, e.g., one or more sensors that send information regarding one or more aspects of the process to the processor; the processor, which processes the information and produces an output; and one or more actuators that receive output from the processor and that modulate one or more aspects of the process, to automate at least a portion of the process. In such a system, an amount of potassium silicate is transferred to a mixing unit (204) from a silicate solution storage unit by a pump. The control system opens a shut-off valve and activates the pump, and the potassium silicate solution begins to flow from the silicate solution storage vessel, through a flow sensor, to the mixing unit (204). Based on the time and the rate of flow, the amount of potassium silicate solution added to the mixing unit (204) is calculated by the control system. Based on the desired admixture recipe, the control system calculates an amount of potassium hydroxide to be added to the mixing unit (204) and activates a hopper (201), that feeds potassium hydroxide from the hopper (201) to the weighing unit (202). The amount of potassium hydroxide introduced to the weighing unit (202) is communicated to the control system, and potassium hydroxide is fed from the hopper (201) until the weighing unit (202) measures the requisite amount of potassium hydroxide, then the control system shuts off the hopper (201). The potassium hydroxide is transferred to the mixing unit (204) from the hopper (201) by a transfer unit, for example, a conveyer. As the potassium hydroxide is being transferred to the mixing unit (204) by the transfer unit, the control system communicates to the mixing unit (204) to turn on, whereby added the potassium hydroxide is mixed with the potassium silicate solution. The rate of addition of the potassium hydroxide to the potassium silicate solution in the mixing unit (204) can be adjusted by the rate of transfer by the transfer unit. Additionally, a temperature sensor, for example a thermistor or a thermocouple, may be configured to measure and communicate the temperature of the solution in the mixing unit (204) to the control system. The control system may adjust the rate of addition of potassium hydroxide to achieve a desired temperature range, and/or, activate a temperature control element, for example a heat exchanger or a cooling unit, to actively maintain and/or reduce the temperature of the solution. After the entirety of the sodium hydroxide has been added to the potassium silicate solution, the solution is adequately mixed, and the solution reaches the appropriate temperature, the control system activates a pump (205) to transfer the prepared admixture solution from the mixing unit (204) to the storage vessel (206).

Combination of potassium hydroxide with a potassium silicate solution may result in the production of one or more gasses including hydrogen. In certain embodiments, the system further comprises a gas collection unit (207) for collection of the one or more gasses produced during the treatment. Any suitable gas collection unit may be used, for example units 204-206 are enclosed within chamber connected to a gas storage vessel, wherein a pump pulls generated gasses from the chamber into the gas storage vessel.

Provided herein are wet cement compositions, such as wet concrete compositions, comprising the admixture comprising a silicate compound and a hydroxide compound and/or reaction products thereof, as described herein. In certain embodiments, a composition comprises a cement, such as a geopolymer cement, e.g., one or more of the cements described herein, water, and an admixture comprising a silicate compound and a hydroxide compound and/or reaction products thereof, as described herein. The admixture can contain silicate and hydroxide in a molar ratio of between 0.5 and 3.0 silicate:hydroxide, preferably 1.0-2.0, more preferably 1.0-1.5. These ratios refer to starting materials; it will be appreciated that reactions during the combinations of the two may result in reaction products that are not silicates or hydroxides, so that ratio in the final product may be different. The admixture can be present in the wet cement or concrete mix The amount of admixture in the composition can be any suitable amount, depending on desired modulations of the cement or concrete mix, such as 0.5-40% by weight cement (bwc), preferably 1-35% bwc. In certain embodiments, e.g., production of high- or ultra high-strength concrete, a relatively high percentage may be used, e.g., 2-40% bwc, preferable 4-35% bwc, even more preferably 20-35% bwc. In certain embodiments, e.g., production of non-ultra high strength concrete, a relatively lower percentage may be used, e.g., 0.25-35% bwc, preferably 0.5-30%, more preferably 0.5-10%, even more preferably 0.5-5% bwc. The composition can also comprise reaction products of the geopolymer cement and admixture. In certain embodiments, the geopolymer comprises one or more cement precursors and one or more alkaline activating agents. In certain embodiments, the one or more cement precursors comprise one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In certain embodiments, the one or more cement precursors comprise one or more, in certain embodiments at least two, of aluminosilicates and/or one or more poly(ferro-sialate)s, such as one or more of lagoon ash, basic oxygen slag (BOS), electric arc furnace (EAF) slag, mill scale, desulferization slag, black/white slag, fly ashes, blast furnace flue dust, red mud, and/or iron ore agglomerate. In certain embodiments the one or more alkaline activating agent comprises one or more of, in certain embodiments at least two of, potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. The composition can further comprise a non-geopolymer cement, such as Portland cement, e.g., OPC. In certain of these embodiments, the non-geopolymer cement, e.g., OPC, is present in an amount of less than 50, 40, 30, 20, 15, 10, or 5% by weight, preferably less than 30%, more preferably less than 20%, even more preferably less than 15%. In certain embodiments, the composition further comprises aggregate.

Also provided herein is a method of producing a wet cement mix comprising providing one or more dry cements, such as one or more geopolymer cements, e.g., as described herein, and mixing the cement(s), e.g., geopolymer cement(s), with water and an admixture comprising a silicate compound and a hydroxide compound, and/or reaction products thereof, such as described herein. Generally, the admixture will be added with the mix water, but it can be added before, during, or after addition of mix water, as desired and appropriate. The molar ratio of silicate compound to hydroxide compound in the admixture can be any suitable ratio, e.g., as described herein, such as a molar ratio of between 0.5 and 3.0 silicate:hydroxide, preferably 1.0-2.0, more preferably 1.0-1.5. The amount of admixture added can be any suitable amount, depending on desired modulations of the cement or concrete mix, such as 0.5-40% by weight cement (bwc), preferably 1-35% bwc. In certain embodiments, e.g., production of high- or ultra high-strength concrete, a relatively high percentage may be used, e.g., 2-40% bwc, preferable 4-35% bwc, even more preferably 20-35% bwc. In certain embodiments, e.g., production of non-ultra high strength concrete, a relatively lower percentage may be used, e.g., 0.25-35% bwc, preferably 0.5-30%, more preferably 0.5-10%, even more preferably 0.5-5% bwc. Additional materials, e.g., aggregates, may also be included in the composition, e.g., in a wet concrete composition.

Methods and compositions provided herein can comprise at least one cementitious replacement material (cement precursor) and at least one alkaline activating material, and/or one or more reaction products thereof; and, optionally, one or both of a bonding material and/or a setting time enhancer material. The materials can be present in any suitable amount. In certain embodiments, cementitious replacement materials (such as aluminosilicate precursors and/or others, as described herein) are present in total at a wt % of at least 20, 30, 40, 50, 55, 60, 65, 70, 75, 80, 85, 90, or 95% and/or not more than 30, 40, 50, 55, 60, 65, 70, 75, 80, 85, 90, 91, 92, 93, 94, 95, 96, 97, 98, or 99%, for example 50-99.9%, 50-99.5%, 50-99%, 50-98%, 50-97%, 50-95%, 50-90%, 50-80%, 50-70%, 50-60%, 60-99.9%, 60-99.5%, 60-99%, 60-98%, 60-97%, 60-95%, 60-90%, 60-80%, 60-70%, 70-99.9%, 70-99.5%, 70-99%, 70-98%, 70-97%, 70-95%, 70-90%, 70-80%, 75-99.9%, 75-99.5%, 75-99%, 75-98%, 75-97%, 75-95%, 75-90%, 75-80%, 80-99.9%, 80-99.5%, 80-99%, 80-98%, 80-97%, 80-95%, 80-90%, 85-99.9%, 85-99.5%, 85-99%, 85-98%, 85-97%, 85-95%, 85-90%, 90-99.9%, 90-99.5%, 90-99%, 90-98%, 90-97%, or 90-95%, preferably, 50-99.5%, more preferably 60-98%, even more preferably, 75-97%. In certain embodiments, the total is 75-97%. Percentages in this case are by weight, in the final cementitious mix. When more than one cementitious replacement material is present, for example, two different cementitious replacement materials or three different cementitious replacement materials, each individual cementitious replacement material may be present at least 1, 2, 3, 4, 5, 6, 7, 8, 9, 10, 12, 15, 20, 25, 30, 35, 40, 45, 50, 55, 60, 65, 70, 75, 80, 85, or 90%, and/or not more than 2, 3, 4, 5, 6, 7, 8, 9, 10, 12, 15, 20, 25, 30, 35, 40, 45, 50, 55, 60, 65, 70, 75, 80, 85, 90, 95, 97, or 98%, preferably, 5-70%, more preferably 6-65%, even more preferably, 8-55%, so long as the total is within the specified ranges, above, of the final cementitious mix. In certain embodiments, alkaline activation materials are present in total at 0.25-40%, 0.25-30%, 0.25-20%, 0.25-10%, 0.25-5%, 0.25-3%, 0.25-2%, 0.25-1%, 0.5-40%, 0.5-30%, 0.5-20%, 0.5-10%, 0.5-5%, 0.5-3%, 0.5-2%, 0.5-1%, 1-40%, 1-30%, 1-20%, 1-10%, 1-5%, 1-3%, 1-2%, 2-40%, 2-30%, 2-20%, 2-10%, 2-5%, 2-3%, 5-40%, 5-30%, 5-20%, or 5-10%. When more than one alkaline activation material is present, for example, two different alkaline activation materials or three different alkaline activation materials, each individual alkaline activation material may be present at any suitable percentage, so long as the total percentage of all the alkaline activation materials is 0.25-40%, 0.25-30%, 0.25-20%, 0.25-10%, 0.25-5%, 0.25-3%, 0.25-2%, 0.25-1%, 0.5-40%, 0.5-30%, 0.5-20%, 0.5-10%, 0.5-5%, 0.5-3%, 0.5-2%, 0.5-1%, 1-40%, 1-30%, 1-20%, 1-10%, 1-5%, 1-3%, 1-2%, 2-40%, 2-30%, 2-20%, 2-10%, 2-5%, 2-3%, 5-40%, 5-30%, 5-20%, or 5-10%. In certain embodiments, the total is 0.5-20%, preferably 0.5 to 10%, even more preferably 0.5 to 5%.

When one or both of one or more bonding materials and/or one or more setting time enhancer materials is present, in certain embodiments, the total amount, whether it is one, the other, or both, and whether it is a single material of each kind or a plurality of materials of each kind, is not greater than 25%, e.g., at least 0.2, 0.5, 1, 2, 5, 7, 10, 12, 15, 17, 22, or 22% and/or not more than 0.5, 1, 2, 5, 7, 10, 12, 15, 17, 22, 22 or 25%, such as 0.2%-25%, 0.5-25%, 1-25%, 2-25%, 5-25%, 10-25%, 15-25%, 20-25%, 0.2%-20%, 0.5-20%, 1-20%, 2-20%, 5-20%, 10-20%, 15-20%, 0.2%-15%, 0.5-15%, 1-15%, 2-15%, 5-15%, 10-15%, 0.2%-10%, 0.5-10%, 1-10%, 2-10%, 5-10%, 0.2%-5%, 0.5-5%, 1-5%, 2-5%, or 5-25%. In certain embodiments, the total is 1-25%. In certain embodiments, the total amount may be in a range that includes higher values than 25%, for example at least 0.2, 0.5, 1, 2, 5, 7, 10, 12, 15, 17, 22, 25, 30, or 35% and/or not more than 0.5, 1, 2, 5, 7, 10, 12, 15, 17, 22, 22, 25, 30, 35, or 40%, such as 0.2%-40%, 0.5-40%, 1-40%, 2-40%, 5-40%, 10-40%, 15-40%, 20-40%, or 30-40%, or 0.2%-35%, 0.5-35%, 1-35%, 2-35%, 5-35%, 10-35%, 15-35%, or 25-35%, or 0.2%-30%, 0.5-30%, 1-30%, 2-30%, 5-30%, 10-30%, or 20-30%.

Ordinary Portland Cement. Although methods and compositions provided herein don't require Ordinary Portland Cement (OPC) in the mix, in certain embodiments OPC is also included. An initial cementitious mix can be prepared with one or more cementitious replacement materials, one or more alkaline activation materials, and optionally, one or both of one or more bonding materials and/or one or more setting time enhancer materials, using processes as described herein. A final cementitious mix can be produced by adding OPC to the initial cementitious mix. The percentage of OPC can be any suitable percentage, for example, at least 0.1, 0.2, 0.5, 0.7, 1.0, 1.5, 2, 3, 4, 5, 6, 7, 8, 9, 10, 12, 15, 20, 25, 30, 35, 40, or 45% and/or not more than 0.2, 0.5, 0.7, 1.0, 1.5, 2, 3, 4, 5, 6, 7, 8, 9, 10, 12, 15, 20, 25, 30, 35, 40, 45 or 50% such as 0.1-50%, 0.5-40%, 1-30%, 1-20%, or 1-10%, or less than 20, 15, 10, 9, 8, 7, 6, 5, 4, 3, 2, or 1%, preferably 0.1-30%, more preferably 1-20%, even more preferably 1-10%. In general, OPC will not be present in the one or more processes to produce particulate material in a desired size range or set of size ranges, and can be added to the cement mix after it has gone through such processes.

Cementitious mixes as provided herein may be used as OPC is used. For example, they may be used with suitable amounts of aggregates, fine and/or coarse. As used herein, the terms “cement mixture,” “cement mix,” “cementitious mixture,” and the like, include a mixture of a cementitious material, such as alkaline activated/geopolymer cementitious materials provided herein, and water, or a product produced by reaction of a cementitious material and water. As used herein, a “concrete” is a cement mixture that also includes aggregates, such as fine and/or coarse aggregates. In many cases, the cementitious materials provided herein have superior qualities, such as superior compressive strength and/or other properties, as described below, to normal cementitious materials, e.g., OPC. Thus, a smaller proportion of, e.g., a concrete, comprising the alkaline-activated cementitious replacement materials described herein and other materials such as aggregates, can be used. In certain embodiments, provided herein is a concrete comprising no greater than 20, 19, 18, 17, 16, 15, 14, 13, 12, 11, 10, 9, 8, 7, 6, 5, or 3% and/or no less than 19, 18, 17, 16, 15, 14, 13, 12, 11, 10, 9, 8, 7, 6, 5, 4, 3, 2, or 1% of a cementitious material, preferably 1-20%, more preferably 2-15%, even more preferably 2-10%, such as one of the alkaline-activated cementitious replacement materials provided herein, in certain embodiments in the size ranges and/or proportions of materials as provided herein, where the concrete does not include additional cementitious materials, such as supplementary cementitious materials, and aggregates, wherein the concrete has suitable properties for its intended use, such as one, two, three, four, five, or six of a suitable compressive strength, e.g., a compressive strength as described herein, in some cases greater than 30, 40, or 50 MPa; a suitable tensile strength, e.g., a tensile strength as described herein, in some cases greater than 10, 20, or 30 MPa; a suitable modulus of elasticity, e.g., a modulus of elasticity as described herein, such as 40-120 GPa; a suitable pore volume range, e.g., a pore volume range as described herein, such as 0.001-2%; a suitable water sorptivity, e.g., a water sorptivity as described herein, such as 0.001-0.055 kg/m²/h^{0.5}; a suitable fire resistance, such as at least 500, 700, or 1000° C. Admixtures other than the bonding material or setting time enhancer may also be added at suitable times during the use of the cementitious mix, e.g., during mixing with water.

### Processing of Materials

Generally, one or more of the ingredients go through one or more processes to produce particulate material in a desired size range or set of desired size ranges, and to mix materials. Without being bound by theory, it is thought that such processes also serve to activate one or more materials. Suitable processes include grinding and milling, for example ball milling, and sieving. Vibration may also be used to sort materials by size. In certain embodiments, materials are processed in a manner that does not include grinding or milling. In certain embodiments, materials are processed in a manner that does not include adding exogenous heat to the materials; in some of these embodiments, although the processing of the materials may result in one or more processes, such as exothermic reactions, that cause the material to increase in temperature, the increased temperature is not necessary to process a geopolymer cement into useable form. In certain embodiments, materials are processed in a continuous process; in certain cases, the time the materials are processed may be very short, e.g., less than 60 seconds, or less than 30 seconds, or even less than 10 seconds. In certain embodiments, materials are processed in an impact mixer, as described more fully herein. In certain embodiments, materials, including one or more cement precursors and one or more alkaline activators, are simultaneously added to a treatment unit, such as an impact mixer, where they are processed in a single step to produce a geopolymer cement; the processing can include size reduction, mixing, and/or activation. In certain cases, the process is continuous, that is, starting materials are added to the treatment unit and exit the treatment unit in continuous fashion, until a desired amount of geopolymer cement is produced. Residence time in the treatment unit (i.e., the time during which processing occurs) can be very short, e.g., less than 300, 200, 100, 80, 60, 50, 40, 30, 20, 10, 5, 4, 3, or 2 seconds; in preferred embodiments, less than 60 seconds, in more preferred embodiments less than 20 seconds, and in still more preferred embodiments less than 10 seconds. In certain embodiments, a geopolymer cement suitable for its intended use can be produced in a one-step process, from starting materials to final product; the process can be rapid, e.g., less than 60, 30, or even 10 seconds, and, in preferred embodiments, requires no grinding, milling, or the like, and no exogenous heating, such as a impact mixing process. The processed material from the treatment unit can be, e.g., bagged or otherwise packaged for storage, transport, or the like.

Pre-processing. In certain embodiments a process starts with one or more cementitious replacement materials, such as one, two, three, four, five, or six cementitious replacement materials, for example, one, two, or three cementitious replacement materials. The one or more cementitious replacement materials may, if necessary, undergo one or more pre-treatment processes, e.g., processes to render the cementitious replacement materials in a size range or other property, to be used with the processing system, e.g., treatment unit. Any suitable process or combination of processes may be used for pre-treatment, e.g., crushing, such as in a jaw crusher, treatment with microwave radiation, and/or treatment with ultrasound.

In certain embodiments, one or more of the starting materials can be pre-processed prior to treatment, e.g., by a treatment unit. The material can be processed using any suitable process to provide a material ready for treatment, e.g., by the treatment unit. In certain embodiments, the particle size is reduced. The particle size may be reduced using any suitable process, for example grinding, milling, or crushing. In certain embodiments, one or more starting materials are treated by crushing, microwave, and/or ultrasound; in certain embodiments one or more starting materials are treated by microwave, optionally preceded by a crushing step; in certain embodiments one or more starting materials are treated by ultrasound, optionally preceded by a crushing step; in certain embodiments one or more starting materials are treated by microwave and ultrasound, optionally preceded by a crushing step.

Without being bound by theory, it is proposed that ultrasound is transmitted through a material in the same way as any sound wave via a series of compression and rarefaction cycles. During rarefaction, provided that the negative pressure is strong enough to overcome the intermolecular forces binding the fluid, the fluid is literally torn apart producing tiny cavities (microbubbles) throughout the medium. In the succeeding compression cycle if cavities were enclosing a vacuum, they would collapse almost instantaneously. However, during cavity formation a small amount of gas or vapour is drawn in from the surrounding liquid. As a result, the succeeding compression cycle may not totally collapse the bubbles and so they will grow slightly larger in the next rarefaction cycle with a further intake of gas and vapour. The process is known as rectified diffusion. The bubble will not grow indefinitely, there will be an equilibrium size for any bubble in an acoustic field (this depends on frequency). Some bubbles will continue to resonate in this stable state, but many will become unstable and collapse generating micro-spots of extreme conditions of temperature and pressure. Based on the theory which has been put forward to explain the energy release involved with cavitation, each cavitation bubble acts as a localised microreactor which generates instantaneous temperatures and pressures on collapse of several thousand degrees and over one thousand atmospheres respectively. When pre-processing comprises treatment with ultrasound, any suitable treatment duration can be used, such as at least 10, 20, 30, 40, 50, 60, 70, 80, 90, 100, 110, 120, 150, 180, 210, 240, 270, 300, 330, 360, 390, 420, 450, 480, 510, 540, 570, 600, 1,000, 5,000, 10,000, 15,000, 20,000, or 25,000, 30,000, 35,000, 40,000, or 45,000 seconds and/or no more than 20, 30, 40, 50, 60, 70, 80, 90, 100, 110, 120, 150, 180, 210, 240, 270, 300, 330, 360, 390, 420, 450, 480, 510, 540, 570, 600, 1,000, 5,000, 10,000, 15,000, 20,000, 25,000, 30,000, 35,000, 40,000, 45,000, or 50,000 seconds, for example 10-50,000 seconds, preferably 30-10,000 seconds, more preferably 60-1000 seconds, yet more preferably 90-500 seconds, still more preferably 100-150 seconds. Any suitable frequency of ultrasound can be used, such as at least 20, 21, 22, 23, 24, 25, 26, 27, 28, 29, 30 kHz, preferably 20 kHz. In certain embodiments, a material is treated with ultrasound for 2 minutes at 20 kHz.

In certain embodiments, pre-processing includes heating material. Any suitable heating technique may be used to pre-treat the material. In certain embodiments, a heating source comprises microwave heating. Without being bound by theory, microwave heating is a technique that promotes various thermal processes with advantages of microwave heating compared to conventional processing methods including energy-saving rapid heating rates, short processing times, deep penetration of the microwave energy (which allows heat to be generated efficiently without directly contacting the workpiece), instantaneous and precise electronic control, clean heating processes, and no generation of secondary waste. Microwave energy processes for heating, drying, and curing have been developed for numerous laboratory-scale investigations and, in some cases, have been commercialized. Microwave energy use should theoretically be advantageous in the processing of cement and concrete materials (e.g., hydraulic Portland cement, aggregate, and water). These materials exhibit excellent dielectric properties and, therefore, should be able to absorb microwave energy very efficiently and instantaneously convert it into heat. When microwave treatment is used, any suitable treatment duration can be used, such as at least 10, 20, 30, 40, 50, 60, 70, 80, 90, 100, 110, 120, 150, 180, 210, 240, 270, 300, 330, 360, 390, 420, 450, 480, 510, 540, 570, 600, 1,000, 5,000, 10,000, 15,000, or 20,000 seconds and/or no more than 20, 30, 40, 50, 60, 70, 80, 90, 100, 110, 120, 150, 180, 210, 240, 270, 300, 330, 360, 390, 420, 450, 480, 510, 540, 570, 600, 1,000, 5,000, 10,000, 15,000, 20,000, or 25,000 seconds, for example 10-25,000 seconds, preferably 500-10,000 seconds, more preferably 3000-9000 seconds, yet more preferably 5000-7000 seconds. Any suitable frequency of microwave can be used, such as at least 1, 1.5, 2, 2.45, 2.5, 3, 3.5, 4, 4.5 5, 6, 7, 8, 9, 10, 12, 14, 16, 18, 20, 22, 24, 26, or 28 GHz, preferably 2.45 GHz. In certain embodiments, a material is treated with ultrasound for 10 minutes at 2.45 kHz.

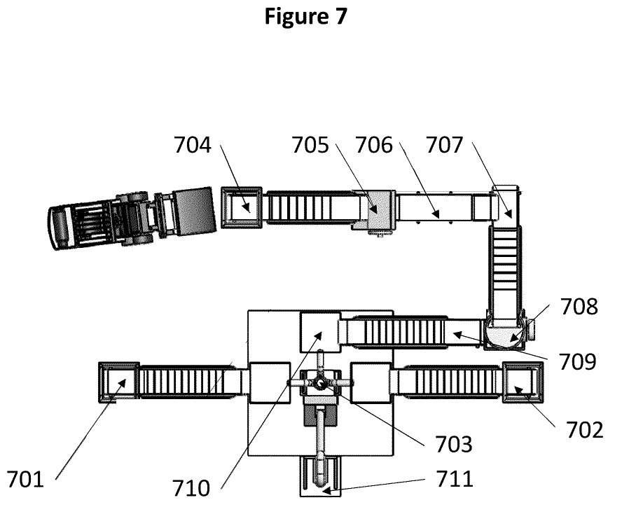

An exemplary system for pre-processing one or more starting materials to be used to form a cementitious product, wherein one or more of the starting materials is pre-processed prior to delivery to a treatment unit, is shown in FIG. 7. Specifically, FIG. 7 shows a system for transporting a first starting material from a first source (701) and a second starting material from a second source (702) to a treatment unit (703). The system further comprises a third source of material (704), where the third source of material is pre-processed prior to introduction to the treatment unit (703). The third material is optionally transferred from a source (704) to a crusher (705) by a conveyer; to produce a crushed material. In certain embodiments, a crusher is not used. The third material, e.g., crushed material, is transferred (705) to an ultrasonic/microwave treatment unit (706), configured to treat the material by microwave, ultrasound, or both microwave and ultrasound, to form a pre-processed starting material. The pre-processed material can optionally be transferred from the ultrasonic/microwave treatment unit (706) to a crushing unit, e.g., a second crushing unit (708) by a transfer unit (707), where it can be crushed to form a crushed or twice-crushed material, then the crushed or twice-crushed material is transferred to a hopper (710) for storage prior to introduction into the treatment unit (703) for treatment. The treated material exits the treatment unit (703) at an outlet (711) for transfer, storage, packaging, or any other suitable additional processing. In certain embodiments, material from the treatment unit is directed to one or more containers that are ready to ship to users. It will be appreciated that this embodiment is merely exemplary. In certain embodiments, only one starting material is pre-processed; in certain embodiments, two starting materials are pre-processed; in certain embodiments, three starting materials are pre-processed; in certain embodiments, more than three starting materials are pre-processed. In any of these embodiments, one or more of crushing, microwave, and/or ultrasound treatment can be used.

Processing (Treatment).

Generally, one or more cement precursors and one or more alkaline activating agents are processed to render the resultant product cementitious, or more cementitious than the starting materials. Any suitable processing may be used. Typically, processing will produce a particulate product in a desired size range; any suitable range can be produced. In certain embodiments, particulate product is 1-500 um, preferably 1-100 um, more preferably 2-50 um, even more preferably 5-30 um. Systems and/or conditions can be adjusted to produce a desired size range. See, e.g., Examples 12-14. Systems and/or conditions can be adjusted to produce a product that comprises amorphous material, e.g., at least 5%, preferably at least 10%, more preferably at least 15% of amorphous material.

In certain embodiments, provided herein are systems and methods for treating one or more cement precursors and one or more alkaline activating materials to produce a cementitious product, e.g., a geopolymer cement. In certain embodiments, systems and methods for treating one or more cement precursors and one or more alkaline activating materials do not require, and do not utilize, grinding or milling. In certain embodiments, systems and methods for treating one or more cement precursors and one or more alkaline activating materials do not require, and do not utilize, addition of exogenous heat to the materials. In certain embodiments, systems and methods for treating one or more cement precursors and one or more alkaline activating materials are continuous. In certain embodiments, systems and methods for treating one or more cement precursors and one or more alkaline activating materials treat the materials by impact mixing, e.g., in an impact mixer. “Impact mixing” as that term is used herein, includes a process for combining materials and processing the materials where the materials, e.g., particulate materials, are caused to impact each other and/or components of a processor. The process can result in, e.g., size reduction and/or activation of materials. An “impact mixer” as that term is used herein, includes a mixer where materials, e.g., particulate materials, are combined and processed by impact mixing. Exemplary impact mixers include Hosokawa Flexomix, such as Hosokawa Flexomix fx160 (Netherlands); modified and improved versions are also provided herein.

In certain embodiments, provided are systems and methods for treating starting materials, such as one or cement precursors and one or more alkaline activating agents, in a one-step continuous process, to produce one or more cementitious products, e.g., geopolymers, from the starting materials, wherein the one or more cementitious products, e.g., geopolymers are ready for use, e.g., in a cement mix such as a concrete mix. The system and/or method can include no grinding or milling. The system and/or method can include no source of exogenous heat. The system and/or method can be configured so that treatment time, from entrance of starting materials to exit of cementitious product ready for use, is very short, e.g., less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds.

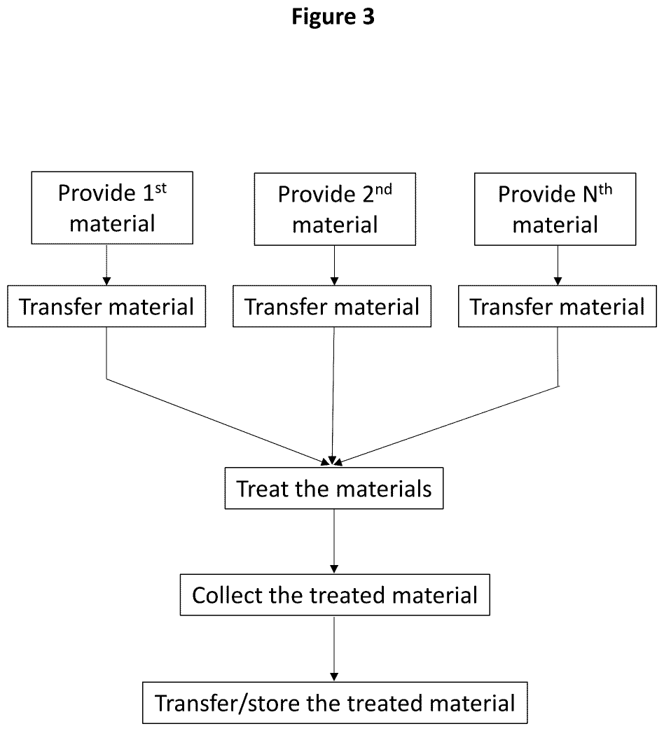

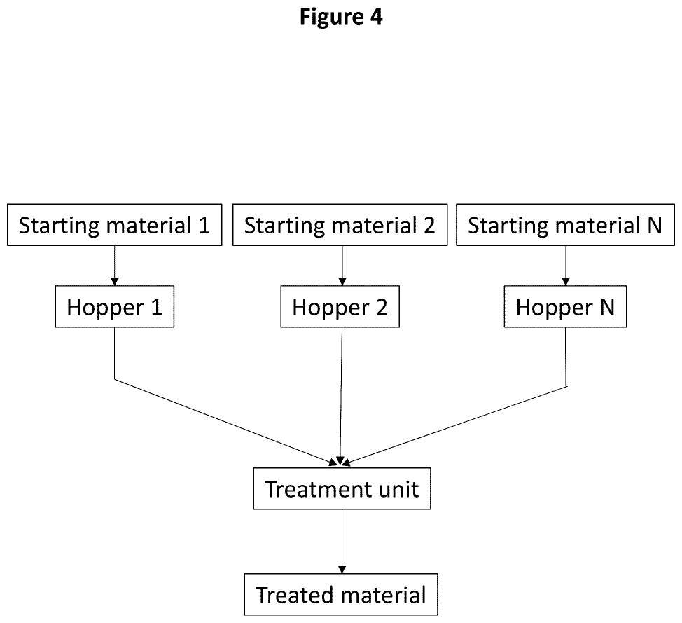

In certain embodiments, provided herein are systems and methods for treating one or more starting materials to produce a cementitious product (FIGS. 3 and 4). In certain embodiments, one or more starting materials are provided from a storage unit of the starting material, such as a silo, and the one or more starting materials are separately transferred from their respective storage units to a treatment unit, where the one or more starting materials are mixed together and, generally, further treated, e.g., to reduce the size of the materials and/or to activate the materials. In certain embodiments, at least a portion of the starting materials are converted from a crystalline state to an amorphous state.

In certain embodiments provided herein is a system for treating one or more starting materials to produce a cementitious product comprising (i) a first source of a first starting material; (ii) a second source of a second starting material; and (iii) a treatment unit where the first and second starting materials are treated to produce a cementitious product, wherein the first and second sources are operably connected to the treatment unit. The treatment unit can be configured so that it does not utilize milling or grinding. The treatment unit can be configured so that it does not supply exogenous heat to the starting materials. The treatment unit can be configured to cause all starting materials to enter the treatment unit simultaneously. The treatment unit can be configured to allow continuous treatment of the starting material. The treatment unit can be configured to treat starting materials while they reside in the treatment unit for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. The system can further comprise an outlet where cementitious product exits the treatment unit. The system can further comprise a packaging unit for packaging cementitious product and/or a storage unit for storing cementitious product, operably connected to the outlet.

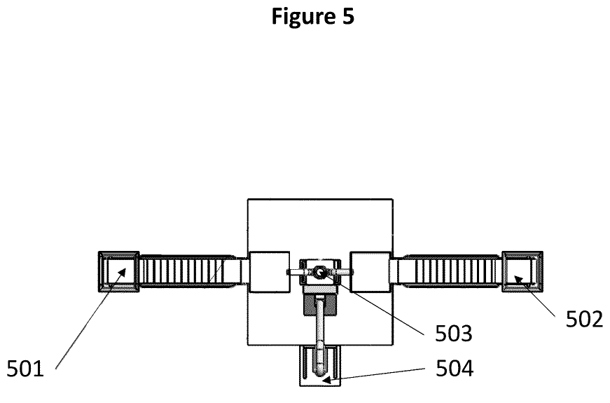

An exemplary system for treating one or more starting materials to form a product, for example a cementitious product, is shown in FIG. 5. Specifically, FIG. 5 shows a system for transporting a first starting material from a first source (501) and a second starting material from a second source (502) to a treatment unit (503), where the first and second starting materials are treated, e.g., by mixing, size reduction, and/or activation, to produce treated material. The treatment unit may be any suitable treatment unit, so long as the final material produced by the treatment unit has the desired properties. In certain embodiments, the treatment unit does not utilize milling or grinding. In certain embodiments, the treatment unit does not heat the materials, though the materials may undergo one or more exothermic processes in the unit and develop heat. In certain embodiments, the treatment unit is configured to allow all materials to enter simultaneously (e.g., from a single conduit), which can be positioned so that materials enter a treatment chamber at an angle from a central shaft, e.g., not vertically, if the central shaft is vertical, e.g., at an angle of at least 5, 10, 15, 20, 25, 30, 35, 40, 45, 50, 55, 60, 65, 70, or 75° from vertical and/or not more than 10, 15, 20, 25, 30, 35, 40, 45, 50, 55, 60, 65, 70, 75, or 80° from vertical; preferably 20-70° from vertical, more preferably 30-60° from vertical, even more preferably 40-50° from vertical. In certain embodiments, the treatment unit is configured to allow continuous treatment, i.e., continuous feed into the unit and continuous exit of treated material from the unit; in certain of these embodiments, the treatment unit is configured to treat materials while they reside in the unit for a short time, e.g., less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. In certain embodiments, the treatment unit is an impact mixer, such as an impact mixer as described herein. The treated material exits the treatment unit (503) at an outlet (504) for transfer, storage, packaging, or any other suitable further processing. In certain embodiments, material from the treatment unit is directed to one or more containers that are ready to ship to users, for example a bag. Any suitable transfer system can be incorporated to deliver the one or more starting materials from their sources (501 and 502) to the treatment unit (503), such as a conveyer and/or a hopper. The system can be configured to accept any suitable number of starting materials into the treatment unit (503), such as at least 1, 2, 3, 4, 5, 6, 7, 8, 9, 10, 11, 12, 13, 14, 15, 16, 17, 18, or 19 and/or no more than 20, 19, 18, 17, 16, 15, 14, 13, 12, 11, 10, 9, 8, 7, 6, 5, 4, 3, or 2 starting materials, for example 1-20 starting materials, preferably 1-10 starting materials, more preferably 2-8 starting materials, even more preferably 2-7 starting materials, yet more preferably 2-5 starting materials.

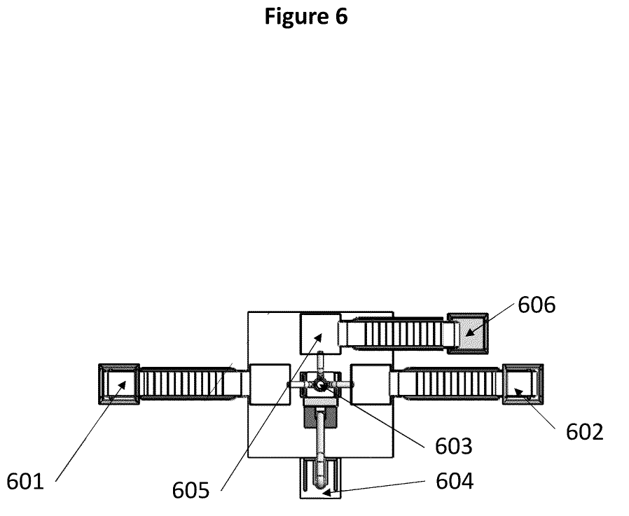

In certain embodiments, the system further comprises a packaging unit for packaging product, e.g., cementitious product, and/or a storage unit for storing product, e.g., cementitious product. An exemplary system is shown in FIG. 6. Specifically, FIG. 6 shows a system for transporting a first starting material from a first source (601) and a second starting material from a second source (602) to a treatment unit (603). The treated material exits the treatment unit (603), and can be directed to either a packaging system (604) or a transfer system (605) that directs the mixed/activated material to a storage unit (606).

Thus, in certain embodiments, provided herein are methods for treating one or more starting materials to produce one or more cementitious products comprising introducing the one or more starting materials into an impact mixer, where they are subjected to impact mixing, to produce the one or more cementitious products. In certain embodiments the one or more starting materials comprising one or more cement precursors. Cement precursor(s) can be any suitable cement precursor(s), such as cement precursors described herein, e.g, one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In certain embodiments, cement precursor materials comprise one or more aluminosilicates and/or one or more poly(ferro-sialate)s, such as one or more of lagoon ash (e.g., an aqueous environment for containing ash from a power station, metal processing, mining, mineral processing, and the like), basic oxygen slag (BOS), electric arc furnace (EAF) slag, mill scale (e.g., from an electric arc furnace), desulferization slag (e.g., from an electric arc furnace, blast furnace, or the like), black/white slag (e.g., from an electric arc furnace), fly ashes (e.g., from coal, steel production, mining, and the like), blast furnace flue dust, red mud (from aluminum production), and/or iron ore agglomerate (e.g., from mining tailings) In certain embodiments, the one or more starting materials also comprise one or more activating agents. Activating agent(s) can be any suitable activating agent(s), such as alkaline activator(s), e.g., alkaline activating agents as described herein, e.g., potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, one or more cement precursors and one or more alkaline activating agents are introduced into the impact mixer in a single feed stream. They are treated by impact mixing to produce one or more cementitious products, e.g., one or more geopolymer cements. The treatment can be continuous, i.e., a feed stream is fed to the impact mixer and a product stream exits the impact mixer, in a continuous process. The process may include no grinding or milling. The process may include no addition of exogenous heat. In certain embodiments, the starting materials reside in the impact mixer for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. The time the materials reside in the mixer can be the average time from introduction of starting materials into the mixer to exit of cementitious product from the mixer (e.g., in a continuous process). The one or more cementitious products, e.g., one or more geopolymer cements, may be further processed after exiting the impact mixer. In certain embodiments, the one or more cementitious products, e.g., one or more geopolymer cements, are ready for their intended use when exiting the impact mixer, and further processing may include packaging the one or more cementitious products, e.g., one or more geopolymer cements, e.g., for transport to one or more use sites, e.g., by bagging or otherwise containing the one or more cementitious products, e.g., one or more geopolymer cements. In certain embodiments, the one or more cementitious products, e.g., one or more geopolymer cements, may be transported to one or more storage containers. The impact mixer can be any suitable impact mixer, such as an impact mixer described herein.

Also provided herein are system for producing cementitious material, wherein the system comprises (i) one or more sources of starting materials operably connected to (ii) an impact mixer configured to treat the starting materials to produce a cementitious product. The one or more sources of starting materials can comprise a source of cement precursor and a source of alkaline activating agent. The impact mixer can be any suitable impact mixer, such as an impact mixer as described herein. Generally, an impact mixer will be configured to reduce the size of starting materials and mix the materials; without being bound by theory, it is thought that impact mixing also activates materials, e.g., causes interactions between materials to produce or augment cementitious properties. In certain embodiments, the impact mixer comprises (a) a conduit operably connected to one or more sources of starting materials and to the impact mixer, to introduce the starting materials into the impact mixer, (b) a shaft to which are attached one or more blades, wherein the shaft and the blades are enclosed in a cylindrical chamber that is operably connected to the conduit, wherein the impact mixer is configured to rotate the shaft at a desired rate. The system is configured to rotate the shaft, e.g., by a motor, for example, at a speed of at least 100, 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, or 5800 RPM and/or not more than 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, 5800, or 6000 RPM, for example 100-6000 RPM, preferably 500-5000 RPM, more preferably 1000-2000 RPM. The one or more blades can comprise at least 1, 2, 3, 4, 5, 6, 8, 10, 12, 14, 16, 20, 24, 28, or 32 and no more than 36, 32, 28, 24, 20, 16, 14, 12, 10, 8, 6, 5, 4, 3, or 2 blades attached to the shaft, for example 1-32 blades, preferably 4-28 blades, more preferably 8-24 blades, even more preferably 10-20 blades, yet more preferably 12-16 blades. Each blade can comprise a base, having a first length, attached to a hub that is further attached to the shaft, and a tip, distal to the proximal base and having a second length, where the surface of the tip is adjacent to but not in contact with the cylindrical chamber. In certain embodiments, the ratio of the second length to the first length is at least 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 at nor more than 5, 2, 1.9, 1.8, 1.7, 1.6, 1.5, 1.4, 1.3, 1.2, 1.1, 1, 0.9, 0.8, 0.7, 0.6, 0.5, 0.4, 0.3, or 0.2, for example 0.2-5, preferably 0.2-2, more preferably 0.2-1, even more preferably 0.2-0.8, yet more preferably 0.4-0.6; in certain embodiments, the ratio is 0.5. In certain embodiments, the shaft is vertical and the blades are positioned at an angle relative to horizontal that is at least 5, 10, 15, 20, 25, 30, 35, 40, 45, 50, 55, 60, 65, 70, 75, or 80° and/or no more than 10, 15, 20, 25, 30, 35, 40, 45, 50, 55, 60, 65, 70, 75, 80, or 85°, for example 5-85°, preferably 25-75, more preferably 45-75°. The conduit for introducing starting materials can be positioned at an angle to the the cylinder, e.g., if the cylinder is vertical, the angle is at least 5, 10, 15, 20, 25, 30, 35, 40, 45, 50, 55, 60, 65, 70, or 75° from vertical and/or not more than 10, 15, 20, 25, 30, 35, 40, 45, 50, 55, 60, 65, 70, 75, or 80° from vertical; preferably 20-70° from vertical, more preferably 30-60° from vertical, even more preferably 40-50° from vertical. The impact mixer can further an exit through which cementitious product exits the mixer; this exit can be operably connected to a processing system for processing the cementitious product, such as a packaging system to package the cementitious product for transport to an end user. The system can further comprise one or more pre-processing units operably connected to the one or more sources of starting materials, to pre-process the starting materials before introduction into the impact mixer. Pre-processing and pre-processing units can be as described herein, e.g., pre-processing to perform one or more of crushing, microwaving, and/or exposing to ultrasound. The system can be configured for continuous operation, i.e., continuous introduction of starting materials and continuous exit of cementitious product. In certain embodiments, the system is configured to treat the starting materials to produce a cementitious product in less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. It will be appreciated that residence time (e.g., as determined by feed rate and volume of the cylindrical chamber), rotation speed of the blades, angle of the blades, and other parameters can be adjusted to produce desired materials, such as the cementitious materials, e.g., geopolymer cements as described herein.

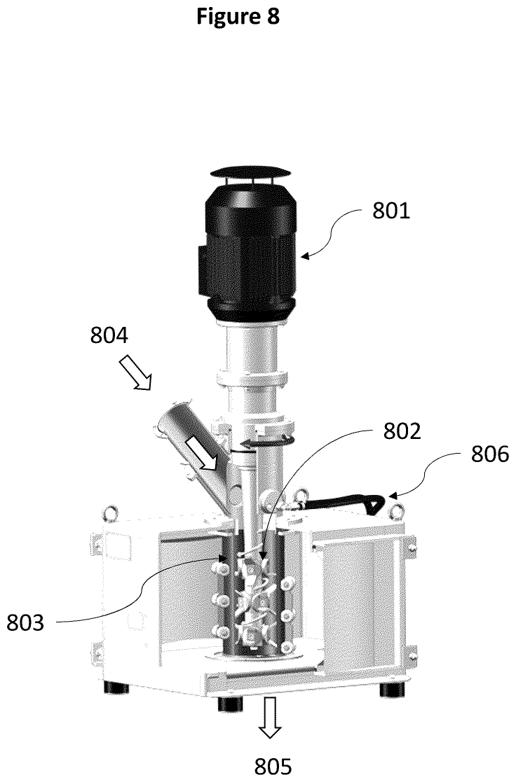

FIG. 8 illustrates an exemplary system for treating one or more starting materials to form a cement composition, where the system comprises an impact mixer. Specifically, the system in FIG. 8 comprises a motor (801) connected to a shaft comprising one or more blades (802). The one or more blades are configured to reside within a cylindrical chamber (803) comprising a top and a bottom, wherein the top of the cylindrical chamber (803) is configured to receive one or more materials from an inlet conduit (804), and the bottom of the cylindrical chamber (803) is configured to pass treated material to an outlet (805). The system can be further configured to comprise one or more inlets for gaseous or liquid reagents (806) connected to the cylindrical chamber (803).

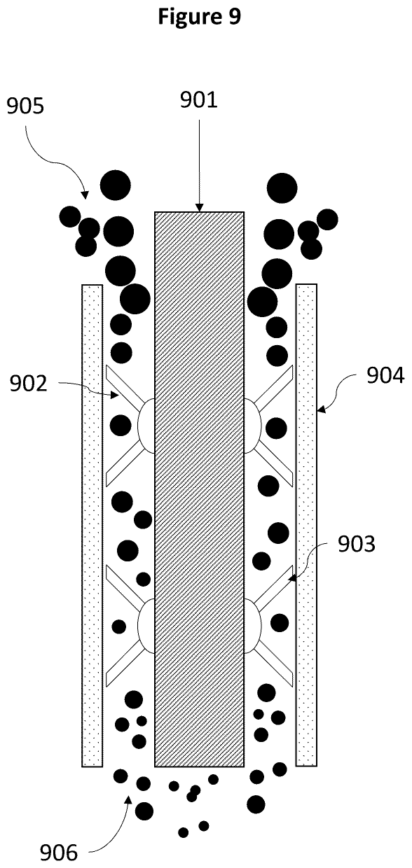

Any suitable number of blades can be attached to the shaft (802). In certain embodiments, the system comprises at least 1, 2, 3, 4, 5, 6, 8, 10, 12, 14, 16, 20, 24, 28, or 32 and no more than 36, 32, 28, 24, 20, 16, 14, 12, 10, 8, 6, 5, 4, 3, or 2 blades attached to the shaft, for example 1-32 blades, preferably 4-28 blades, more preferably 8-24 blades, even more preferably 10-20 blades, yet more preferably 12-16 blades. As illustrated in FIG. 9, the system can comprise a shaft (901) comprising a plurality of sets of blades, wherein a first set of blades (902) is positioned at a length of the shaft (901) between the top and the middle of the cylindrical chamber (904), and a second set of blades (903) is positioned at a length of the shaft (901) between the bottom and the middle of the cylindrical chamber (904). The system may comprise any suitable number of blade sets, such as at least 1, 2, 3, 4, 5, 6, 7, 8, or 9 and/or no more than 10, 9, 8, 7, 6, 5, 4, 3, or 2 blade sets, for example 1-10 blade sets, preferably 1-6 blade sets, more preferably 1-4 blade sets, yet more preferably 2-4 blade sets. The blade sets may be arranged to be aligned with each other or staggered. Further illustrated in FIG. 9, one or more starting materials (905) enters the top of the cylindrical chamber (904), wherein the starting material (905) is processed by the first set of blades (902) to form an intermediary material, wherein the intermediary material is then further processed by subsequent sets of blades (903) to form a mixed/activated product (906) that exits through the bottom of the cylindrical chamber (904).

The cylindrical chamber (904) can comprise any suitable material, such as a metal, rubber, or plastic, for example stainless steel, PEEK, natural rubber. In certain embodiments the chamber comprises stainless steel. The chamber can further comprise structural features that aid in the mixing process, for example corrugations, channels, and/or blades.

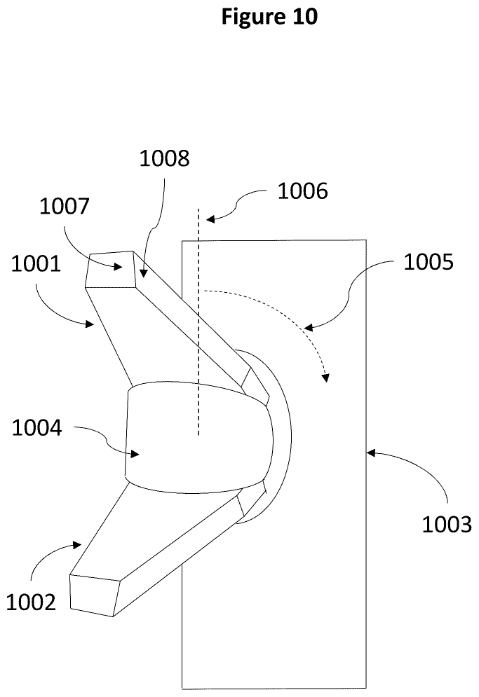

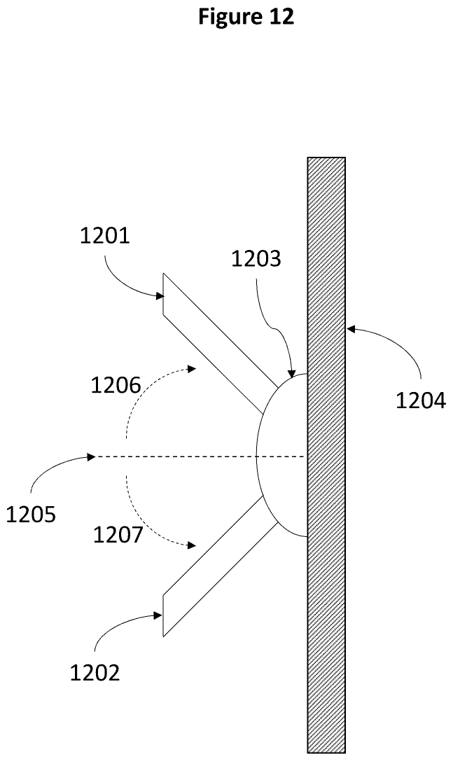

The blades can be attached to the shaft using any suitable attachment, such as a hub. As illustrated in FIG. 10, a first upper blade (1001) and a second lower blade (1002) are attached to the shaft (1003) using a hub (1004). The hub can be configured to attach to the hub at any suitable angle (1005) relative to the long axis of the shaft (1006), such as 0-90° relative to the long axis of the shaft (1006), preferably 0-20°, more preferably 0-60°, even more preferably 0-90°. As shown in FIG. 12, the blades (1201 and 1202) can be positioned on the hub at any angle (1207 and 1208) relative to the horizontal (1205). In certain embodiments, the angle relative to the horizontal is at least 5, 10, 15, 20, 25, 30, 35, 40, 45, 50, 55, 60, 65, 70, 75, or 80° and/or no more than 10, 15, 20, 25, 30, 35, 40, 45, 50, 55, 60, 65, 70, 75, 80, or 85°, for example 5-85°, preferably 25-75, more preferably 45-75. A different blade angle may be preferred for different combinations of starting materials depending on the prosperities of the starting materials, for example type of material, combination of materials, median particle size, desired product, wherein different blade angles may affect the resulting quality of product produced after treatment. As shown in Examples 12-14, a blade angle of 75°, 48°, and 68° respectively were used to treat the starting materials to the exemplary cement and resulting concrete compositions.

In certain embodiments, the surface of the tip (1007) of the blade is parallel to the surface of the cylindrical chamber. In certain embodiments, the surface is flat. In other embodiments, the surface of the tip comprises a curvature that matches the curvature of the cylindrical chamber. The tip of the blade can be any suitable distance from the inner surface of the cylinder; generally, the distance is kept to a minimum, so that particles do not move past the blades without contacting them.

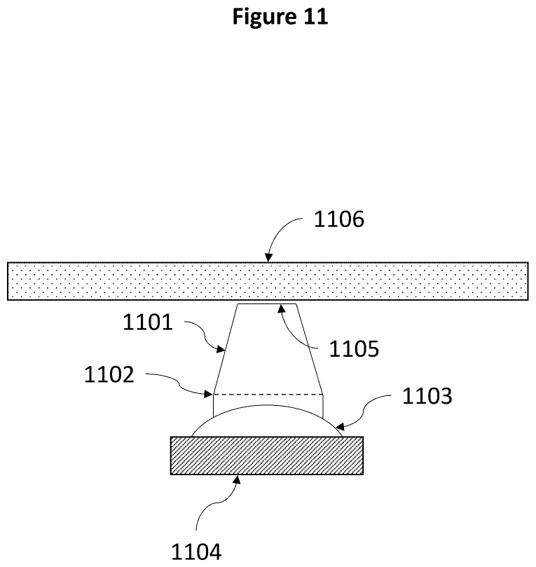

The blade can comprise any suitable shape. In certain embodiments, (as illustrated in FIG. 11) the blade (1101) comprises a base (1102) attached to a hub (1103) further attached to a shaft (1104) and a tip (1105) distal to the proximal base, wherein the surface of the tip is adjacent to but not in contact with the cylindrical chamber (1106). In certain embodiments, the ratio of the length of the distal tip to the length of the proximal base is at least 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 at nor more than 5, 2, 1.9, 1.8, 1.7, 1.6, 1.5, 1.4, 1.3, 1.2, 1.1, 1, 0.9, 0.8, 0.7, 0.6, 0.5, 0.4, 0.3, or 0.2, for example 0.2-5, preferably 0.2-2, more preferably 0.2-1, even more preferably 0.2-0.8, yet more preferably 0.4-0.6; in certain embodiments, the ratio is 0.5. In certain embodiments, the side of the blade (1008) is flat. In certain embodiments, the side of the blade (1008) comprises a sharpened edge. Any suitable edge shape can be used, such as a V-edge, a compound bevel, a convex edge, a hollow edge, or a chisel edge. The edge angle of the sharpened blade can be any suitable angle. In certain embodiments, the edge angle is at least 10, 15, 20, 25, 30, 35, 40, or 45° and/or no more than 50, 45, 40, 35, 30, 25, 20, or 15°, for example 10-50°.

The blade can comprise any suitable material, for example steel, tungsten, or diamond. In certain embodiments, the blade comprises a material with a hardness higher than the materials to be treated. In certain embodiments, the blade comprises stainless steel or tungsten steel. The blade can further be coated with any suitable material, such as a ceramic or plastic coating. In certain embodiments, the coating on the blade prevents the metal from interacting with the materials during treatment.

The shaft can be rotated at any suitable speed, such as at least 100, 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, or 5800 RPM and/or not more than 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, 5800, or 6000 RPM, for example 100-6000 RPM, preferably 500-5000 RPM, more preferably 1000-2000 RPM. Different rotation rates may be preferred for different combinations of starting materials depending on, e.g., the properties of the starting materials, for example type of material, combination of materials, median particle size, desired product, wherein different rotation rates may affect the resulting quality of product produced after treatment. As shown in Examples 12-14, a blade angle of 1200, 1500, and 1800 RPM respectively were used to treat the starting materials to the exemplary cement and resulting concrete compositions. In certain embodiments, the shaft can be rotated at 1000-2000 RPM, preferably 1200-1800 RPM.

The inlet (804) can be positioned at any suitable angle with respect to the central shaft so that materials enter a treatment chamber at an angle from a central shaft, e.g., not vertically, if the central shaft is vertical, e.g., at an angle of at least 5, 10, 15, 20, 25, 30, 35, 40, 45, 50, 55, 60, 65, 70, or 75° from vertical and/or not more than 10, 15, 20, 25, 30, 35, 40, 45, 50, 55, 60, 65, 70, 75, or 80° from vertical; preferably 20-70° from vertical, more preferably 30-60° from vertical, even more preferably 40-50° from vertical.

In certain embodiments, the treatment unit is configured to allow continuous treatment, i.e., continuous feed into the unit and continuous exit of treated material from the unit; in certain of these embodiments, the treatment unit is configured to treat materials while they reside in the unit for a short time, e.g., less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. The residence time of material in the treatment unit can be a function of the feed rate of material into the treatment unit as well and the length of the cylindrical chamber (802). For a given chamber length, any suitable feed rate may be used to generate a desired treatment time. In certain embodiments the feed rate is at least 100, 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, or 5800 kg/hr and/or not more than 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, 5800, or 6000 kg/hr, for example 100-6000 kg/hr, preferably 2000-5000 kg/hr, more preferably 3500-4500 kg/hr. A different feed rate may be preferred for different combinations of starting materials depending on the prosperities of the starting materials, for example type of material, combination of materials, median particle size, desired product, wherein different feed rate may affect the resulting quality of product produced after treatment. As shown in Examples 12-14, feed rates of 3800, 4200, 3600 kg/hr respectively were used to treat the starting materials to the exemplary cement and resulting concrete compositions. In certain embodiments, the treatment time is no more than 30, 20, 25, 20, 15, 10, 5, 4, 3, or 2 seconds. It is surprising and unexpected that one or more starting materials can be processed into a cementitious product ready for packaging with such short treatment times.

In certain embodiments, the rotation of the blades creates air flow through the cylindrical chamber during treatment. In certain embodiments, the operation of the treatment unit generates little to no heat. In certain embodiments, air flow through the chamber during operation prevents the system from heating to more than 5, 10, or 15° over ambient temperature. It is further surprising and unexpected that one or more non-cementitious starting materials can be processed into a cementitious product ready for packaging with such short treatment times without heating.

Any of the systems to produce a cementitious product from starting materials may further comprise a control system, e.g., comprising sources of input to a processor, e.g., one or more sensors that send information regarding one or more aspects of the process to the processor; the processor, which processes the information and produces an output; and one or more actuators that receive output from the processor and that modulate one or more aspects of the process, to automate at least a portion of the process. Exemplary sensors include one or more of a flow rate sensor, e.g., to sense flow of starting materials into a treatment unit, such as an impact mixer, a timing sensor, to sense elapsed time or other times, and the like. The processing unit can be any suitable processing unit, such as a computer or the like. Actuators can include one or more valves, e.g., for regulating flow of starting materials, a unit to rotate a shaft in, e.g., an impact mixer, and the like.

In certain embodiments, provided is a network comprising a plurality of spatially separate geopolymer production systems, wherein each of the systems send information regarding one or more aspects of one or more processes at the system to a central processing unit. The central processing unit can process the information and send output to one or more of the spatially separate geopolymer production systems, such as output that causes a change in the one or more spatially separate geopolymer production systems. In certain embodiments, the network comprises at least 2, 3, 4, 5, 6, 7, 8, 10, 12, 15, 20, 25, 30, 40, 50, 70, 100, 200, or 500 spatially separate geopolymer production systems and/or not more than 3, 4, 5, 6, 7, 8, 10, 12, 15, 20, 25, 30, 40, 50, 70, 100, 200, 500, or 1000 spatially separate geopolymer production systems. The central processing unit may be a single unit or a plurality of units, and can be, e.g., distributed, such as a cloud-based system. The processing unit can be configured to learn from information provided by the various systems and adjust conditions at one or more systems based, at least in part, on the learning. Any suitable geopolymer production systems may be networked; in certain embodiments, at least one of the geopolymer production systems comprises an impact mixer.

The temperature at various stages of the process may be any suitable temperature. In certain embodiments, the temperature is at or near room temperature, e.g., 1-40° C., or 3-30° C., or 5-25° C., or 10-25° C., or 6-18° C., for example, in embodiments in which no exogenous heat is added. In certain embodiments, an elevated temperature is used during one or more stages of the process, for example, a temperature of at least 30, 40, 50, 60, 70, 80, 90, 100, 110, 120, 130, 150, 170, 190, 200, 250, 300, 350, 400, 450, 500, 600, 700, 800, 900, 1000, 1200, or 1400° C., and/or not more than 40, 50, 60, 70, 80, 90, 100, 110, 120, 130, 150, 170, 190, 200, 250, 300, 350, 400, 450, 500, 600, 700, 800, 900, 1000, 1200, 1400, or 1500° C., for example, 30-300° C., or 50-300° C., or 80-250° C., or 50-200° C., or 60-180° C., or 70-150° C., or 80-120° C., or 90-100° C., or 100-300° C., or 150-250° C., or 180-220° C., or 100-600° C., or 200-600° C., or 300-600° C., or 300-500° C., or 350-450° C., or 100-1500° C. In certain embodiments, materials are processed at a temperature at which calcination does not occur. Materials can be heated at any suitable stage, for example, before grinding takes place, for up to 24, 22, 20, 18, 16, 14, 12, 10, 8, 6, 5, 4, 3, 2, or 1 hour; additionally or alternatively, a suitable temperature can be used during one or more of the size reduction processes, such as grinding or milling of cementitious replacement materials, in some cases with alkaline activating materials, bonding materials, and/or setting time enhancer materials. Stages of processing are described more fully below.

It will be appreciated that the systems and methods herein differ from previous systems and methods for producing geopolymer cement in one or more ways. Thus, in certain embodiments, provided is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises at least one of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In certain embodiments, provided is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises at least two of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In certain embodiments, provided is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises at least three of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In certain embodiments, provided is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises at least four of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In certain embodiments, provided is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises (i) the method is a continuous method; (ii) combining and treating has a duration of not more than 60 seconds; (iii) the method does not require grinding or milling; (iv) the method not require addition of exogenous heat during the combining and/or treating; and (v) the method produces geopolymer cement that is ready to use.

In certain embodiments provided is a method for treating one or more cement precursors and one or more alkaline activating agents to produces a cementitious product, e.g., a geopolymer cement, wherein the method does not require, and does not utilize, grinding or milling and does not require, and does not utilize addition of exogenous heat to the materials, and wherein the materials are treated for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. The method can be continuous. In certain embodiments, provided is a dry particulate material, such as a geopolymer cement, produced by the method.

In certain embodiments, one or more components of a cementitious mix as provided herein may be exposed to carbon dioxide and/or to methane, as described further below.

The methods and systems provided herein can produce geopolymer cements. In certain embodiments, provided is a dry particulate composition comprising (i) one or more cementitious replacement materials (cement precursors); (ii) one alkaline activating materials (alkaline activating agents). The dry particulate composition can comprise, e.g., a geopolymer cement, such as a geopolymer cement produced by one of the methods or systems described herein, such as a geopolymer cement produced in a method or system that does not utilize grinding or milling and/or that does not utilize exogenous heat provided to starting materials; exemplary systems and methods include those in which starting materials are treated in an impact mixer. In certain embodiments, the particles of the particulate composition are in a size range of 0.1-1000 um, or 0.1-500 um, or 0.1-400 um, or 0.1-300 um, or 0.1-200 um, or 0.5-1000 um, or 0.5-500 um, or 0.5-400 um, or 0.5-300 um, or 0.5-200 um, or 1-1000 um, or 1-500 um, or 1-400 um, or 1-300 um, or 1-200 um, 1-500 um, preferably 1-100 um, more preferably 2-50 um, even more preferably 3-40 um, and yet even more preferably 5-30 um. In certain embodiments, at least 1, 2, 3, 4, 5, 7, 10, 12, 15, 17, 20, 22, 25, 30, 40, or 50% of the one or more cement precursors is in amorphous form, preferably at least 5%, more preferably at least 10%, even more preferably at least 15%. In certain embodiments, the one or more cement precursors are present at a wt % of at least 20, 30, 40, 50, 55, 60, 65, 70, 75, 80, 85, 90, or 95% and/or not more than 30, 40, 50, 55, 60, 65, 70, 75, 80, 85, 90, 91, 92, 93, 94, 95, 96, 97, 98, or 99%, for example 50-99.9%, 50-99.5%, 50-99%, 50-98%, 50-97%, 50-95%, 50-90%, 50-80%, 50-70%, 50-60%, 60-99.9%, 60-99.5%, 60-99%, 60-98%, 60-97%, 60-95%, 60-90%, 60-80%, 60-70%, 70-99.9%, 70-99.5%, 70-99%, 70-98%, 70-97%, 70-95%, 70-90%, 70-80%, 75-99.9%, 75-99.5%, 75-99%, 75-98%, 75-97%, 75-95%, 75-90%, 75-80%, 80-99.9%, 80-99.5%, 80-99%, 80-98%, 80-97%, 80-95%, 80-90%, 85-99.9%, 85-99.5%, 85-99%, 85-98%, 85-97%, 85-95%, 85-90%, 90-99.9%, 90-99.5%, 90-99%, 90-98%, 90-97%, or 90-95%, in preferred embodiments, 50-99.5%, in more preferred embodiments 60-98%, in even more preferred embodiments, 75-97%; the one or more alkaline activating materials (alkaline activating agents) may be present at a wt % of 0.25-40%, 0.25-30%, 0.25-20%, 0.25-10%, 0.25-5%, 0.25-3%, 0.25-2%, 0.25-1%, 0.5-40%, 0.5-30%, 0.5-20%, 0.5-10%, 0.5-5%, 0.5-3%, 0.5-2%, 0.5-1%, 1-40%, 1-30%, 1-20%, 1-10%, 1-5%, 1-3%, 1-2%, 2-40%, 2-30%, 2-20%, 2-10%, 2-5%, 2-3%, 5-40%, 5-30%, 5-20%, or 5-10%, in preferred embodiments 1-25%, in more preferred embodiments 1-20%, in still more preferred embodiments 1-15%, in yet more preferred embodiments 1-10%, or even 1-5%. In preferred embodiments the, the one or more cement precursor materials (cement precursors) comprise one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In even more preferred embodiments, cement precursor materials (cement precursors) comprise one or more aluminosilicates and/or one or more poly(ferro-sialate)s, such as one or more of lagoon ash (e.g., an aqueous environment for containing ash from a power station, metal processing, mining, mineral processing, and the like), basic oxygen slag (BOS), electric arc furnace (EAF) slag, mill scale (e.g., from an electric arc furnace), desulferization slag (e.g., from an electric arc furnace, blast furnace, or the like), black/white slag (e.g., from an electric arc furnace), fly ashes (e.g., from coal, steel production, mining, and the like), blast furnace flue dust, red mud (from aluminum production), and/or iron ore agglomerate (e.g., from mining tailings). In certain of these preferred embodiments, the one or more cement precursors comprise at least two of lagoon ash, basic oxygen slag (BOS), electric arc furnace (EAF) slag, mill scale, desulferization slag, black/white slag, fly ashes, blast furnace flue dust, red mud, and/or iron ore agglomerate. In certain embodiments, the one or more alkaline activating materials (alkaline activating agents) comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, the one or more alkaline activating materials (alkaline activating agents) comprise at least two of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, the dry particulate material, e.g., geopolymer cement, is produced in a process that, for a given amount of the dry particulate material, e.g., geopolymer cement produces 40-100% at least 40, 45, 50, 55, 60, 65, 70, 75, 80, 85, 90, 95, or 97% and/or not more than 45, 50, 55, 60, 65, 70, 75, 80, 85, 90, 95, 97, 98, 99, or 100% less carbon dioxide than production of the same amount of non-geopolymer cement in a process that comprises calcining limestone, preferably at least 50% less, more preferably at least 70% less, yet more preferably at least 75% less. Reductions in carbon dioxide production can be calculated by any suitable method, e.g., life cycle analysis (LCA), as is known in the art. See Examples 12-14. In certain embodiments, provided is a wet cement composition comprising any of the above compositions and also comprising water and an admixture comprising a silicate compound and a hydroxide compound. In preferred embodiments, the silicate compound and the hydroxide compound are present at a molar ratio of 0.5 to 3.0, preferably 1.0-2.0, more preferably 1.0-1.5 silicate:hydroxide. In certain embodiments, the cementitious replacement material or materials comprises blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments, the product, e.g., when combined with water, optionally admixture comprising a silicate compound and a hydroxy compound and, optionally, aggregates has a compressive strength of 30-400 MPa after addition of water and setting and hardening. In certain embodiments, provided is a solid product derived from any of the compositions previously described in this paragraph wherein the product has one, two, three, four, five, six, or all of (i) a compressive strength of 30-400 MPa; (ii) a tensile strength of 10-75 MPa; (iii) a modulus of elasticity of 40-120 GPa; (iv) a pore volume range of 0.5-5%; (v) a water sorptivity coefficient of 0.001 to 0.055 kg/m²/h^{0.5} (vi) a fire resistivity range of 500° C. to 2000° C.; (vii) a carbon dioxide emission reduction of 40-98% compared to a product with similar properties made with conventional cement.

Treatment to Produce a Plurality of Size Ranges

In certain embodiments, cementitious replacement materials, alone or in combination with alkaline activation materials, bonding materials, and/or setting time enhancer materials, are treated to produce particulate materials within e.g., at least 1, 2, 3, 4, 5, 6, or 7 different size ranges; in certain cases, within a plurality of desired size ranges, e.g., at least 2, 3, 4, 5, 6, or 7 different size ranges. Without being bound by theory, it is thought that the treatment, such as grinding or milling, in some embodiments, without grinding or milling, may also serve to activate or otherwise alter the mechanochemistry of the mixture in certain steps.

In the simplest case, all of one or more cementitious replacement materials, one or more alkaline activating materials, are combined and processed together to produce one desired final size range. See, e.g., processes described previously.

In other cases, all of one or more cementitious replacement materials, one or more alkaline activating materials, and, optionally, one or more bonding materials and/or setting time enhancer materials are combined and processed together to produce two, three, four, five or more desired final size ranges; this can be done in separate batches and/or in one or more batches with portions removed at different stages, or a combination thereof. In other cases, the process may start with one or more cementitious materials processed to produce a desired size range, with or without alkaline activating materials also present, then other materials are added at later stages, e.g., one or more alkaline activating materials, one or more bonding materials, one or more setting time enhancer materials. Thus, in certain embodiments materials may be treated to produce a single size range, and in other embodiments materials may be treated to produce various stages at different size ranges, and the materials in the different size ranges may be combined to produce a cementitious mix with a desired distribution of sizes. A single batch may be treated to produce the desired material and, at different stages corresponding to different size ranges and/or different combinations of ingredients, one or more portions may be removed, then used in a final blend. Additionally or alternatively, a plurality of batches may be treated to produce different desired materials, and the batches combined in a final blend. Any suitable combination of the two approaches may be used. Size ranges can be determined by any suitable method, e.g., sieving, as is known in the art.

After pretreatment, if necessary, a first quantity of the one or more cementitious replacement materials is treated, e.g., by grinding or milling, for example, by disc milling, rotor milling, or vertical milling, to produce a first particulate material comprising the one or more cementitious replacement materials in a first size range. If a plurality of cementitious replacement materials is used, the materials may be treated together or one or more may be treated separately; if the latter, after treatment to obtain the desired size range the cementitious materials can be combined for the next step. The sizes of the particulate material can be separated by any suitable method, for example, by a range of mesh sizes in a series of sieves, or by vibration, or a combination thereof. An exemplary mill is the Retsch TM mill, which can be used, e.g., with 8-15 mm balls at 50-700 RPM for 1-20 min. Other ball sizes, RPM, and/or treatment times can be used, as appropriate for the materials, batch size, and other relevant characteristics. The size range achieved may be any suitable size range, for example, at least 50, 60, 70, 80, 85, 90, 95, 100, 105, 110, 115, 120, 125, 130, 135, 140, 145, 150, 155, 160, 165, 170, 175, 180, 190, 200, 220, or 250 um and/or not more than 60, 70, 80, 85, 90, 95, 100, 105, 110, 115, 120, 125, 130, 135, 140, 145, 150, 155, 160, 165, 170, 175, 180, 190, 200, 220, 250, or 300 um; for example, 50-250 um, such as 50-230, or 60-200, or 70-190, or 80-180, or 90-170, or 100-160, or 110-160, or 120-160, or 130-150 um. In certain embodiments, the size range is 130-150 um. In certain embodiments, the size range is 120-150 um. Some of the first particulate material may be set aside; alternatively or additionally, the process may stop at this point for the batch and other batches may be carried to further points in the process. In certain embodiments, one or more additional materials, e.g., alkaline activating materials, and, optionally, bonding materials and/or setting time enhancer materials, may be processed along with the cementitious replacement materials, even at this stage.

In certain embodiments, the one or more alkaline activating materials are not present during the first treatment and are added after the first treatment. In certain embodiments, one or more alkaline replacement materials are present during the first treatment; in some of these cases one or more additional alkaline activating materials are added after the first treatment. In any case, when all alkaline activating materials are added, the alkaline activating materials are present at a proportion as described herein, e.g., at 1-20% (total of all alkaline activating materials), to produce a combined cementitious replacement material/alkaline activation material. It has surprisingly been found that in some cases the alkaline activating material(s) need only be present for a limited amount of time during the grinding/milling in order for activation to occur, e.g., less than 30, 20, 10, 5, 4, 3, 2, 1, or 0.5 min. Thus, in certain embodiments, alkaline activating materials are added to the first particulate material at the start of a second size reduction process, or at some point after the start, such as at any suitable time as described herein, for example, less than 30, 20, 10, 5, 4, 3, 2, 1, or 0.5 minutes before the end of the process. If more than one alkaline activating material is used, the materials may be added at the same time or at different times in the size reduction process, e.g., grinding. In certain embodiments, alkaline activating materials are treated separately and not added to the mix until later in the process; in some cases, alkaline activating materials are not added until the final combination of all materials. In certain embodiments, one or more bonding materials and/or one or more setting time enhancement materials are added to the first material and processed along with the first material.

The combined cementitious replacement material/alkaline activation material, and, in some cases, bonding material and/or setting time enhancer material, which was either present at the start of the first step, or was produced by adding alkaline activation material (and in some cases bonding material and/or setting enhancement material) to the first particulate material, or even to the initial cementitious replacement materials (e.g., before pre-treatment) or both, can be further treated e.g., by grinding or milling, to produce a second particulate material within a second range of sizes, e.g., mesh sizes, wherein the second range of sizes, e.g., mesh sizes is smaller than the first range of sizes. The size range may be any suitable size range so long as it is smaller than the first size range, for example, at least 20, 30, 40, 50, 60, 70, 80, 85, 90, 95, 100, 105, 110, 115, 120, 125, 130, 135, 140, 145, 150, 155, 160, 165, 170, 175, 180, 190, 200, 210 or 220, um and/or not more than 30, 40, 50, 60, 70, 80, 85, 90, 95, 100, 105, 110, 115, 120, 125, 130, 135, 140, 145, 150, 155, 160, 165, 170, 175, 180, 190, 200, 220, or 250, um; for example, 20-220 um, such as 20-200, or 30-170, or 40-160, or 50-150, or 80-140, or 70-130, or 80-130, or 90-130, or 100-120 um. In certain embodiments, the size range is 100-120 um. Some of the second particulate material may be set aside; alternatively or additionally, the process may stop at this point for the batch and another batch or batches may be carried to further points in the process. If some of the second particulate material is set aside, any suitable amount may be removed, for example, at least 1, 2, 3, 4, 5, 7, 10, 12, 15, 20, 25, 30, 35, 40, or 45% and/or not more than 2, 3, 4, 5, 7, 10, 12, 15, 20, 25, 30, 35, 40, 45, or 50%, for example, 1-50%, or 2-45%, or 3-45%, or 4-45%, or 5-45%, or 5-40%, or 5-38%, or 5-30%, or 10-40% or 10-30% or 15-40% or 15-30% or 20-40% or 20-30%.

In certain embodiments, one or more bonding materials is added to the second particulate material. In certain embodiments, one or more setting time enhancing materials is added to the second particulate material. In certain embodiments, both one or more bonding materials and one or more setting time enhancers is added to the second particulate material. In any of these embodiments, the total amount of bonding material and/or setting time enhancer materials added is at least 0.1, 0.5, 1, 2, 5, 10, 15, 20, 25, 30, or 35% and/or not more than 0.5, 1, 2, 5, 10, 15, 20, 25, 30, or 40%, and can be any range as described herein, for example, 0.1-40%, or 0.5-30%, or 1-25%. In certain embodiments, neither bonding material nor setting time enhancer material is added to the second particulate material.

The second particulate material, with or without bonding material and/or setting time enhancer material, can be further treated e.g., by grinding or milling, to produce a third particulate material within a third range of sizes, e.g., mesh sizes, wherein the third range of sizes, e.g., mesh sizes is smaller than the second range of mesh sizes. The size range may be any suitable size range so long as it is smaller than the second size range, for example, at least 5, 10, 15, 20, 25, 30, 40, 50, 60, 70, 80, 85, 90, 95, 100, 105, 110, 115, 120, 125, 130, 135, 140, 145, 150, 155, 160, 165, 170, 175, or 180 um and/or not more than 10, 15, 20, 25, 30, 40, 50, 60, 70, 80, 85, 90, 95, 100, 105, 110, 115, 120, 125, 130, 135, 140, 145, 150, 155, 160, 165, 170, 175, 180, 190, or 200 um; for example, 5-200 um, such as 5-150, or 10-150, or 15-140, or 15-130, or 20-140, or 20-130, or 25-135, or 25-130, or or 30-120, or 30-125, or 30-100 um. In certain embodiments, the size range is 30-100 um. Some of the third particulate material may be set aside; alternatively or additionally, the process may stop at this point for the batch and another batch or batches may be carried to further points in the process. If some of the third particulate material is set aside, any suitable amount may be removed, for example, at least 1, 2, 3, 4, 5, 7, 10, 12, 15, 20, 25, 30, 35, 40, 45, or 50% and/or not more than 2, 3, 4, 5, 7, 10, 12, 15, 20, 25, 30, 35, 40, 45, 50, 55, 60, or %, for example, 1-65%, or 1-50%, or 1-25%, or 1-20%, or 2-65%, or 2-60%, or 2-30%, or 2-25%, or 2-20%, or 3-60%, or 3-55%, or 3-40%, or 3-30% or 3-25%, or 3-20%, or 4-60%, or 4-55%, or 4-54%, or 4-50%, or 4-40% or 4-30%, or 4-25% or 4-20%, or 5-60%, or 5-50%, or 5-40%, or 5-30% or 5-25%, or 5-20%, or 10-50% or 10-40% or 10-30% or 10-20%.

The third particulate material may optionally be treated to reduce the size further, e.g., by grinding or milling, to produce a fourth particulate material within a fourth range of sizes, e.g., mesh sizes, wherein the fourth range of sizes, e.g., mesh sizes is smaller than the third range of mesh sizes. In certain embodiments, one or more bonding materials are added to the second particulate material before its treatment to produce the third particulate material and are present in the third particulate material and one or more setting time enhancers are added to the third particulate material, then it is treated to produce the fourth particulate material. In certain embodiments, one or more setting time enhancer materials are added to the second particulate material before its treatment to produce the third particulate material and are present in the third particulate material, and one or more bonding materials are added to the third particulate material, then it is treated to produce the fourth particulate material. In certain embodiments, a first combination of one or more bonding materials and one or more setting time enhancing materials are added to the second particulate material before its treatment to produce the third particulate material and are present in the third particulate material and a second combination of one or more bonding materials and one or more setting time enhancing materials, different from the first, is added to the third particulate material, then it is treated to produce the fourth particulate material. The size range may be any suitable size range so long as it is smaller than the third size range, for example, at least 0.1, 0.2, 0.5, 0.7, 1, 1.5, 2, 2.5, 3, 3.5, 4, 4.5, 5, 6, 7, 8, 9, 10, 12, 15, 17, 20, 22, 25, 27, 30, 35, 40, 50, 60, or 70 um, and/or not more than 0.2, 0.5, 0.7, 1, 1.5, 2, 2.5, 3, 3.5, 4, 4.5, 5, 6, 7, 8, 9, 10, 12, 15, 17, 20, 22, 25, 27, 30, 35, 40, 50, 60, 70, or 80 um, for example, 0.1-80, or 0.1-70, or 0.1-60, or 0.1-50, or 0.1-40, or 0.1-30, or 0.1-20 um, or 0.2-80, or 0.2-70, or 0.2-60, or 0.2-50, or 0.2-40, or 0.2-30, or 0.2-20 um, or 0.5-80, or 0.5-70, or 0.5-60, or 0.5-50, or 0.5-40, or 0.5-30, or 0.5-20 um, or 1-80, or 1-70, or 1-60, or 1-50, or 1-40, or 1-30, or 1-20 um, or 2-80, or 2-70, or 2-60, or 2-50, or 2-40, or 2-30, or 2-20 um, or 5-80, or 5-70, or 5-60, or 5-50, or 5-40, or 5-30, or 5-20 um, or 7-80, or 7-70, or 7-60, or 7-50, or 7-40, or 7-30, or 7-20 um, or 10-80, or 10-70, or 10-60, or 10-50, or 10-40, or 10-30, or 10-20 um. In certain embodiments, the size range is 0.1-30 um.

The second, third, and fourth particulate materials can be combined; in embodiments in which a fourth particulate material is not produced, the second and third particulate materials can be combined; the materials are mixed, e.g., by further processing in, e.g. a mill, for a short time, e.g., less than 5, 4, 3, 2, or 1 minute. In embodiments in which alkaline activating material was added before size reduction to produce the first particulate material, a portion of the first particulate material may also be used. The second particulate material may have been removed from a batch that was further processed to produce at least a third particulate material and optionally fourth particulate material, or may have been produced in a separate batch from the at least third and optionally fourth material, or a combination thereof. The third particulate material may have been removed from a batch that was further processed to produce the fourth particulate material, or may have been produced in a separate batch from the at least third fourth material, or a combination thereof. Similarly, in embodiments in which the first particulate material comprises alkaline activating material, a portion may be removed to be later recombined with other particulate materials, or separate batches may be used, or a combination thereof.

Any suitable variation of the above process may be used. One or more processing steps may be removed, and one or more materials may be added or removed at any step.

In certain embodiments, one or more of the alkaline activating materials, the bonding materials, if used, and/or the setting time enhancer materials, if used, is treated separately, e.g., by grinding or milling, from one or more of the other materials, e.g., separately from cementitious replacement materials, to achieve the desired size range.

The final product can be a product produced by any suitable combination of the above processes. In the simplest case, the final product comprises one or more cementitious replacement materials and one or more alkaline activating materials, and, optionally, one or more bonding materials and/or one or more setting time enhancers in a desired size range, such as at least 0.05, 0.1, 0.5, 1, 2, 3, 4, 5, 7, 10, 12, 15, 20, 30, 40, 50, 60, 70, 80, 90, 100, 120, 150, or 200 um and/or not more than 0.1, 0.5, 1, 2, 3, 4, 5, 7, 10, 12, 15, 20, 30, 40, 50, 60, 70, 80, 90, 100, 120, 150, 200 or 250 um, such as 0.1-250, 0.1-200, 0.1-150, 0.1-100, 0.1-70, 0.1-50, 0.1-40, 0.1-30, 0.1-20, or 0.1-10 um; or 0.5-250, 0.5-200, 0.5-150, 0.5-100, 0.5-70, 0.5-50, 0.5-40, 0.5-30, 0.5-20, or 0.5-10 um; or 1-250, 1-200, 1-150, 1-100, 1-70, 1-50, 1-40, 1-30, 1-20, or 1-10 um; for example, 0.1-30 um. In another case, the final product comprises a first particulate material comprising one or more cementitious replacement materials and one or more alkaline activating materials, and, optionally, one or more bonding materials and/or one or more setting time enhancers in first size range, such as at least 0.05, 0.1, 0.5, 1, 2, 3, 4, 5, 7, 10, 12, 15, 20, 30, 40, 50, 60, 70, 80, 90, 100, 120, 150, or 200 um and/or not more than 0.1, 0.5, 1, 2, 3, 4, 5, 7, 10, 12, 15, 20, 30, 40, 50, 60, 70, 80, 90, 100, 120, 150, 200 or 250 um, such as 0.1-250, 0.1-200, 0.1-150, 0.1-100, 0.1-70, 0.1-50, 0.1-40, 0.1-30, 0.1-20, or 0.1-10 um; or 0.5-250, 0.5-200, 0.5-150, 0.5-100, 0.5-70, 0.5-50, 0.5-40, 0.5-30, 0.5-20, or 0.5-10 um; or 1-250, 1-200, 1-150, 1-100, 1-70, 1-50, 1-40, 1-30, 1-20, or 1-10 um; for example, 0.1-30 um; and a second particulate material comprising one or more cementitious replacement materials and one or more alkaline activating materials, and, optionally, one or more bonding materials and/or one or more setting time enhancers in second size range, such as at least 2, 5, 10, 11, 12, 13, 14, 15, 17, 20, 25, 30, 35, 40, 45, 50, 60, 70, 80, 90, 100, 120, 150, 200, 250, 300, 350, or 400 um and/or not more than 5, 10, 11, 12, 13, 14, 15, 17, 20, 25, 30, 35, 40, 45, 50, 60, 70, 80, 90, 100, 120, 150, 200, 250, 300, 350, 400 or 450 um, such as 5-450, 5-300, 5-200, 5-100, 5-80, or 5-50 um, or 10-450, 10-300, 10-200, 10-100, 10-80, or 10-50 um; or 20-450, 20-300, 20-200, 20-100, 20-80, or 20-50 um; or 30-450, 3-300, 30-200, 30-100, 30-80, or 3-50 um for example, 30-100 um; the first and second particulate materials may be present in any suitable proportion of the final product, for example the first particulate material may be present at at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99% and the second particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%. In another case, the final product comprises a first particulate material comprising one or more cementitious replacement materials and one or more alkaline activating materials, and, optionally, one or more bonding materials and/or one or more setting time enhancers in first size range, such as at least 0.05, 0.1, 0.5, 1, 2, 3, 4, 5, 7, 10, 12, 15, 20, 30, 40, 50, 60, 70, 80, 90, 100, 120, 150, or 200 um and/or not more than 0.1, 0.5, 1, 2, 3, 4, 5, 7, 10, 12, 15, 20, 30, 40, 50, 60, 70, 80, 90, 100, 120, 150, 200 or 250 um, such as 0.1-250, 0.1-200, 0.1-150, 0.1-100, 0.1-70, 0.1-50, 0.1-40, 0.1-30, 0.1-20, or 0.1-10 um; or 0.5-250, 0.5-200, 0.5-150, 0.5-100, 0.5-70, 0.5-50, 0.5-40, 0.5-30, 0.5-20, or 0.5-10 um; or 1-250, 1-200, 1-150, 1-100, 1-70, 1-50, 1-40, 1-30, 1-20, or 1-10 um; for example, 0.1-30 um; a second particulate material comprising one or more cementitious replacement materials and one or more alkaline activating materials, and, optionally, one or more bonding materials and/or one or more setting time enhancers in second size range, such as at least 2, 5, 10, 11, 12, 13, 14, 15, 17, 20, 25, 30, 35, 40, 45, 50, 60, 70, 80, 90, 100, 120, 150, 200, 250, 300, 350, or 400 um and/or not more than 5, 10, 11, 12, 13, 14, 15, 17, 20, 25, 30, 35, 40, 45, 50, 60, 70, 80, 90, 100, 120, 150, 200, 250, 300, 350, 400 or 450 um, such as 5-450, 5-300, 5-200, 5-100, 5-80, or 5-50 um, or 10-450, 10-300, 10-200, 10-100, 10-80, or 10-50 um; or 20-450, 20-300, 20-200, 20-100, 20-80, or 20-50 um; or 30-450, 3-300, 30-200, 30-100, 30-80, or 3-50 um for example, 30-100 um; and a third particulate material comprising one or more cementitious replacement materials and one or more alkaline activating materials, and, optionally, one or more bonding materials and/or one or more setting time enhancers in third size range, such as at least 30, 35, 40, 45, 50, 60, 70, 80, 90, 100, 110, 120, 130, 140, 150, 170, 200, 220, 250, 300, 350, 400, 450, or 500 um and/or not more than 35, 40, 45, 50, 60, 70, 80, 90, 100, 110, 120, 130, 140, 150, 170, 200, 220, 250, 300, 350, 400, 450, 500 or 600 um for example, 50-500, 50-400, 50-300, 50-200, 50-150, or 50-100 um; or 70-500, 70-400, 70-300, 70-200, 70-150, or 70-100 um, or 100-500, 100-400, 100-300, 100-250, 100-200, 100-150, or 100-140 um, or 110-500, 110-400, 1100-300, 110-250, 110-200, 110-150, or 110-140 um, or 120-500, 120-400, 120-300, 120-250, 120-200, 120-150, or such as 100-120 um; the first, second, and third particulate materials may be present in any suitable proportion of the final product, for example the first particulate material may be present at at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%, the second particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%, and the third particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%. In another case, the final product comprises a first particulate material comprising one or more cementitious replacement materials and one or more alkaline activating materials, and, optionally, one or more bonding materials and/or one or more setting time enhancers in first size range, such as at least 0.05, 0.1, 0.5, 1, 2, 3, 4, 5, 7, 10, 12, 15, 20, 30, 40, 50, 60, 70, 80, 90, 100, 120, 150, or 200 um and/or not more than 0.1, 0.5, 1, 2, 3, 4, 5, 7, 10, 12, 15, 20, 30, 40, 50, 60, 70, 80, 90, 100, 120, 150, 200 or 250 um, such as 0.1-250, 0.1-200, 0.1-150, 0.1-100, 0.1-70, 0.1-50, 0.1-40, 0.1-30, 0.1-20, or 0.1-10 um; or 0.5-250, 0.5-200, 0.5-150, 0.5-100, 0.5-70, 0.5-50, 0.5-40, 0.5-30, 0.5-20, or 0.5-10 um; or 1-250, 1-200, 1-150, 1-100, 1-70, 1-50, 1-40, 1-30, 1-20, or 1-10 um; for example, 0.1-30 um; a second particulate material comprising one or more cementitious replacement materials and one or more alkaline activating materials, and, optionally, one or more bonding materials and/or one or more setting time enhancers in second size range, such as at least 2, 5, 10, 11, 12, 13, 14, 15, 17, 20, 25, 30, 35, 40, 45, 50, 60, 70, 80, 90, 100, 120, 150, 200, 250, 300, 350, or 400 um and/or not more than 5, 10, 11, 12, 13, 14, 15, 17, 20, 25, 30, 35, 40, 45, 50, 60, 70, 80, 90, 100, 120, 150, 200, 250, 300, 350, 400 or 450 um, such as 5-450, 5-300, 5-200, 5-100, 5-80, or 5-50 um, or 10-450, 10-300, 10-200, 10-100, 10-80, or 10-50 um; or 20-450, 20-300, 20-200, 20-100, 20-80, or 20-50 um; or 30-450, 3-300, 30-200, 30-100, 30-80, or 3-50 um for example, 30-100 um; a third particulate material comprising one or more cementitious replacement materials and one or more alkaline activating materials, and, optionally, one or more bonding materials and/or one or more setting time enhancers in third size range, such as at least 30, 35, 40, 45, 50, 60, 70, 80, 90, 100, 110, 120, 130, 140, 150, 170, 200, 220, 250, 300, 350, 400, 450, or 500 um and/or not more than 35, 40, 45, 50, 60, 70, 80, 90, 100, 110, 120, 130, 140, 150, 170, 200, 220, 250, 300, 350, 400, 450, 500 or 600 um for example, 50-500, 50-400, 50-300, 50-200, 50-150, or 50-100 um; or 70-500, 70-400, 70-300, 70-200, 70-150, or 70-100 um, or 100-500, 100-400, 100-300, 100-250, 100-200, 100-150, or 100-140 um, or 110-500, 110-400, 1100-300, 110-250, 110-200, 110-150, or 110-140 um, or 120-500, 120-400, 120-300, 120-250, 120-200, 120-150, or such as 100-120 um, and a fourth particulate material comprising one or more cementitious replacement materials and one or more alkaline activating materials, and, optionally, one or more bonding materials and/or one or more setting time enhancers in fourth size range, such as at least 50, 60, 70, 80, 90, 100, 110, 120, 130, 140, 150, 170, 200, 220, 250, 300, 350, 400, 450, 500, or 550 um and/or not more than 35, 40, 45, 50, 60, 70, 80, 90, 100, 110, 120, 130, 140, 150, 170, 200, 220, 250, 300, 350, 400, 450, 500, 550, or 600 um, for example, 70-500, 70-400, 70-300, 70-200, 70-250, or 70-200 um, or 100-500, 100-400, 100-300, 100-250, 100-200, 100-180 um, or 100-160 um, or 110-500, 110-400, 1100-300, 110-250, 110-200, 110-150, or 110-140 um, or 120-500, 120-400, 120-300, 120-250, 120-200, 120-180, 120-160, 120-150, or 120-140 um, or 130-500, 130-400, 130-300, 130-250, 130-200, 130-180, 130-160, 130-150, or 130-140 um, such as 120-150 um or 130-150 um; the first, second, third and fourth particulate materials may be present in any suitable proportion of the final product, for example the first particulate material may be present at at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%, the second particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%, the third particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99% and fourth particulate material may be present at least 1, 2, 5, 7, 10, 12, 15, 17, 20, 22, 25, 27, 30, 32, 35, 37, 40, 42, 45, 47, 50, 55, 60, 65, 70, 75, 80, 85, 90, 95, 96, 97, 98, or 99%. In any of these embodiments, the various components may be present in any suitable proportion; for example, the one or more cementitious replacement materials may be present at a final wt % of at least 20, 30, 40, 50, 55, 60, 65, 70, 75, 80, 85, 90, or 95% and/or not more than 30, 40, 50, 55, 60, 65, 70, 75, 80, 85, 90, 91, 92, 93, 94, 95, 96, 97, 98, or 99%, for example 50-99.9%, 50-99.5%, 50-99%, 50-98%, 50-97%, 50-95%, 50-90%, 50-80%, 50-70%, 50-60%, 60-99.9%, 60-99.5%, 60-99%, 60-98%, 60-97%, 60-95%, 60-90%, 60-80%, 60-70%, 70-99.9%, 70-99.5%, 70-99%, 70-98%, 70-97%, 70-95%, 70-90%, 70-80%, 75-99.9%, 75-99.5%, 75-99%, 75-98%, 75-97%, 75-95%, 75-90%, 75-80%, 80-99.9%, 80-99.5%, 80-99%, 80-98%, 80-97%, 80-95%, 80-90%, 85-99.9%, 85-99.5%, 85-99%, 85-98%, 85-97%, 85-95%, 85-90%, 90-99.9%, 90-99.5%, 90-99%, 90-98%, 90-97%, or 90-95%, for example, 50-99.5%, such as 60-98%, in some cases, 75-97%; the one or more alkaline activating materials may be present at a final wt % of 0.25-40%, 0.25-30%, 0.25-20%, 0.25-10%, 0.25-5%, 0.25-3%, 0.25-2%, 0.25-1%, 0.5-40%, 0.5-30%, 0.5-20%, 0.5-10%, 0.5-5%, 0.5-3%, 0.5-2%, 0.5-1%, 1-40%, 1-30%, 1-20%, 1-10%, 1-5%, 1-3%, 1-2%, 2-40%, 2-30%, 2-20%, 2-10%, 2-5%, 2-3%, 5-40%, 5-30%, 5-20%, or 5-10%, for example 1-25%, such as 1-20%, or 1-15%, or 1-10%, or 1-5%. The bonding material and/or setting time enhancer, if present, may be present at a combined final wt % of, for example, 0.2-40%, 0.2-30%, 0.2%-25%, 0.5-40%, 0.5-30%, 0.5-25%, 1-40%, 1-35%, 1-30%, 1-25%, 2-40%, 2-35%, 2-30%, 2-25%, 5-40%, 5-35%, 5-30%, 5-25%, 10-40%, 10-35%, 10-30%, 10-25%, 15-40%, 15-35%, 15-30%, 15-25%, 20-40%, 20-35%, 20-30%, 20-25%, 0.2%-20%, 0.5-20%, 1-20%, 2-20%, 5-20%, 10-20%, 15-20%, 0.2%-15%, 0.5-15%, 1-15%, 2-15%, 5-15%, 10-15%, 0.2%-10%, 0.5-10%, 1-10%, 2-10%, 5-10%, 0.2%-5%, 0.5-5%, 1-5%, 2-5%, or 5-25%. In certain embodiments, the total is 1-25%. In certain embodiments, the total is 1-40%. In certain embodiments, a cement, such as Ordinary Portland Cement, is added to the final product; the cement, e.g., OPC, may be added to a final concentration of at least 1, 2, 5, 10, 12, 15, 20, 25, 30, 40, 50, 60, 70, 80, 90, or 95% and/or not more than 2, 5, 10, 12, 15, 20, 25, 30, 40, 50, 60, 70, 80, 90, 95 or 98%.

In certain embodiments the final product contains at least one of a first particulate material comprising one or more cementitious replacement materials and one or more alkaline activating materials in a first size range and a second particulate material comprising one or more cementitious replacement materials and one or more alkaline activating materials in a second size range, wherein the second size range is smaller than the first, optionally, a third particulate material comprising one or more cementitious replacement material and one or more alkaline activating materials in a third size range, wherein the third size range is smaller than the second size range, and, optionally, a fourth particulate material comprising one or more cementitious replacement materials and one or more alkaline activating materials in a fourth size range, wherein the fourth size range is smaller than the third size range. Suitable size ranges may be any of those described herein. In certain embodiments, one or more of the second, third, and/or fourth particulate materials (if present) may also comprise a bonding material, a setting time enhancer, or both, in proportions as described herein. In certain embodiments, the final product comprises the second and third particulate materials. In certain embodiments, the final product comprises the third and fourth particulate materials. In certain embodiments, the final product comprises the second, third, and fourth particulate materials. In certain embodiments, the final product comprises the first, second and third particulate materials. In certain embodiments, the final product comprises the first, second third, and fourth particulate materials. The proportions of each ingredient are as described herein. The one or more cementitious replacement materials may be present at a final wt % of at least 20, 30, 40, 50, 55, 60, 65, 70, 75, 80, 85, 90, or 95% and/or not more than 30, 40, 50, 55, 60, 65, 70, 75, 80, 85, 90, 91, 92, 93, 94, 95, 96, 97, 98, or 99%, for example 50-99.9%, 50-99.5%, 50-99%, 50-98%, 50-97%, 50-95%, 50-90%, 50-80%, 50-70%, 50-60%, 60-99.9%, 60-99.5%, 60-99%, 60-98%, 60-97%, 60-95%, 60-90%, 60-80%, 60-70%, 70-99.9%, 70-99.5%, 70-99%, 70-98%, 70-97%, 70-95%, 70-90%, 70-80%, 75-99.9%, 75-99.5%, 75-99%, 75-98%, 75-97%, 75-95%, 75-90%, 75-80%, 80-99.9%, 80-99.5%, 80-99%, 80-98%, 80-97%, 80-95%, 80-90%, 85-99.9%, 85-99.5%, 85-99%, 85-98%, 85-97%, 85-95%, 85-90%, 90-99.9%, 90-99.5%, 90-99%, 90-98%, 90-97%, or 90-95%, for example, 50-99.5%, such as 60-98%, in some cases, 75-97%; the one or more alkaline activating materials may be present at a final wt % of 0.25-40%, 0.25-30%, 0.25-20%, 0.25-10%, 0.25-5%, 0.25-3%, 0.25-2%, 0.25-1%, 0.5-40%, 0.5-30%, 0.5-20%, 0.5-10%, 0.5-5%, 0.5-3%, 0.5-2%, 0.5-1%, 1-40%, 1-30%, 1-20%, 1-10%, 1-5%, 1-3%, 1-2%, 2-40%, 2-30%, 2-20%, 2-10%, 2-5%, 2-3%, 5-40%, 5-30%, 5-20%, or 5-10%, for example 1-25%, such as 1-20%, or 1-15%, or 1-10%, or 1-5%. The bonding material and/or setting time enhancer, if present, may be present at a combined final wt % of, for example, 0.2-40%, 0.2-30%, 0.2%-25%, 0.5-40%, 0.5-30%, 0.5-25%, 1-40%, 1-35%, 1-30%, 1-25%, 2-40%, 2-35%, 2-30%, 2-25%, 5-40%, 5-35%, 5-30%, 5-25%, 10-40%, 10-35%, 10-30%, 10-25%, 15-40%, 15-35%, 15-30%, 15-25%, 20-40%, 20-35%, 20-30%, 20-25%, 0.2%-20%, 0.5-20%, 1-20%, 2-20%, 5-20%, 10-20%, 15-20%, 0.2%-15%, 0.5-15%, 1-15%, 2-15%, 5-15%, 10-15%, 0.2%-10%, 0.5-10%, 1-10%, 2-10%, 5-10%, 0.2%-5%, 0.5-5%, 1-5%, 2-5%, or 5-25%. In certain embodiments, the total is 1-25%. In certain embodiments, the total is 1-40%.

In certain embodiments, a cement, such as Ordinary Portland Cement, is added to the final product; the cement, e.g., OPC, may be added to a final concentration of at least 0.1, 0.5, 1, 2, 5, 10, 12, 15, 20, 25, 30, 40, 50, 60, 70, 80, 90, or 95% and/or not more than 0.5, 1, 2, 5, 10, 12, 15, 20, 25, 30, 40, 50, 60, 70, 80, 90, 95 or 98%.

In certain embodiments the cementitious replacement material or materials comprises blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments the alkaline activating material comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments the bonding material comprises plagioclase, feldspathic material, pyroxene, amphibole, quartz, diatomaceous earth, magnesium oxide, potassium oxide, methylsulfonylmethane, malic acid, zirconium dioxide, bentonite, micro silica, or a combination thereof. In certain embodiments the setting time enhancer comprises aluminum hydroxide, VCAS (waste product of fiberglass production), cement kiln dust, zeolite, calcium oxide, aluminum oxide, dolomite calcite, montmorillonite, sodium lignosulfate, zinc oxide, sodium phosphate, phosphoric acid, sodium chloride (low accelerators/high retarders), tartaric acid, or a combination thereof.

In addition, before or, more commonly, during mixing with water, one or more admixtures, in addition to bonding material and setting time enhancer, if present, may be added. Any suitable admixture may be used, such as water reducers (superplasticizers), set retarders, or nucleation seeders. In certain embodiments, an admixture comprising a silicate compound and a hydroxide compound, as described elsewhere herein, is used.

In certain embodiments provided herein is method of producing a cementitious composition comprising (i) providing a material comprising at least one cementitious replacement material, at least one alkaline activator, and at least one of a bonding material or a setting time enhancer; and (ii) treating the material to produce a particulate product of a mesh size of 0.1-1000, 0.1-500, or 0.1-200 um. In certain embodiments the material comprises at least two different cementitious replacement materials. In certain embodiments the material comprises at least three different cementitious replacement materials. In certain embodiments the material comprises at least two different alkaline activators. In certain embodiments the material comprises a bonding material. In certain embodiments the material comprises a setting time enhancer. In certain embodiments the material comprises both a bonding material and a setting time enhancer. In certain embodiments treating the material comprises first treating the cementitious replacement material to reduce its size, then adding one or more of the alkaline activator and/or bonding material and/or setting time enhancer and treating the combination to reduce the size further. In certain embodiments the cementitious replacement material or materials comprises blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments the alkaline activating material comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments the bonding material comprises plagioclase, feldspathic material, pyroxene, amphibole, quartz, diatomaceous earth, magnesium oxide, potassium oxide, methylsulfonylmethane, malic acid, zirconium dioxide, bentonite, micro silica, or a combination thereof. In certain embodiments the setting time enhancer comprises aluminum hydroxide, VCAS (waste product of fiberglass production), cement kiln dust, zeolite, calcium oxide, aluminum oxide, dolomite calcite, montmorillonite, sodium lignosulfate, zinc oxide, sodium phosphate, phosphoric acid, sodium chloride (low accelerators/high retarders), tartaric acid, or a combination thereof.

In certain embodiments provided herein is a method of producing a cement material comprising (i) adding water to a cementitious material comprising a cementitious replacement material and an alkaline activating material and mixing; and (ii) adding carbon dioxide or methane to one or more of the water added to the cementitious material, the cementitious replacement/alkaline activating material; the combination of the water and the cementitious replacement/alkaline activating material during mixing; and/or the combination of the water and the cementitious replacement/alkaline activating material after mixing.

Properties of Geopolymer Cements Produced by Methods Herein.

A composition produced by the above methods and/or as described herein can have many advantageous properties when combined with water and allowed to set and harden. In certain embodiments, the composition to which water is added and is allowed to set and harden contains no conventional cement, such as no OPC and/or no conventional SCMs; or less than 20, 15, 10, 5, 2, or 1% of OPC and/or conventional SCMs. Setting time may be significantly shorter than for a conventional cement, e.g., no greater than 0.25, 0.5, 0.75, 1, 1.5, 2, 2.5, 3, 3.5, or 4 hours and/or at least 0.1, 0.25, 0.5, 0.75, 1, 1.5, 2, 2.5, 3, or 3.5 hours, e.g. no greater than 1 hour, or no greater than 0.75 hour, or no greater than 0.5 hour. This has advantages both in precast operations, allowing less time between batches since the cast material can be removed from the mold sooner, and in operations where cement products are poured into a mold at a jobsite. The composition may have superior compressive strength properties, e.g., a compressive strength at one or more time points after mixing, such as at 1 day, 7 days, 14 days, or 28 days, of 30-400, or 50-400, or 100-400, or 200-400 MPa; additionally or alternatively, the composition may have superior tensile strength properties, e.g., a tensile strength at one or more time points after mixing, such as at 1 day, 7 days, 14 days, or 28 days, of 10-75, 20-75, 30-75, 40-75, 50-75, or 60-75 MPa; additionally or alternatively, the composition may have superior modulus of elasticity, e.g., a modulus of elasticity at one or more time points after mixing, such as at 1 day, 7 days, 14 days, or 28 days, of 40-120, 50-120, 60-120, 70-120, 80-120, 90-120, 100-120, or 110-120 GPa; additionally or alternatively, the composition may have a superior pore volume range, e.g., a pore volume range at one or more time points after mixing, such as at 1 day, 7 days, 14 days, or 28 days, of not more than 0.001, 0.01, 0.05, 0.1, 0.5, 1, 2, 3, 4 or 5% and/or at least 0.0001, 0.001, 0.01, 0.05, 0.1, 0.5, 1, 2, 3 or 4%, such as 0.001-2%, or 0.001-1%, or 0.001-0.5%, or 0.001-0.1%; additionally or alternatively, the composition may have a superior water sorptivity coefficient, e.g., a water sorptivity coefficient at one or more time points after mixing, such as at 1 day, 7 days, 14 days, or 28 days, of 0.001-0.055, 0.001-0.05, 0.001-0.04, 0.001-0.03, 0.001-0.02, or 0.001-0.01 kg/m²/h^{0.5}; additionally or alternatively, the composition may have a superior fire resistance, e.g., fire resistance at one or more time points after mixing, such as at 1 day, 7 days, 14 days, or 28 days, of 500-2000, or 700-2000, or 1000-2000, or 1200-2000, or 1500-2000° C. All of the above properties may be measured by tests well known in the art.

Alternatively or additionally, the cementitious compositions provided herein generate much less carbon dioxide in their production than conventional cementitious compositions produced using calcination, e.g., OPC; for example, for a given quantity of cementitious composition of the present disclosure compared to the same quantity of a conventional cementitious composition, e.g., OPC, the composition of the present invention may generate less carbon dioxide emissions, e.g., 10-98, 30-98, 40-98, 45-98, 50-98, 55-98, 60-98, 65-98, 70-98, 75-98, 80-98, 85-98, 90-98, 95-98, 10-95, 30-95, 40-95, 45-95, 50-95, 55-95, 60-95, 65-95, 70-95, 75-95, 80-95, 85-95, or 90-95% less carbon dioxide. It will be appreciated that cementitious compositions provided herein can in some cases be used in lower quantity in, e.g., concrete, than conventional cement, e.g., conventional OPC, and produce a concrete product, with the same or better characteristics than the concrete produced with conventional cement. This reduces carbon dioxide from the process by reducing the amount of cement used, thus avoiding a certain amount of carbon dioxide production. See Examples 13-15.

It will be appreciated that cementitious materials in the size ranges described herein are not limited to the cement replacement/alkaline activating materials described herein; for example, OPC can be treated to achieve similar size ranges, and combined, to produce an OPC that potentially has greater compressive strength and/or other properties, as described herein, than an OPC that has not been so treated.

In certain embodiments, provided is a dry particulate composition comprising (i) at least one cementitious replacement material; (ii) at least one alkaline activating material; and (iii) at least one bonding material, at least one setting time enhancer material, or both. The material is considered dry if water was added during the process to produce it, so long as the added water comprises less than 2, 1, 0.7, 0.5, 0.3, or 0.1% water. In certain embodiments, the particles of the particulate composition are in a size range of 0.1-1000 um, or 0.1-500 um, or 0.1-400 um, or 0.1-300 um, or 0.1-200 um, or 0.5-1000 um, or 0.5-500 um, or 0.5-400 um, or 0.5-300 um, or 0.5-200 um, or 1-1000 um, or 1-500 um, or 1-400 um, or 1-300 um, or 1-200 um. In certain embodiments, the cementitious replacement material or materials comprises blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments, the alkaline activating material comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, the bonding material, if present, comprises plagioclase, feldspathic material, pyroxene, amphibole, quartz, diatomaceous earth, magnesium oxide, potassium oxide, methylsulfonylmethane, malic acid, zirconium dioxide, bentonite, micro silica or a combination thereof. In certain embodiments, the setting time enhancer, if present, comprises aluminum hydroxide, VCAS (waste product of fiberglass production), cement kiln dust, zeolite, calcium oxide, aluminum oxide, dolomite calcite, montmorillonite, sodium lignosulfate, zinc oxide, sodium phosphate, phosphoric acid, sodium chloride (low accelerators/high retarders), tartaric acid, or a combination thereof. In certain embodiments, the material further comprises water beyond that present during production. In certain embodiments, the product, e.g., when combined with water and, optionally, aggregates has a compressive strength of 30-400 MPa after addition of water and setting and hardening. In certain embodiments, provided is a solid product derived from any of the compositions previously described in this paragraph wherein the product has one, two, three, four, five, six, or all of (i) a compressive strength of 30-400 MPa; (ii) a tensile strength of 10-75 MPa; (iii) a modulus of elasticity of 40-120 GPa; (iv) a pore volume range of 0.5-5%; (v) a water sorptivity coefficient of 0.001 to 0.055 kg/m²/h^{0.5} (vi) a fire resistivity range of 500° C. to 2000° C.; (vii) a carbon dioxide emission reduction of 40-98% compared to a product with similar properties made with conventional cement.

In certain embodiments, provided is a cementitious material comprising at least two of (i) a first portion of a first particulate material comprising one or more cementitious replacement materials and one or more alkaline activating material in a first range of sizes; (ii) a second portion of a second particulate material comprising the one or more cementitious replacement materials and the one or more alkaline activating materials in a second range of sizes, smaller than the first range of sizes; (iii) a third portion of a third particulate material comprising the one or more cementitious replacement materials and the one or more alkaline activating materials in a third range of sizes, smaller than the second range of sizes; and (iv) a fourth portion of a fourth particulate material comprising the one or more cementitious replacement materials and the one or more alkaline activating material in a fourth range of sizes, smaller than the third range of sizes. In certain embodiments, the cementitious replacement material or materials comprise blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments, the alkaline activating material comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, the composition comprises the second portion and the third portion. In certain embodiments, the composition comprises the third portion and the fourth portion. In certain embodiments, the third and/or fourth particulate materials also comprise at least one of a bonding material or a setting enhancer material. In certain embodiments, the composition comprises the at least one bonding material, wherein the bonding material comprises plagioclase, feldspathic material, pyroxene, amphibole, quartz, diatomaceous earth, magnesium oxide, potassium oxide, methylsulfonylmethane, malic acid, zirconium dioxide, bentonite, micro silica, or a combination thereof. In certain embodiments, the composition comprises the at least one setting time enhancer material, wherein the setting time enhancer material comprises aluminum hydroxide, VCAS (waste product of fiberglass production), cement kiln dust, zeolite, calcium oxide, aluminum oxide, dolomite calcite, montmorillonite, sodium lignosulfate, zinc oxide, sodium phosphate, phosphoric acid, sodium chloride (low accelerators/high retarders), tartaric acid, or a combination thereof. In certain embodiments, the first, second, third, and fourth particulate materials comprise at least two cementitious replacement materials. In certain embodiments, the first, second, third, and fourth particulate materials comprise at least three cementitious replacement materials. In certain embodiments, the one or more cementitious replacement materials comprises blast furnace slag (BFS), ground granulated blast slag (GGBS), flyash (e.g. class F, class C, solid waste incineration flyash, other flyashes, or a combination thereof), micro silica, red mining slag, calcium aluminates, filter cakes from metal industry, copper tailings, copper slag, bauxite tailings, stainless steel slag, pond ash, coal ash, electric arc furnace slag, bottom ash, kiln dust (non-cement kiln), lime, hydrated lime, quarry dust, red kalonite clay, ferro sialate, other metal slags, or other mining slags, or a combination thereof. In certain embodiments, the first, second, third, and fourth particulate materials comprise at least two alkaline activation materials. In certain embodiments, the first, second, third, and fourth particulate materials comprise at least three alkaline activation materials. In certain embodiments the one or more alkaline activating materials comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In certain embodiments, the one or more cementitious replacement materials comprise 50-90 wt % of the cementitious material. In certain embodiments, the one or more cementitious replacement materials comprise 75-97 wt % of the cementitious material. In certain embodiments the one or more alkaline activators comprise 0.25-40 wt % of the cementitious material. In certain embodiments the one or more alkaline activators comprise 0.5-20 wt % of the cementitious material. In certain embodiments the composition comprises at least one bonding material, at least one setting time enhancing material, or a combination thereof, wherein the at least one bonding material, at least one setting time enhancing material, or combination thereof comprises 0.2-25% of the cementitious material. In certain embodiments the composition comprises at least one bonding material, at least one setting time enhancing material, or a combination thereof, wherein the at least one bonding material, at least one setting time enhancing material, or combination thereof comprises 0.2-10% of the cementitious material. In certain embodiments, the first size range is 5-230 um. In certain embodiments the first size range is 130-150 um. In certain embodiments the second size range is 20-200 um. In certain embodiments the second size range is 100-120 um. In certain embodiments the third size range is 5-200 um. In certain embodiments the third size range is 30-100 um. In certain embodiments the fourth size range is 0.1-80 um. In certain embodiments the fourth size range is 0.1-30 um. In certain embodiments the composition comprises at least three of (i) a first portion of a first particulate material comprising one or more cementitious replacement materials and one or more alkaline activating material in a first range of sizes; (ii) a second portion of a second particulate material comprising the one or more cementitious replacement materials and the one or more alkaline activating materials in a second range of sizes, smaller than the first range of sizes; and (iii) a third portion of a third particulate material comprising the one or more cementitious replacement materials and the one or more alkaline activating materials in a third range of sizes, smaller than the second range of sizes; (iv) a fourth portion of a fourth particulate material comprising the one or more cementitious replacement materials and the one or more alkaline activating material in a fourth range of sizes, smaller than the third range of sizes. In certain of these embodiments the composition comprises the first, second and third portions. In certain of these embodiments the composition comprises the second, third, and fourth portions. In certain embodiments the composition comprises all of (i) a first portion of a first particulate material comprising one or more cementitious replacement materials and one or more alkaline activating material in a first range of sizes; (ii) a second portion of a second particulate material comprising the one or more cementitious replacement materials and the one or more alkaline activating materials in a second range of sizes, smaller than the first range of sizes; (iii) a third portion of a third particulate material comprising the one or more cementitious replacement materials and the one or more alkaline activating materials in a third range of sizes, smaller than the second range of sizes; and (iv) a fourth portion of a fourth particulate material comprising the one or more cementitious replacement materials and the one or more alkaline activating material in a fourth range of sizes, smaller than the third range of sizes. In certain embodiments, provided is a solid product derived from any of the compositions described in this paragraph combined with water and allowed to set and harden, wherein the product has one, two, three, four, five, six, or seven of (i) a compressive strength of 30-400 MPa; (ii) a tensile strength of 10-75 MPa; (iii) a modulus of elasticity of 40-120 GPa; (iv) a pore volume range of 0.5-5%; (v) a water sorptivity coefficient of 0.001 to 0.055 kg/m²/h^{0.5} (vi) a fire resistivity range of 500° C. to 2000° C.; (vii) a carbon dioxide emission reduction of 40-98% compared to a product with similar properties made with conventional cement.

In certain embodiments provided is a solid product produced by combining a dry cementitious material with water and allowing it to set and harden, wherein the solid product has at least one, two, three, four, five, six, or all of (i) a compressive strength of 30-400 MPa; (ii) a tensile strength of 10-75 MPa; (iii) a modulus of elasticity of 40-120 GPa; (iv) a pore volume range of 0.5-5%; (v) a water sorptivity coefficient of 0.001 to 0.055 kg/m²/h^{0.5} (vi) a fire resistivity range of 500° C. to 2000° C.; (vii) a carbon dioxide emission reduction of 40-98% compared to a product with similar properties made with conventional cement. In certain embodiments, the dry cementitious material does not contain a supplementary cementitious material. In certain embodiments the dry cementitious material contains less than 5% OPC. In certain embodiments the dry cementitious material comprises at least one cementitious replacement material and at least one alkaline activating material. In certain embodiments the solid product has (i) a compressive strength of 150-400 MPa; (ii) a tensile strength of 35-75 MPa; and (iii) a fire resistivity range of 1000° C. to 2000° C.

### Optional Carbonation Process

The carbonation process involves the carbon mineralization of the concrete as well and the capturing of CO₂ and/or methane into the concrete mix. We have four processes to mineralize our cement using the addition of CO₂ and/or methane; the addition of carbon dioxide and/or methane can occur at one or more of dry grinding, mix water, wet mixing concrete, and/or curing of concrete product.
Grinding The materials that include cementitious replacement materials, alkaline activator, and, optionally, bonding materials and/or setting time enhancer materials are ground in a process as described herein. Carbon dioxide and/or methane may be applied to the materials at any suitable stage of the grinding process at a suitable addition rate, e.g., 1-5 kg per minute.
Pumping into wet mix The cement material along with the addition of aggregate, sand and water are added to a mixing device e.g., one that is that is airtight. The CO₂ and/or methane are pumped into the mixture at suitable rate, e.g., a range of 5 to 15 kg per minute pumped into the material and mixed together.
Dissolve into water Carbon dioxide and/or methane are pumped into the mixture of H₂O and dissolved into the water until maximum saturation is reached. The material is then added into the cement mixture comprising of cementitious replacement materials, alkaline activator, bonding materials and/or setting time enhancer materials, aggregate and/or sand.
Curing in carbon chambers A cement mixture comprising cementitious replacement materials, alkaline activator, bonding materials and/or setting time enhancer materials, aggregate, sand and water Is placed into a chamber that has CO₂ and/or methane pumped into the chamber at a suitable rate, e.g., a range of 1 to 5 kg per minute, the material is left for about 24 hours to cure in these conditions.

### EMBODIMENTS

In embodiment 1 provided herein is a dry particulate composition comprising (i) one or more cement precursors; and (ii) one or more alkaline activating agents. In embodiment 2 provided herein is the composition of embodiment 1 that is a geopolymer cement. In embodiment 3 provided herein is the composition of embodiment 1 or 2 wherein the particles of the particulate composition are in a size range of 1-100 um, more preferably 2-50 um, even more preferably 3-40 um, and yet even more preferably 5-30 um. In embodiment 4 provided herein is the composition of any one of embodiments 1 through 3 wherein at least 5%, preferably at least 10%, more preferably at least 15% of the one or more cement precursors is in amorphous form. In embodiment 5 provided herein is the composition of any one of embodiments 1 through 4 wherein the one or more cement precursors are present at a wt % of 50-99.5%, in preferred embodiments 60-98%, in more preferred embodiments, 75-97%. In embodiment 6 provided herein is the composition of any one of embodiments 1 through 5 wherein the one or more alkaline activating agents are present at a wt % of 1-25%, in preferred embodiments 1-20%, in more preferred embodiments 1-15%, in even more preferred embodiments 1-10%, in yet more preferred embodiments even 1-5%. In embodiment 7 provided herein is the composition of any one of embodiments 1 through 6 wherein the one or more cement precursors comprise one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In embodiment 8 provided herein is the composition of any one of embodiments 1 through 7 wherein the one or more cement precursors comprise one or more aluminosilicates and/or one or more poly(ferro-sialate)s. In embodiment 9 provided herein is the composition of any one of embodiments 1 through 7 wherein the one or more cement precursors comprise lagoon ash, basic oxygen slag (BOS), electric arc furnace (EAF) slag, mill scale, desulferization slag, black/white slag, fly ashes, blast furnace flue dust, red mud, and/or iron ore agglomerate. In embodiment 10 provided herein is the composition of any one of embodiments 1 through 7 wherein the one or more cement precursors comprise at least two of lagoon ash, basic oxygen slag (BOS), electric arc furnace (EAF) slag, mill scale, desulferization slag, black/white slag, fly ashes, blast furnace flue dust, red mud, and/or iron ore agglomerate. In embodiment 11 provided herein is the composition of any one of embodiments 1 through 10 wherein the one or more alkaline activating agents comprises potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In embodiment 12 provided herein is the composition of any one of embodiments 1 through 10 wherein the one or more alkaline activating agents comprises at least two of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In embodiment 13 provided herein is the composition of any one of embodiments 1 through 12 wherein the dry particulate material, e.g., geopolymer cement, is produced in a process that, for a given amount of the dry particulate material, e.g., geopolymer cement, produces 40-100% at least 40, 45, 50, 55, 60, 65, 70, 75, 80, 85, 90, 95, or 97% and/or not more than 45, 50, 55, 60, 65, 70, 75, 80, 85, 90, 95, 97, 98, 99, or 100% less carbon dioxide than production of the same amount of non-geopolymer cement in a process that comprises calcining limestone. In embodiment 14 provided herein is a wet cement composition comprising the composition of any one of embodiments 1 through 13, water, and an admixture comprising a silicate compound and a hydroxide compound. In embodiment 15 provided herein is the wet cement composition of embodiment 14 wherein the silicate compound and the hydroxide compound are present at a molar ratio of 0.5 to 3.0, preferably 1.0-2.0, more preferably 1.0-1.5 silicate:hydroxide.

In embodiment 16 provided herein is a wet cement composition comprising (i) a geopolymer cement; (ii) water; and (iii) an admixture comprising a silicate compound and a hydroxide compound. In embodiment 17 provided herein is the composition of embodiment 16 wherein the admixture comprises sodium silicate or potassium silicate, and sodium hydroxide or potassium hydroxide. In embodiment 18 provided herein is the composition of embodiment 17 wherein the admixture comprises potassium silicate and potassium hydroxide. In embodiment 19 provided herein is the composition of any one of embodiments 16 through 18 wherein the silicate compound and the hydroxide compound are present at a molar ratio of 0.5 to 3.0, preferably 1.0-2.0, more preferably 1.0-1.5 silicate:hydroxide. In embodiment 20 provided herein is the composition of any one of embodiments 16 through 19 wherein the admixture is present at 0.5-40% by weight cement (bwc), preferably 1-35% bwc. In embodiment 21 provided herein is the composition of any one of embodiments 16 through 19 wherein the admixture is present at 2-40% bwc, preferable 4-35% bwc, even more preferably 20-35% bwc. In embodiment 22 provided herein is the composition of any one of embodiments 16 through 19 wherein the admixture is present at 0.25-35% bwc, preferably 0.5-30%, more preferably 0.5-10%, even more preferably 0.5-5% bwc. In embodiment 23 provided herein is the composition of any one of embodiments 16 through 22 further comprising reaction products of the geopolymer cement and the admixture. In embodiment 24 provided herein is the composition of any one of embodiments 16 through 23 wherein the geopolymer comprises one or more cement precursors and one or more alkaline activating agents. In embodiment 25 provided herein is the composition of embodiment 25 wherein the one or more cement precursors comprises one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In embodiment 26 provided herein is the composition of embodiment 25 wherein the one or more cement precursors comprises one or more aluminosilicates and/or one or more poly(ferro-sialate)s, such as one or more of lagoon ash, basic oxygen slag (BOS), electric arc furnace (EAF) slag, mill scale, desulferization slag, black/white slag, fly ashes, blast furnace flue dust, red mud, and/or iron ore agglomerate. In embodiment 27 provided herein is the composition of any one of embodiments 24 through 26 comprising at least two of the cement precursors. In embodiment 28 provided herein is the composition of any one of embodiments 24 through 27 wherein the alkaline activating agent comprises one or more of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In embodiment 29 provided herein is the composition of embodiment 28 comprising at least two of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In embodiment 30 provided herein is the composition of any one of embodiments 16 through 29 further comprising a non-geopolymer cement. In embodiment 31 provided herein is the composition of embodiment 30 wherein the non-geopolymer cement is ordinary Portland cement (OPC). In embodiment 32 provided herein is the composition of embodiment 30 or 31 wherein the non-geopolymer cement, e.g., OPC, is present in an amount of less than 50, 40, 30, 20, 15, 10, or 5% by weight and/or at least 0.1, 0.2, 0.5, or 1%, preferably 0.1-30%, more preferably 0.5 20%, even more preferably 1-15%. In embodiment 33 provided herein is the composition of any one of embodiments 16 through 32 further comprising aggregate.

In embodiment 34 provided herein is a method for producing a geopolymer cement comprising subjecting one or more cement precursors and one or more alkaline activating agent to a process comprising combining and treating the one or more cement precursors and the one or more alkaline activating agents to produce a geopolymer cement, wherein the method comprises at least one of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In embodiment 35 provided herein is the method of embodiment 34 comprising at least two of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In embodiment 36 provided herein is the method of embodiment 34 comprising at least three of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In embodiment 37 provided herein is the method of embodiment 34 comprising at least four of (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use. In embodiment 38 provided herein is the method of embodiment 34 comprising (i) the method is a continuous method; (ii) combining and treating has a duration of not more than 60 seconds; (iii) the method does not require grinding or milling; (iv) the method not require addition of exogenous heat during the combining and/or treating; (v) the method produces geopolymer cement that is ready to use.

In embodiment 39 provided herein is a system for producing a geopolymer cement comprising (i) a source of a cement precursor; (ii) a source of an alkaline activating agent; and (iii) a treatment unit to treat the cement precursor and the alkaline activating agent to produce a geopolymer cement. In embodiment 40 provided herein is the system of embodiment 39 wherein the treatment unit comprises an impact mixer.

In embodiment 41 provided herein is a network comprising a plurality of spatially separate geopolymer production systems, wherein each of the systems send information regarding one or more aspects of one or more processes at the system to a central processing unit. In embodiment 42 provided herein is the network of embodiment 41 wherein the central processing unit processes the information and send output to one or more of the spatially separate geopolymer production systems, such as output that causes a change in the one or more spatially separate geopolymer production systems. In embodiment 43 provided herein is the network of embodiment 41 or embodiment 42 wherein the network comprises at least 2, 3, 4, 5, 6, 7, 8, 10, 12, 15, 20, 25, 30, 40, 50, 70, 100, 200, or 500 spatially separate geopolymer production systems and/or not more than 3, 4, 5, 6, 7, 8, 10, 12, 15, 20, 25, 30, 40, 50, 70, 100, 200, 500, or 1000 spatially separate geopolymer production systems, preferably 2-1000 systems, more preferably 2-200 systems, even more preferably 2-100 systems. In embodiment 44 provided herein is the network of any one of embodiments 41 through 43 wherein at least one of the geopolymer production systems comprises an impact mixer.

In embodiment 45 provided herein is a method for treating one or more cement precursors and one or more alkaline activating agents to produces a cementitious product, e.g., a geopolymer cement, wherein the method does not require, and does not utilize, grinding or milling and does not require, and does not utilize addition of exogenous heat to the materials, and wherein the materials are treated for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. In embodiment 46 provided herein is the method of embodiment 45 wherein the method is continuous. In embodiment 47 provided herein is a dry particulate material produced by the method of embodiment 45 or 46.

In embodiment 48 provided herein is a method for treating one or more starting materials to produce one or more cementitious products comprising introducing the one or more starting materials into an impact mixer, where they are subjected to impact mixing, to produce the one or more cementitious products. In embodiment 49 provided herein is the method of embodiment 48 wherein the one or more starting materials comprise one or more cement precursors. In embodiment 50 provided herein is the method of embodiment 49 wherein the one or more starting materials further comprise one or more alkaline activating agents. In embodiment 51 provided herein is the method of embodiment 49 or 50 wherein the one or more cement precursors comprise one or more of aluminosilicates, silxo-aluminates, poly(Siloxo)/poly(siloxonate)/poly (silanol), poly (ferro-sialate), otho silicate, otho (siloxonate), oligo silicates, hydrosodalite, silonate, or phosphate based material. In embodiment 52 provided herein is the method of embodiment 51 wherein the one or more cement precursors comprises one or more aluminosilicates and/or one or more poly(ferro-sialate)s, such as one or more of lagoon ash, basic oxygen slag (BOS), electric arc furnace (EAF) slag, mill scale, desulferization slag, black/white slag, fly ashes, blast furnace flue dust, red mud, and/or iron ore agglomerate. In embodiment 53 provided herein is the method of embodiment 52 wherein the one or more alkaline activating agents comprise one or more of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof. In embodiment 54 provided herein is the method of any one of embodiments 48 through 53 wherein the starting materials, e.g., cement precursor(s) and alkaline activating agent(s), are introduced into the impact mixer in a single feed stream. In embodiment 55 provided herein is the method of any one of embodiments 48 through 54 wherein the process is a continuous process. In embodiment 56 provided herein is the method of any one of embodiments 48 through 55 wherein the one or more cementitious products comprise geopolymer cement. In embodiment 57 provided herein is the method of any one of embodiments 48 through 56 wherein the starting materials reside in the impact mixer for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. In embodiment 58 provided herein is a geopolymer cement produced by the method of any one of embodiments 48 through 57.

In embodiment 59 provided herein is a system for producing cementitious material, wherein the system comprises (i) one or more sources of starting materials operably connected to (ii) an impact mixer configured to treat the starting materials to produce a cementitious product. In embodiment 60 provided herein is the system of embodiment 59 wherein the one or more sources of starting materials comprises a source of cement precursor and a source of alkaline activating agent. In embodiment 61 provided herein is the system of embodiment 59 or 60 wherein the impact mixer is configured to reduce the size of the starting materials and mix the starting materials. In embodiment 62 provided herein is the system of any one of embodiments 59 through 61 wherein the impact mixer comprises (a) a conduit operably connected to one or more sources of starting materials and to the impact mixer, to introduce the starting materials into the impact mixer, (b) a shaft to which are attached one or more blades, wherein the shaft and the blades are enclosed in a cylindrical chamber that is operably connected to the conduit, wherein the impact mixer is configured to rotate the shaft at a desired rate. In embodiment 63 provided herein is the system of embodiment 62 wherein the one or more blades comprise at least 1, 2, 3, 4, 5, 6, 8, 10, 12, 14, 16, 20, 24, 28, or 32 and no more than 36, 32, 28, 24, 20, 16, 14, 12, 10, 8, 6, 5, 4, 3, or 2 blades attached to the shaft, for example 1-32 blades, preferably 4-28 blades, more preferably 8-24 blades, even more preferably 10-20 blades, yet more preferably 12-16 blades. In embodiment 64 provided herein is the system of embodiment 62 or 63 wherein the shaft is vertical and the blades are positioned at an angle relative to horizontal that is at least 5, 10, 15, 20, 25, 30, 35, 40, 45, 50, 55, 60, 65, 70, 75, or 80° and/or no more than 10, 15, 20, 25, 30, 35, 40, 45, 50, 55, 60, 65, 70, 75, 80, or 85°, for example 5-85°, preferably 25-75, more preferably 45-75°. In embodiment 65 provided herein is the system of any one of embodiments 62 through 64 wherein each blade comprises a base, having a first length, attached to a hub that is further attached to the shaft, and a tip, distal to the proximal base and having a second length, wherein the surface of the tip is adjacent to but not in contact with the cylindrical chamber. In embodiment 66 provided herein is the system of embodiment 65 wherein a ratio of the second length to the first length is at least 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 at nor more than 5, 2, 1.9, 1.8, 1.7, 1.6, 1.5, 1.4, 1.3, 1.2, 1.1, 1, 0.9, 0.8, 0.7, 0.6, 0.5, 0.4, 0.3, or 0.2, for example 0.2-5, preferably 0.2-2, more preferably 0.2-1, even more preferably 0.2-0.8, yet more preferably 0.4-0.6; in certain embodiments, the ratio is 0.5. In embodiment 67 provided herein is the system of any one of embodiments 62 through 66 wherein the conduit is positioned at an angle to the cylinder. In embodiment 68 provided herein is the system of embodiment 67 wherein the cylinder is vertical and the angle is at least 5, 10, 15, 20, 25, 30, 35, 40, 45, 50, 55, 60, 65, 70, or 75° from vertical and/or not more than 10, 15, 20, 25, 30, 35, 40, 45, 50, 55, 60, 65, 70, 75, or 80° from vertical; preferably 20-70° from vertical, more preferably 30-60° from vertical, even more preferably 40-50° from vertical. In embodiment 69 provided herein is the system of any one of embodiments 59 through 68 wherein the impact mixer comprises an exit through which cementitious product exits the mixer. In embodiment 70 provided herein is the system of embodiment 69 further comprising a processing system operably connected to the exit for processing the cementitious product. In embodiment 71 provided herein is the system of embodiment 70 wherein the processing system is configured to package the cementitious product for transport to an end user. In embodiment 72 provided herein is the system of any one of embodiments 59 through 71 further comprising one or more pre-processing units operably connected to the one or more sources of starting materials, to pre-process the starting materials before introduction into the impact mixer. In embodiment 73 provided herein is the system of any one of embodiments 59 through 72 wherein the system is configured to rotate the shaft, e.g., by a motor, at a speed of at least 100, 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, or 5800 RPM and/or not more than 200, 300, 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5200, 5400, 5600, 5800, or 6000 RPM, for example 100-6000 RPM, preferably 500-5000 RPM, more preferably 1000-2000 RPM. In embodiment 74 provided herein is the system of any one of embodiments 59 through 73 wherein the system is configured for continuous operation. In embodiment 75 provided herein is the system of any one of embodiments 59 through 74 wherein the system is configured to treat the starting materials to produce a cementitious product in less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds.

In embodiment 76 provided herein is a system for treating one or more starting materials to produce a cementitious product comprising (i) a first source of a first starting material; (ii) a second source of a second starting material; and (iii) a treatment unit where the first and second starting materials are treated to produce a cementitious product, wherein the first and second sources are operably connected to the treatment unit. In embodiment 77 provided herein is the system of embodiment 76 wherein the treatment unit is configured so that it does not utilize milling or grinding. In embodiment 78 provided herein is the system of embodiment 76 or embodiment 77 wherein the treatment unit is configured so that it does not supply exogenous heat to the starting materials. In embodiment 79 provided herein is the system of any one of embodiments 76 through 78 wherein the treatment unit is configured to cause all starting materials to enter the treatment unit simultaneously. In embodiment 80 provided herein is the system of any one of embodiments 76 through 79 wherein the treatment unit is configured to allow continuous treatment of the starting material. In embodiment 81 provided herein is the system of any one of embodiments 76 through 80 wherein the treatment unit is configured to treat starting materials while they reside in the treatment unit for less than 600, 500, 400, 300, 200, 100, 50, 40, 30, 25, 20, 17, 15, 14, 13, 12, 11, 10, 9, 8, 7, 6, 5, 4, 3, or 2 seconds, and/or not more than 1000, 600, 500, 400, 300, 200, 100, 50, 40, 30, 25, 20, 17, 15, 14, 13, 12, 11, 10, 9, 8, 7, 6, 5, 4, or 3 seconds, preferably less than 30 seconds, more preferably less than 20 seconds, even more preferably less than 10 seconds. In embodiment 82 provided herein is the system of any one of embodiments 76 through 81 further comprising an outlet where cementitious product exits the treatment unit. In embodiment 83 provided herein is the system of embodiment 82 further comprising a packaging unit for packaging cementitious product and/or a storage unit for storing cementitious product, operably connected to the outlet.

### EXAMPLES

The procedure used in Examples 1-10 was as follows, unless otherwise indicated:

Material sourcing Waste Materials were sourced from local industrial partners including US steel, The Heritage group and ArcelorMittal. Chemical materials were sourced from online suppliers including cheMondis, Univar solutions and Cole chemicals.

Milling machine Retsch™ PM100 and Retsch™ TM 300, depending on the size of the batch.

| Machine | Jar size | Jar material | Ball size mm | Ball material |
|---|---|---|---|---|
| Retsch PM100 | 500 ml | Stainless steel | 3 to 15 | Stainless steel |
| Retsch TM 300 | 5 litres | Stainless steel | 3 to 15 | Stainless steel |

Method The cementitious replacement material was weighed out at a range of 75-97% if singularly or each at 8-55% if blended and place into the ball Jar with balls of range between 8-15 mm. The cementitious replacement material was then blended in the ball grinding machine (Retsch PM100 and Retsch TM 300) for 1 to 10 minutes at a speed of 400 to 650 RPM until the material was at a first size range of 130-150 um.

The alkaline activation material was then weighed out at a range of 1-20% if singularly or blended and placed into the ball jar with balls of a range between 4-12 mm. The alkaline activation material was then blended in the ball grinding machine (Retsch PM100 and Retsch TM 300) for 1 to 24 minutes at a speed of 300-650 RPM until the material is at a second size range of 100-120 um.

5-38% of the material is removed from the grinding jar and left at this particle size.

In Examples in which bonding material was used, the bonding material was then weighed out at a range of 1-25% if singularly or each at 5-20% if blended and placed into the ball jar with balls of a range between 3-8 mm. The material, with or without bonding material, was then blended in the ball grinding machine (Retsch PM100 and Retsch TM 300) for a range of 1 to 15 minutes at a speed of 100-400 RPM until the material was at a third size range of 30-100 um.

4-54% of the material was removed from the grinding jar and left at this particle size.

In Examples in which setting time enhancer material only was used, the setting time enhancer material was weighed out at a range of 1-25% if singularly or each at 5-20% if blended and placed into the ball jar with balls of a range between 3-8 mm. The material, with or without setting time enhancer material, was then blended in the ball grinding machine (Retsch PM100 and Retsch TM 300) for 1 to 15 minutes at a speed of 100-400 RPM until the material is at a third size range is 5-200 um or 30-100 um. 4-54% of the material is removed from the grinding jar and left at this particle size.

If both a bonding material and a setting time enhancer material were both used, then the bonding material was ground to the third size and the setting time enhancer was ground to a fourth size. If only one or the other, or neither, was used, the material was ground to the third size then further ground to the fourth size.

When both bonding material and a setting time enhancer material were used, after producing the third material, the setting time enhancer material was weighed out at a range of 1-25% if singularly or each at 5-20% if blended and placed into the ball jar with balls of a range between 3-5 mm. The setting time enhancer material is then blended in the ball grinding machine (Retsch PM100 and Retsch TM 300) for a range of 1 to 18 minutes at a speed of 100-550 RPM until the material is at a fourth size range is 0.1-80 um or 0.1-30 um.

8-65% of the material is removed from the grinding jar and left at this particle size.

The cementitious binder, alkaline activator, bonding material (if used) and setting time enhancer (if used) of all particle size were added back into the ball grinding machine and blended for 30 seconds to 2 minutes at a speed of 100-250 RPM.

The material was then weighed out to the desired weight and water add the material is then mixed in a Metcalfe mixer and mixed for between 4-15 minutes.

The material is then cast into a 50×50×50 mm steel mold and left to cure at room temperature 0-50 degrees. Data was collected after the cubes had set and hardened.

### Example 1

Mix Design Example One:
Ground granulated blast slag—65-95%
Micro silica—2-29%
Sodium silica—1-15%
Reactive magnesium oxide—1-12%
Plagioclase—1-15%
Zeolite—1-20%
Water—1-30%

### Overall Data Set

All tests were conducted in triplicate form and the average of the results in the table Below.

| | 7 days | 14 days | 28 days |
|---|---|---|---|
| Compressive (MPa) | 60-304 | 60-357 | 60-400 |
| Tensile (MPa) | 2-35 | 2-49 | 2-58 |
| Modulus of elasticity (GPa) | 3-45 | 3-59 | 3-79 |
| Pore volume range | 0-1% | 0-1.1% | 0-1.1% |
| Water sorptivity coefficient | 0-0.044 | 0-0.044 | 0-0.044 |
| (kg/m²/h^{0.5}) | | | |
| Fire resistance ° C. | 100-1345 | 100-1456 | 100-1487 |
| co₂ emissions reduction | 59-79% | 59-79% | 59-79% |

An exemplary specific mix design of this Example, and corresponding properties, was:
Ground granulated blast slag—19 g
Micro silica—5 g
Sodium silica—3 g
Reactive magnesium oxide—2 g
Plagioclase—3 g
Zeolite—4 g
Water—6 g

Data Set

All tests were conducted in triplicate form and the average of the results in the table below.

| | 7 days | 14 days | 28 days |
|---|---|---|---|
| Compressive (MPa) | 78 | 99 | 148 |
| Tensile (MPa) | 9 | 21 | 39 |
| Modulus of elasticity (GPa) | 6 | 17 | 32 |
| Pore volume range | 0-1% | 0-1.1% | 0-1.1% |
| Water sorptivity coefficient | 0-0.044 | 0-0.044 | 0-0.044 |
| (kg/m²/h^{0.5}) | | | |
| Fire resistance ° C. | 100-1345 | 100-1456 | 100-1487 |
| co₂ emissions reduction | 59-79% | 59-79% | 59-79% |

### Example 2

Mix Design Example Two:
Bauxite tailings—45-95%
Bottom ash—20-85%
Potassium silicate—1-20%
Potassium Hydroxide—1-17%
Calcium oxide—1-11%
Water—1-32%

### Data Set

All tests were conducted in triplicate form and the average of the results in the table below.

| | 7 days | 14 days | 28 days |
|---|---|---|---|
| Compressive (MPa) | 60-257 | 60-269 | 60-287 |
| Tensile (MPa) | 2-39 | 2-53 | 2-54 |
| Modulus of elasticity (GPa) | 3-34 | 3-42 | 3-53 |
| Pore volume range | 0-1.3% | 0-1.4% | 0-1.4% |
| Water sorptivity coefficient | 0-0.056 | 0-0.056 | 0-0.056 |
| (kg/m²/h^{0.5}) | | | |
| Fire resistance ° C. | 100-1567 | 100-567 | 100-1567 |
| co₂ emissions reduction | 65%-83% | 65%-83% | 65%-83% |

An exemplary specific mix design of this Example, and corresponding properties, was:
Bauxite tailings—19 g
Bottom ash—22 g
Potassium silicate—9 g
Potassium Hydroxide—6 g
Calcium oxide—4 g
Water—8 g

### Data Set

All tests were conducted in triplicate form and the average of the results in the table below.

| | 7 days | 14 days | 28 days |
|---|---|---|---|
| Compressive (MPa) | 60-257 | 60-269 | 60-287 |
| Tensile (MPa) | 2-39 | 2-53 | 2-54 |
| Modulus of elasticity | 3-34 | 3-42 | 3-53 |
| (GPa) | | | |
| Pore volume range | 0-1.3% | 0-1.4% | 0-1.4% |
| Water sorptivity | 1-0.056 | 0-0.056 | 1-0.056 |
| coefficient | | | |
| (kg/m²/h^{0.5}) | | | |
| Fire resistance ° C. | 100-1567 | 100-1567 | 100-1567 |
| co₂ emissions reduction | 65%-83% | 65%-83% | 65%-83% |

### Example 3

Mix Design Example Three:
GGBS—40-85%
Fly ash—35-90%
Zeolite—0-35%
Sodium Hydroxide—0-25%
Sodium Silicate—2-31%
Water—5-33%

### Data Set

All tests were conducted in triplicate form and the average of the results in the table below.

| | 7 days | 14 days | 28 days |
|---|---|---|---|
| Compressive (MPa) | 60-134 | 60-284 | 60-312 |
| Tensile (MPa) | 2-15 | 2-34 | 2-46 |
| Modulus of elasticity (GPa) | 3-19 | 3-28 | 3-43 |
| Pore volume range | 0-1.1% | 0-1.2% | 0-1.2% |
| Water sorptivity coefficient | 0-0.034 | 0-0.034 | 0-0.034 |
| (kg/m²/h^{0.5}) | | | |
| Fire resistance ° C. | 100-1421 | 100-1421 | 100-1421 |
| co₂ emissions reduction | 68-91% | 68-91% | 68-91% |

An exemplary specific mix design of this Example, and corresponding properties, was:
GGBS—19 g
Fly ash—11 g
Zeolite—6 g
Sodium Hydroxide—8 g
Sodium Silicate—5 g
Water—6 g

### Data Set

All tests were conducted in triplicate form and the average of the results in the table below.

| | 7 days | 14 days | 28 days |
|---|---|---|---|
| Compressive (MPa) | 79 | 105 | 167 |
| Tensile (MPa) | 8 | 16 | 35 |
| Modulus of elasticity (GPa) | 7 | 14 | 33 |
| Pore volume range | 0-1.1% | 0-1.2% | 1-1.2% |
| Water sorptivity coefficient | 1-0.034 | 0-0.034 | 1-0.034 |
| (kg/m²/h^{0.5}) | | | |
| Fire resistance ° C. | 100-1421 | 100-1421 | 100-1421 |
| co₂ emissions reduction | 68-91% | 68-91% | 68-91% |

### Example 4

Mix Design Example Four:
Hydrated lime—30-95%
Micro silica—3-29%
Potassium silicate—3-28%
Potassium Hydroxide—0-25%
Water—5-31%

### Data Set

All tests were conducted in triplicate form and the average of the results in the table below.

| | 7 days | 14 days | 28 days |
|---|---|---|---|
| Compressive (MPa) | 50-94 | 50-134 | 50-153 |
| Tensile (MPa) | 2-15 | 53 | 54 |
| Modulus of elasticity (GPa) | 4-24 | 4-31 | 4-43 |
| Pore volume range | 0-1.3% | 0-1.4% | 0-1.4% |
| Water sorptivity coefficient | 0-0.056 | 0-0.056 | 0-0.056 |
| (kg/m²/h^{0.5}) | | | |
| Fire resistance ° C. | 100-1437 | 100-1437 | 100-1437 |
| co₂ emissions reduction | 73-83% | 73-83% | 73-83% |

An exemplary specific mix design of this Example, and corresponding properties, was:
Hydrated lime—17 g
Micro silica—8 g
Potassium silicate—6 g
Potassium Hydroxide—7 g
Water—7 g

### Data Set

All tests were conducted in triplicate form and the average of the results in the table below.

| | 7 days | 14 days | 28 days |
|---|---|---|---|
| Compressive (MPa) | 62 | 78 | 98 |
| Tensile (MPa) | 9 | 19 | 23 |
| Modulus of elasticity (GPa) | 6 | 17 | 21 |
| Pore volume range | 0-1.3% | 0-1.4% | 0-1.4% |
| Water sorptivity coefficient | 0-0.056 | 0-0.056 | 0-0.056 |
| (kg/m²/h^{0.5}) | | | |
| Fire resistance ° C. | 100-1437 | 100-1437 | 100-1437 |
| co₂ emissions reduction | 73-83% | 73-83% | 73-83% |

### Example 5

Mix Design Example Five:
Hydrated lime—56-94%
GGBS—34-94%
Sodium Hydroxide—0-25%
Sodium Silicate—0-23%
Zeolite—0-34%
Kiln dust—0-35%
Water—5-29%

### Data Set

All tests were conducted in triplicate form and the average of the results in the table below.

| | 7 days | 14 days | 28 days |
|---|---|---|---|
| Compressive (MPa) | 63-157 | 63-159 | 63-185 |
| Tensile (MPa) | 3-25 | 3-33 | 3-38 |
| Modulus of elasticity (GPa) | 2-29 | 2-34 | 2-41 |
| Pore volume range | 0-1.3% | 0-1.4% | 0-1.4% |
| Water sorptivity coefficient | 0-0.056 | 0-0.056 | 0-0.056 |
| (kg/m²/h^{0.5}) | | | |
| Fire resistance ° C. | 100-1567 | 100-1567 | 100-1567 |
| co₂ emissions reduction | 67-83% | 67-83% | 67-83% |

An exemplary specific mix design of this Example, and corresponding properties, was:
Hydrated lime—15 g
GGBS—12 g
Sodium Hydroxide—6 g
Sodium Silicate—8 g
Zeolite—11 g
Kiln dust—9 g
Water—8 g

### Data Set

All tests were conducted in triplicate form and the average of the results in the table below.

| | 7 days | 14 days | 28 days |
|---|---|---|---|
| Compressive (MPa) | 98 | 132 | 167 |
| Tensile (MPa) | 6 | 18 | 29 |
| Modulus of elasticity (GPa) | 4 | 16 | 26 |
| Pore volume range | 0-1.3% | 0-1.4% | 0-1.4% |
| Water sorptivity coefficient | 0-0.056 | 0-0.056 | 0-0.056 |
| (kg/m²/h^{0.5}) | | | |
| Fire resistance ° C. | 100-1567 | 100-1567 | 100-1567 |
| co₂ emissions reduction | 67-83% | 67-83% | 67-83% |

### Example 6

Mix Design Example Six:
Pond ash—56-94%
Micro Silica—3-34%
GGBS—0-56%
Potassium hydroxide—0-23%
Potassium Silicate—0-34%
Water—5-29%

### Data Set

All tests were conducted in triplicate form and the average of the results in the table below.

| | 7 days | 14 days | 28 days |
|---|---|---|---|
| Compressive (MPa) | 53-111 | 53-132 | 53-143 |
| Tensile (MPa) | 3-17 | 3-21 | 3-32 |
| Modulus of elasticity (GPa) | 2-19 | 2-23 | 2-37 |
| Pore volume range | 0-1.1% | 0-1.1% | 0-1.1% |
| Water sorptivity coefficient | 0-0.033 | 0-0.033 | 0-0.033 |
| (kg/m²/h^{0.5}) | | | |
| Fire resistance ° C. | 100-1343 | 100-1343 | 100-1343 |
| co₂ emissions reduction | 57-84% | 57-84% | 57-84% |

An exemplary specific mix design of this Example, and corresponding properties, was:
Pond ash—14 g
Micro Silica—8 g
GGBS—7 g
Potassium hydroxide—5 g
Potassium Silicate—6 g
Water—8 g

### Data Set

All tests were conducted in triplicate form and the average of the results in the table below.

| | 7 days | 14 days | 28 days |
|---|---|---|---|
| Compressive (MPa) | 63 | 98 | 129 |
| Tensile (MPa) | 7 | 15 | 24 |
| Modulus of elasticity (GPa) | 4 | 9 | 16 |
| Pore volume range | 0-1.1% | 0-1.1% | 0-1.1% |
| Water sorptivity coefficient | 0-0.033 | 0-0.033 | 0-0.033 |
| (kg/m²/h^{0.5}) | | | |
| Fire resistance ° C. | 100-1343 | 100-1343 | 100-1343 |
| co₂ emissions reduction | 57-84% | 57-84% | 57-84% |

### Example 7

Mix Design Example Seven:
Coal ash—56-94%
Fly ash—0-83%
GGBS—0-74%
Sodium Silicate—0-23%
sodium hydroxide—0-34%
Water—5-33%

### Data Set

All tests were conducted in triplicate form and the average of the results in the table below.

| | 7 days | 14 days | 28 days |
|---|---|---|---|
| Compressive (MPa) | 52-115 | 52-124 | 52-145 |
| Tensile (MPa) | 3-19 | 3-23 | 3-29 |
| Modulus of elasticity (GPa) | 2-24 | 2-28 | 2-32 |
| Pore volume range | 0-1.1% | 0-1.1% | 0-1.1% |
| Water sorptivity coefficient | 0-0.053 | 0-0.053 | 0-0.053 |
| (kg/m²/h^{0.5}) | | | |
| Fire resistance ° C. | 100-1432 | 100-1432 | 100-1432 |
| co₂ emissions reduction | 67-89% | 67-89% | 67-89% |

An exemplary specific mix design of this Example, and corresponding properties, was:
Coal ash—12 g
Fly ash—6 g
GGBS—18 g
Sodium Silicate—9 g
sodium hydroxide—11 g
Water—8 g

### Data Set

All tests were conducted in triplicate form and the average of the results in the table below.

| | 7 days | 14 days | 28 days |
|---|---|---|---|
| Compressive (MPa) | 76 | 119 | 139 |
| Tensile (MPa) | 19 | 23 | 29 |
| Modulus of elasticity (GPa) | 16 | 21 | 29 |
| Pore volume range | 0-1.1% | 0-1.1% | 0-1.1% |
| Water sorptivity coefficient | 0-0.053 | 0-0.053 | 0-0.053 |
| (kg/m²/h^{0.5}) | | | |
| Fire resistance ° C. | 100-1432 | 100-1432 | 100-1432 |
| co₂ emissions reduction | 67-89% | 67-89% | 67-89% |

### Example 8

Mix Design Example Eight:
Electric Arc Furnace slag—56-94%
Potassium Hydroxide—0-25%
Potassium Silicate—0-23%
Pyroxene—0-34%
VCAS—0-35%
Water—5-29%

### Data Set

All tests were conducted in triplicate form and the average of the results in the table below.

| | 7 days | 14 days | 28 days |
|---|---|---|---|
| Compressive (MPa) | 52-137 | 52-148 | 52-165 |
| Tensile (MPa) | 3-16 | 3-22 | 3-29 |
| Modulus of elasticity (GPa) | 2-18 | 2-27 | 2-36 |
| Pore volume range | 0-1.1% | 0-1.1% | 0-1.1% |
| Water sorptivity coefficient | 0-0.057 | 0-0.057 | 0-0.057 |
| (kg/m²/h^{0.5}) | | | |
| Fire resistance ° C. | 100-1345 | 100-1345 | 100-1345 |
| co₂ emissions reduction | 62-91% | 62-91% | 62-91% |

An exemplary specific mix design of this Example, and corresponding properties, was:
Electric Arc Furnace slag—21 g
Potassium Hydroxide—8 g
Potassium Silicate—9 g
Pyroxene—11 g
VCAS—8 g
Water—9 g

### Data Set

All tests were conducted in triplicate form and the average of the results in the table below.

| | 7 days | 14 days | 28 days |
|---|---|---|---|
| Compressive (MPa) | 99 | 127 | 158 |
| Tensile (MPa) | 15 | 22 | 29 |
| Modulus of elasticity (GPa) | 13 | 25 | 31 |
| Pore volume range | 0-1.1% | 0-1.1% | 0-1.1% |
| Water sorptivity coefficient | 0-0.057 | 0-0.057 | 0-0.057 |
| (kg/m²/h^{0.5}) | | | |
| Fire resistance ° C. | 100-1345 | 100-1345 | 100-1345 |
| co₂ emissions reduction | 62-91% | 62-91% | 62-91% |

### Example 9

Mix Design Example Nine:
Copper Tailing—56-94%
Kiln dust—34-94%
Magnesium Hydroxide—0-25%
Sodium Silicate—0-23%
Zeolite—0-34%
Water—5-29%

### Data Set

All tests were conducted in triplicate form and the average of the results in the table below.

| | 7 days | 14 days | 28 days |
|---|---|---|---|
| Compressive (MPa) | 49-134 | 49-149 | 49-178 |
| Tensile (MPa) | 3-18 | 3-26 | 3-34 |
| Modulus of elasticity (GPa) | 2-21 | 2-29 | 2-32 |
| Pore volume range | 0-1.2% | 0-1.2% | 0-1.2% |
| Water sorptivity coefficient | 0-0.059 | 0-0.059 | 0-0.059 |
| (kg/m²/h^{0.5}) | | | |
| Fire resistance ° C. | 100-1432 | 100-1432 | 100-1432 |
| co₂ emissions reduction | 62-84% | 62-84% | 62-84% |

An exemplary specific mix design of this Example, and corresponding properties, was:
Copper Tailing—16 g
Kiln dust—13 g
Magnesium Hydroxide—8 g
Sodium Silicate—9 g
Zeolite—12 g
Water—8 g

### Data Set

All tests were conducted in triplicate form and the average of the results in the table below.

| | 7 days | 14 days | 28 days |
|---|---|---|---|
| Compressive (MPa) | 78 | 112 | 156 |
| Tensile (MPa) | 8 | 22 | 31 |
| Modulus of elasticity (GPa) | 6 | 16 | 24 |
| Pore volume range | 0-1.2% | 0-1.2% | 0-1.2% |
| Water sorptivity coefficient | 0-0.059 | 0-0.059 | co0-0.059 |
| (kg/m²/h^{0.5}) | | | |
| Fire resistance ° C. | 100-1432 | 100-1432 | 100-1432 |
| co₂ emissions reduction | 62-84% | 62-84% | 62-84% |

### Example 10

Mix Design Example Ten:
Bottom ash—56-94%
Calcium Aluminates—34-94%
Sodium Hydroxide—0-25%
Feldspathic materials—0-35%
Sodium Silicate—0-23%
Cement kiln dust—0-35%
Water—5-29%

### Data Set

All tests were conducted in triplicate form and the average of the results in the table below.

| | 7 days | 14 days | 28 days |
|---|---|---|---|
| Compressive (MPa) | 51-127 | 51-149 | 51-165 |
| Tensile (MPa) | 3-18 | 3-24 | 3-31 |
| Modulus of elasticity (GPa) | 2-24 | 2-28 | 2-33 |
| Pore volume range | 0-1.2% | 0-1.2% | 0-1.2% |
| Water sorptivity coefficient | 0-0.065 | 0-0.065 | 0-0.065 |
| (kg/m²/h^{0.5}) | | | |
| Fire resistance ° C. | 100-1231 | 100-1231 | 100-1231 |
| co₂ emissions reduction | 56-86% | 56-86% | 56-86% |

An exemplary specific mix design of this Example, and corresponding properties, was:
Bottom ash—19 g
Calcium Aluminates—10 g
Sodium Hydroxide—8 g
Feldspathic materials—6 g
Sodium Silicate—5 g
Cement kiln dust—9 g
Water—11 g

### Data Set

All tests were conducted in triplicate form and the average of the results in the table below.

| | 7 days | 14 days | 28 days |
|---|---|---|---|
| Compressive (MPa) | 69 | 95 | 124 |
| Tensile (MPa) | 6 | 15 | 29 |
| Modulus of elasticity (GPa) | 5 | 13 | 26 |
| Pore volume range | 0-1.2% | 0-1.2% | 0-1.2% |
| Water sorptivity coefficient | 0-0.065 | 0-0.065 | 0-0.065 |
| (kg/m²/h^{0.5}) | | | |
| Fire resistance ° C. | 100-1231 | 100-1231 | 100-1231 |
| co₂ emissions reduction | 56-86% | 56-86% | 56-86% |

### Example 11: Admixture Preparation

In this Example, a mixture of potassium silicate and potassium hydroxide, i.e., admixture, was prepared by contacting a liquid potassium silicate solution with dry, flaked potassium hydroxide (FIG. 1). Admixture was prepared according to seven different recipes corresponding to seven different molar ratios of SiO₂ to OH, from 1 to 1.6 as shown in Table 1.

Potassium silicate solution was added to a 30 L plastic bucket with a lid based on a desired admixture formulation Table 1, for example, 3200 g of potassium silicate when preparing Admixture 4). The amount of potassium silicate added was confirmed by weighing the material. Potassium hydroxide was added to a separate plastic bucket, in an amount based on the desired admixture formulation Table 1; for example 1180 g of potassium hydroxide when preparing Admixture 4). The potassium hydroxide was then slowly combined with the potassium silicate mixture while stirring with a wooden stick. Once distributed, a lid was placed on the bucket without sealing completely. The lid was removed, the mixture stirred, and the temperature measured every 5 minutes. If the temperature of the mixture reached >105° C., a hose was used to flush cold water on the exterior of the bucket to cool the mixture (to preserve the integrity of the bucket). Once the temperature began to decrease, the solution was stirred every five minutes for an additional 20 minutes. Once the temperature of the mixture reached 30-40° C., the mixture was stirred an additional time and left for 24 hours before use.

TABLE 1
Admixture recipes

| | | Potassium | Potassium |
|---|---|---|---|
| | Molar | silicate | hydroxide |
| | ratio | [g] | [g] |
| Admixture 1 | 1 | 1000 | 572.1 |
| Admixture 2 | 1.1 | 1000 | 479.6 |
| Admixture 3 | 1.2 | 1000 | 402.6 |
| Admixture 4 | 1.25 | 3200 | 1180 |
| Admixture 5 | 1.3 | 3200 | 1080 |
| Admixture 6 | 1.4 | 3200 | 901 |
| Admixture 7 | 1.5 | 3200 | 746 |

This Example demonstrates that admixture can be prepared with different molar ratios of SiO₂ to OH.

### Example 12: Preparation of an Ultra-High Strength Cement and Concrete

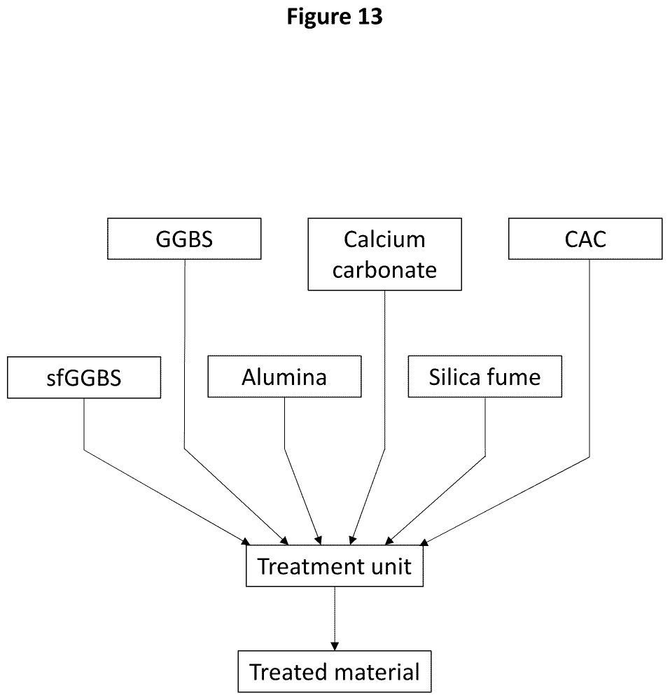

In this Example, an ultra-high strength cement was produced from ground granulated blast furnace slag (GGBS), calcium carbonate, calcium aluminate cement (CAC), superfine ground granulated blast furnace slag (with a median particle size of 10 um or lower; sfGGBS), alumina, and silica fumes (one or both of which can act as alkaline activator) (FIG. 13). The materials (amounts shown in Table 2) were fed continuously into the impact mixer shown in FIGS. 5 and 6 and treated in the impact mixer. The average particle size of each material before and after treatment are shown in Table 3. The impact mixer was a modified Hosokawa Flexomix fx160 (Netherlands), wherein each of the 12 blade sets were modified to taper to a distal dimension (FIG. 11; 1105) half the width of the proximal dimension, i.e., at the blade base (FIG. 11; 1102), and positioned at an angle (FIGS. 12; 1206 and 1207) of 75° from the horizontal (FIG. 12; 1205). The flow rate of each material from the hopper to the impact mixer was calibrated based on the relative amounts of each material as shown in Table 2. The total, combined flow rate of material to the impact mixer was 3,800 kg/hr, the blade rotation was set to 1,200 RPM. Material was passed continuously into the impact mixer, with an average residence time in the impact mixer of 2 seconds. The treated material then moved to an outlet for transfer to storage.

TABLE 2
Ultra-high strength concrete formulation

| | Ultra-high | |
|---|---|---|
| | strength | Acceptable |
| | composition | ranges |
| Material | [g] | [g] |
| Ground granulated blast furnace slag | 850 | 500-850 |
| Calcium carbonate | 125 | 0-125 |
| Calcium aluminate cement | 125 | 0-125 |
| Superfine ground granulated blast | 55 | 0-55 |
| furnace slag (sub 10 um) | | |
| Alumina | 12 | 0-12 |
| Silica fume | 60 | 5-60 |
| Admixture 4 | 350 | 50-350 |
| Aggregate (AGG 1 + CB Quartz | 2000 | N/A |
| only 1-3r eplaced) | | |
| Basalt fibre (6 mm) | 30 | N/A |
| Water | 100 | N/A |
| Chemcrete 100 plus from Larsen | 30 | N/A |
| Building Products (HP3) | | |

TABLE 3
Average starting and ending particle sizes

| | Average | Average |
|---|---|---|
| | starting | ending |
| | particle | particle |
| | size | size |
| Material | [um] | [um] |
| Ground granulated blast furnace slag | 20 | 6 |
| Calcium carbonate | 30 | 10 |
| Calcium aluminate cement | 50 | 30 |
| Superfine ground granulated blast | 10 | 5 |
| furnace slag (sub 10 um) | | |
| Alumina | 45 | 20 |
| Silica fume | 3 | 0.3 |

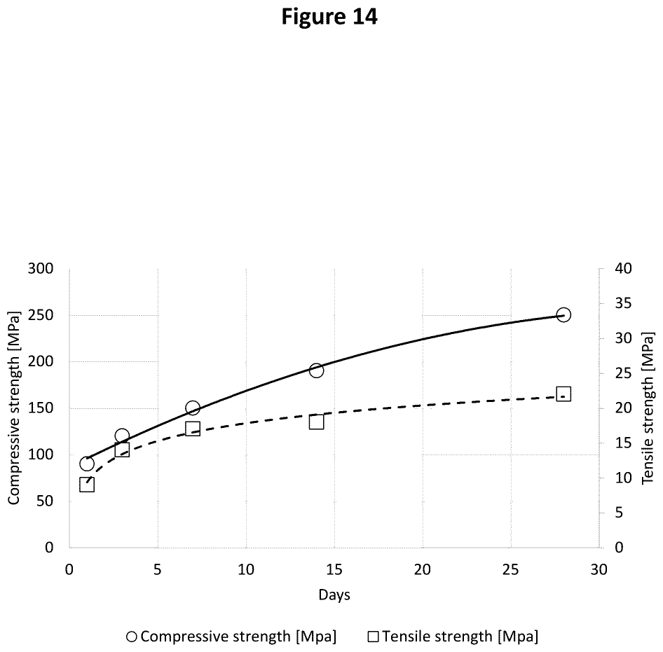

An ultra-high strength concrete was then prepared using the ultra-high strength cement describe above by combining and mixing with water, aggregates, Admixture 4 (as shown in Example 1), basalt fibre, and Chemcrete 100 plus from Larsen Building Products (HP3) (amounts shown in Table 2). The ultra-high strength concrete demonstrated an initial set time of 2.25 minutes, wherein the concrete demonstrated a gelatinous consistency, and a final set time of 8.5 minutes, wherein the mold can be removed. The compressive and tensile strengths of the concrete over 1-28 days are shown in FIG. 14. Specifically, FIG. 14 shows compressive strength (primary axis, open circles, solid line) and tensile strength (second axis, open squares, dashed line) as a function of time. The ultra-high strength concrete demonstrated a compressive strength of 90, 120, 150, 190, and 250 MPa at 1, 3, 7, 14, and 28 days respectively, and a tensile strength of 9, 14, 17, 18, and 22 MPa at 1, 3, 7, 14, and 28 days respectively.

The carbon dioxide savings, calculated by life cycle assessment (LSA), compared to preparation and use of an equivalent amount of ordinary Portland cement (OPC), was 70%. It will be appreciated that, given the extremely high strength of concrete produced with the cement of this Example, even greater savings can be realized by reducing the amount of cement used in the concrete.

This Example demonstrates than an ultra-high strength cement can be produced in a rapid, continuous, one-step process from materials comprising mostly industrial waste materials, in which ingredients are subjected to impact mixing, rather than, e.g., grinding or milling, and that the cement can be used to produce ultra-high strength concrete, with a rapid setting time and final compressive strengths far higher than typical concrete, at a fraction of the carbon dioxide production of concrete made with typical cement, e.g., OPC.

### Example 13: Preparation of a High Strength Cement and Concrete

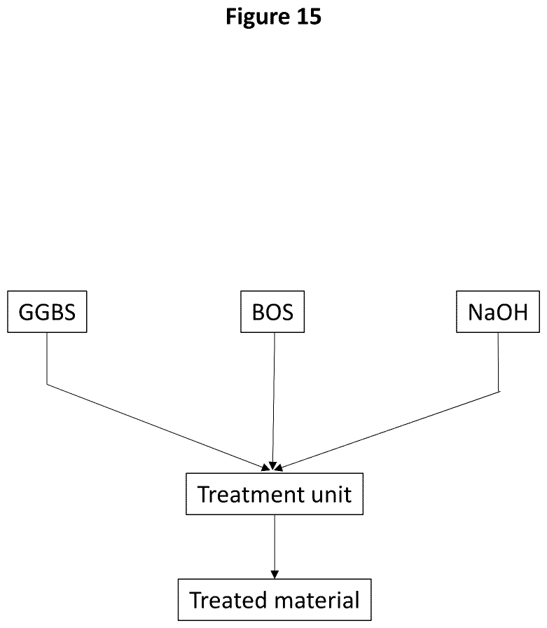

In this Example, a high strength cement was produced from ground granulated blast furnace slag (GGBS), basic oxygen slag (BOS), and sodium hydroxide (FIG. 15). The materials (amounts shown in Table 4) were fed continuously into the impact mixer shown in FIGS. 5 and 6 and treated in the impact mixer. The average particle size of each material before and after treatment are shown in Table 5. The impact mixer was a modified Hosokawa Flexomix fx160 (Netherlands), wherein each of the 12 blade sets were modified taper to a distal dimension (FIG. 11; 1105) half the width of the proximal dimension, i.e., at the blade base (FIG. 11; 1102), and positioned at an angle (FIGS. 12; 1206 and 1207) of 48° from the horizontal (FIG. 12; 1205). The flow rate of each material from the hopper to the impact mixer was calibrated based on the relative amounts of each material as shown in Table 4. The total, combined flow rate of material to the impact mixer was 4,200 kg/hr, the blade rotation was set to 1,500 RPM. Material was passed continuously into the impact mixer, with an average residence time in the impact mixer of 1.2 seconds. The treated material then moved to an outlet for transfer to storage.

TABLE 4
High strength cement formulation

| | Optimal | Range |
|---|---|---|
| Material | [%] | [%] |
| Ground granulated blast furnace slag | 39 | 24-39 |
| Basic oxygen slag | 2.7 | 0-5.3 |
| Sodium hydroxide | 1.5 | 0.8-6.2 |
| Admixture 4 | 0.6 | 0-4.4% |
| Aggregate (AGG 1 + CB Quartz | 53.5 | N/A |
| only 1-3 replaced) | | |
| Water | 2.7 | N/A |

TABLE 5
Average starting and ending particle sizes

| | Average | Average |
|---|---|---|
| | starting | ending |
| | particle | particle |
| | size | size |
| Material | [um] | [um] |
| Ground granulated blast | 20 | 6 |
| furnace slag | | |
| Basic oxygen slag | 300 | 50 |
| Sodium hydroxide | 400 | 30 |

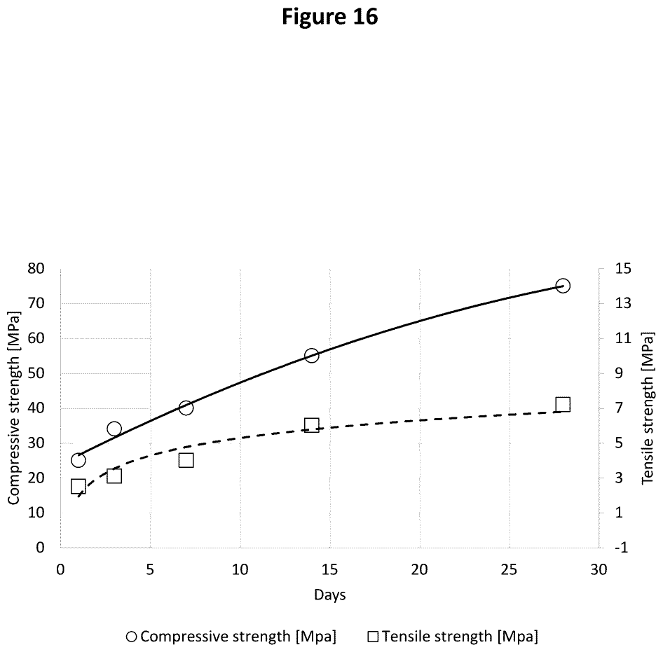

A high strength concrete was prepared using high strength cement describe above by combining and mixing with water, aggregates, and Admixture 4 (as shown in Example 1) (amounts shown in Table 4). The high strength concrete demonstrated an initial set time of 45 minutes, wherein the concrete demonstrated a gelatinous consistency, and a final set time of 180 minutes, wherein the mould can be removed. The compressive and tensile strengths of the concrete over 1-28 days are shown in FIG. 16. Specifically, FIG. 16 shows compressive strength (primary axis, open circles, solid line) and tensile strength (second axis, open squares, dashed line) as a function of time. The high strength concrete demonstrated a compressive strength of 25, 34, 40, 55, and 75 MPa at 1, 3, 7, 14, and 28 days respectively, and a tensile strength of 2.5, 3.1, 4, 6, and 7.2 MPa at 1, 3, 7, 14, and 28 days respectively.

The carbon dioxide savings, calculated by life cycle assessment (LSA), compared to preparation and use of an equivalent amount of ordinary Portland cement (OPC), was 85%. It will be appreciated that, given the high strength of concrete produced with the cement of this Example, even greater savings can be realized by reducing the amount of cement used in the concrete.

This Example demonstrates than an high strength cement can be produced in a rapid, continuous, one-step process where only three ingredients are combined, two of which are industrial waste materials, in which ingredients are subjected to impact mixing, rather than, e.g., grinding or milling, and that the cement can be used to produce high strength concrete, with a rapid setting time and final compressive strengths higher than typical concrete, at a fraction of the carbon dioxide production of concrete made with typical cement, e.g., OPC.

### Example 14: Preparation of Near-Carbon Neutral Cement and Concrete

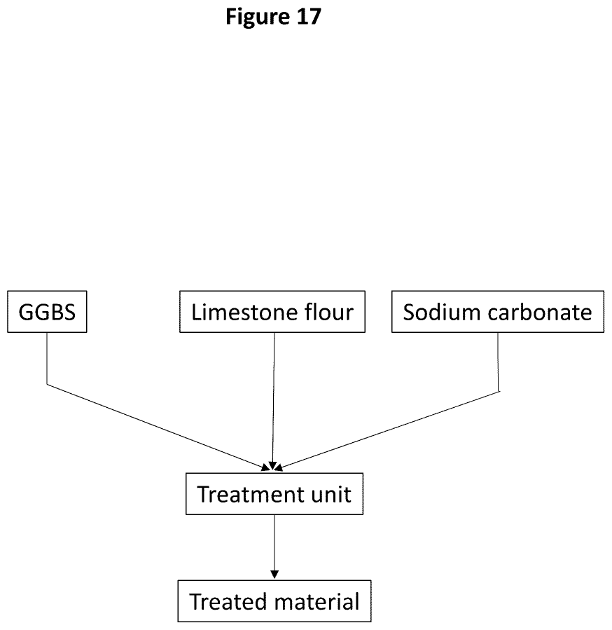

In this Example, four near-carbon neutral cement mixes were produced from ground granulated blast furnace slag (GGBS), limestone flour, and sodium carbonate (FIG. 17). The materials (amounts shown in Table 6) were fed continuously into the impact mixer shown in FIGS. 5 and 6 and treated in the impact mixer. The average particle size of each material before and after treatment are shown in Table 7. The impact mixer was a modified Hosokawa Flexomix fx160 (Netherlands), wherein each of the 12 blade sets were modified to taper to a distal dimension (FIG. 11; 1105) half the width of the proximal dimension, i.e., at the blade base (FIG. 11; 1102), and positioned at an angle (FIGS. 12; 1206 and 1207) of 68° from the horizontal (FIG. 12; 1205). The flow rate of each material from the hopper to the impact mixer was calibrated based on the relative amounts of each material as shown in Table 6. The total, combined flow rate of material to the impact mixer was 3,600 kg/hr, the blade rotation was set to 1,800 RPM. Material was passed continuously into the impact mixer, with an average residence time in the impact mixer of 1.2 seconds. The treated material then moved to an outlet for transfer to storage.

TABLE 6
Near-carbon neutral cement formulation

| | Mix 1 | Mix 2 | Mix 3 | Mix 4 | Range |
|---|---|---|---|---|---|
| Material | [%] | [%] | [%] | [%] | [%] |
| GGBS | 12.2 | 13.1 | 12.7 | 21.9 | 12.2-32 |
| Limestone flour | 27.6 | 26.4 | 25.4 | 16.6 | 3.5-31.2 |
| Sodium | 3.5 | 3 | 5.3 | 4 | 0-8 |
| Carbonate | | | | | |
| Sodium | 0 | 0 | 0 | 0 | 0-7.1 |
| hydroxide liquid | | | | | |
| Potassium | 0.5 | 1.3 | 0 | 0 | 0-6.2 |
| hydroxide liquid | | | | | |
| Bullet B MR | 0 | 0 | 0.4 | 1.3 | 0-8.8 |
| 1.25 | | | | | |
| Aggregate | 53.5 | 53.5 | 53.5 | 53.5 | N/A |
| water | 2.7 | 2.7 | 2.7 | 2.7 | N/A |

TABLE 7
Average starting and ending particle sizes

| | Average | Average |
|---|---|---|
| | starting | ending |
| | particle | particle |
| | size | size |
| Material | [um] | [um] |
| Ground granulated blast | 20 | 6 |
| furnace slag | | |
| Limestone flour | 80 | 25 |
| Sodium carbonate | 400 | 30 |

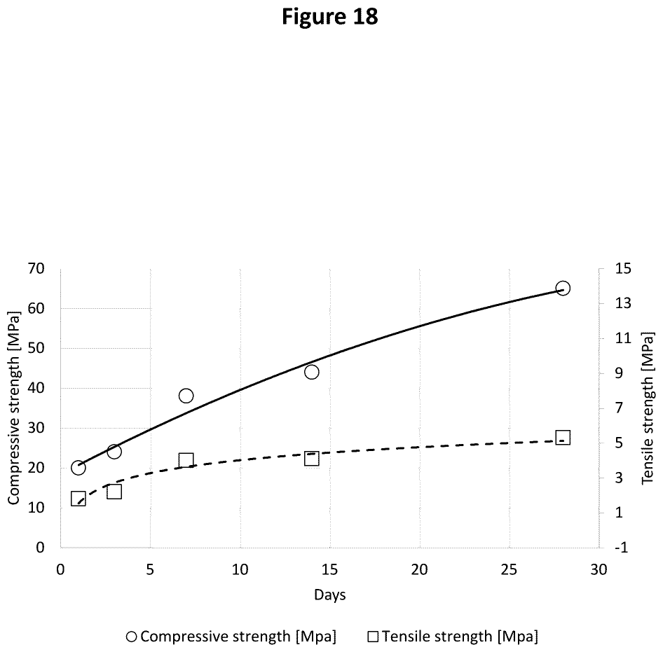

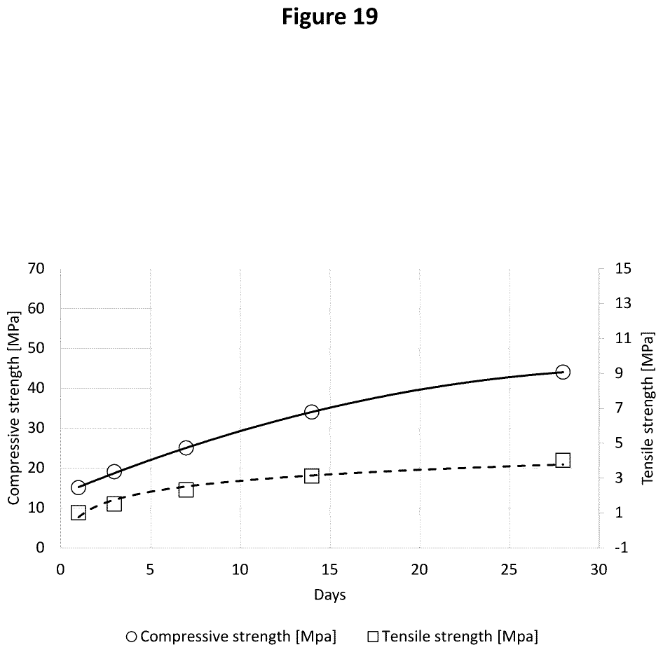

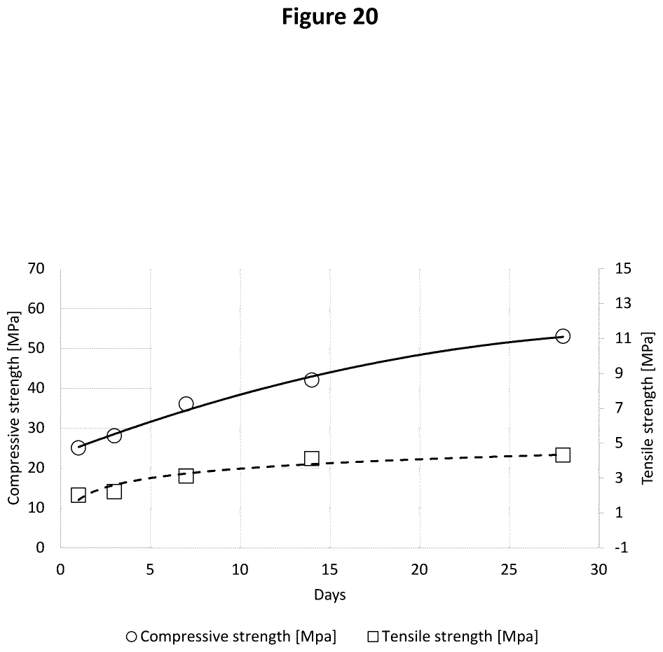

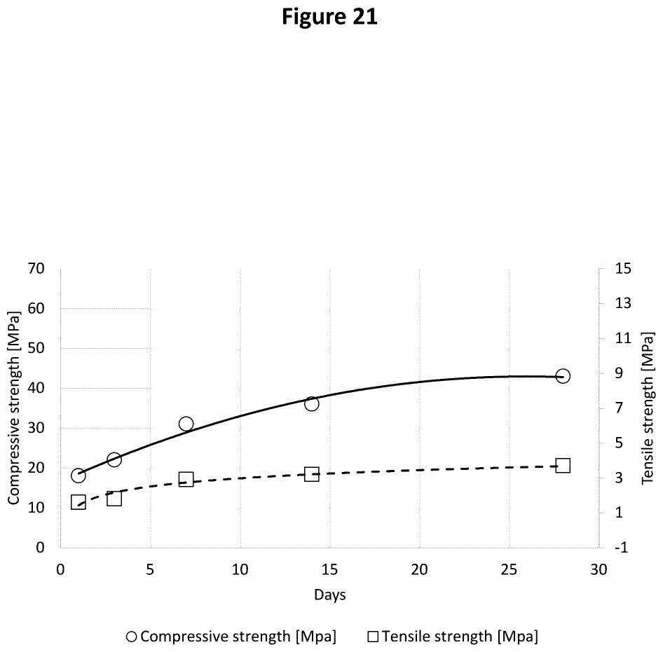

Four near-carbon neutral concretes were prepared using the four near-carbon neutral cements describe above by combining/mixing with water, aggregates, and one of Admixture 4 (as shown in Example 1), sodium hydroxide, or potassium hydroxide (amounts shown in Table 6. The near-carbon neutral concrete demonstrated an initial set time of 65 minutes, wherein the concrete demonstrated a gelatinous consistency, and a final set time of 210 minutes, wherein the mold can be removed. The compressive and tensile strengths of the concrete over 1-28 days are shown in FIGS. 18-21 for mixes 1-4. Specifically, FIGS. 18-21 shows compressive strength (primary axis, open circles, solid line) and tensile strength (second axis, open squares, dashed line) as a function of time. Mix 1 concrete demonstrated a compressive strength of 20, 24, 38, 44, and 65 MPa at 1, 3, 7, 14, and 28 days respectively, and a tensile strength of 1.8, 2.2, 4, 4.1, and 5.3 MPa at 1, 3, 7, 14, and 28 days respectively (FIG. 18). Mix 2 concrete demonstrated a compressive strength of 15, 19, 25, 34, and 44 MPa at 1, 3, 7, 14, and 28 days respectively, and a tensile strength of 1, 1.5, 2.5, 3.1, and 4 MPa at 1, 3, 7, 14, and 28 days respectively (FIG. 19). Mix 3 concrete demonstrated a compressive strength of 25, 28, 36, 42, and 53 MPa at 1, 3, 7, 14, and 28 days respectively, and a tensile strength of 2, 2.2, 3.1, 4.1, and 4.3 MPa at 1, 3, 7, 14, and 28 days respectively (FIG. 20). Mix 4 concrete demonstrated a compressive strength of 18, 22, 31, 36, and 43 MPa at 1, 3, 7, 14, and 28 days respectively, and a tensile strength of 1.6, 1.8, 2.9, 3.2, and 3.7 MPa at 1, 3, 7, 14, and 28 days respectively (FIG. 21). Mix 1 demonstrated the highest compressive and tensile strengths at 28 days.

The carbon dioxide savings, calculated by life cycle assessment (LSA), compared to preparation and use of an equivalent amount of ordinary Portland cement (OPC), was 95% for all four mixes.

This Example demonstrates than nearly carbon neutral cement can be produced in a rapid, continuous, one-step process in which ingredients are subjected to impact mixing, rather than, e.g., grinding or milling, and that the cement can be used to produce concrete, with a rapid setting time and final compressive strengths in ranges suitable for most uses, with nearly zero carbon dioxide production.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for treating producing one or more cementitious products comprising
(i) introducing starting materials comprising one or more cement precursors and one or more alkaline activating agents into an impact mixer; and
(ii) subjecting the starting materials to impact mixing in the mixer, to produce the one or more cementitious products that exit the mixer.

2. The method of claim 1 wherein the one or more cement precursors comprises one or more of lagoon ash, basic oxygen slag (BOS), electric arc furnace (EAF) slag, mill scale, desulferization slag, black/white slag, fly ashes, blast furnace flue dust, red mud, and/or iron ore agglomerate.

3. The method of claim 1 wherein the one or more alkaline activating agents comprise one or more of potassium silicate, potassium hydroxide, sodium hydroxide, sodium silicate, calcium hydroxide, magnesium hydroxide, reactive magnesium oxide, calcium chloride, sodium carbonate, silicone dioxide, sodium aluminate, calcium sulfate, sodium sulfate, or dolomite, or a combination thereof.

4. The method of claim 1 wherein the starting materials are introduced into the impact mixer in a single feed stream.

5. The method of claim 1 wherein the process is a continuous process.

6. The method of claim 1 wherein the one or more cementitious products comprise geopolymer cement.

7. The method of claim 1 wherein the starting materials reside in the impact mixer for 2 to 200 seconds.

8. The method of claim 1 wherein the impact mixer comprises (a) a conduit operably connected one or more sources of the starting materials and to the impact mixer, to introduce the starting materials into the impact mixer, and (b) a shaft to which are attached one or more blades, wherein the shaft and the blades are enclosed in a cylindrical chamber that is operably connected to the conduit, wherein the impact mixer is configured to rotate the shaft at a desired rate.

9. The method of claim 8 wherein the one or more blades comprise 4-28 blades.

10. The method of claim 8 wherein the shaft is vertical and the blades are positioned at an angle relative to horizontal that is 45-75°.

11. The method of claim 8 wherein each blade comprises a base, having a first length, attached to a hub that is further attached to the shaft, and a tip, distal to the proximal base and having a second length, wherein the surface of the tip is adjacent to but not in contact with the cylindrical chamber.

12. The method of claim 11 wherein a ratio of the second length to the first length is 0.2-0.8.

13. The method of claim 1 wherein one or more of the starting materials is pre-processed before being introduced into the mixer, wherein the pre-processing comprises crushing, treatment with ultrasound, treatment with microwave, or any combination thereof.

14. The method of claim 8 wherein the shaft is rotated at 500-5000 RPM.

15. The method of claim 1 wherein no exogenous heat is supplied to the materials during the process.

16. The method of claim 1 wherein the one or more cementitious materials that exit the mixer are ready to use with no further processing.

17. A system for producing cementitious material, wherein the system comprises (i) a source of one or more cement precursors; (ii) a source of one or more alkaline activating agents; and (iii) an impact mixer, operably connected to the source of one or more cement precursors and the source of one or more alkaline activating agents, configured to treat the starting materials to produce a cementitious product.

18. The system of claim 17 wherein the impact mixer comprises (a) a conduit operably connected to the source of one or more cement precursors and to the source of one or more alkaline activating agents, (b) a shaft to which are attached one or more blades, wherein the shaft and the blades are enclosed in a cylindrical chamber that is operably connected to the conduit, wherein the impact mixer is configured to rotate the shaft at a desired rate.

19. The system of claim 18 wherein the one or more blades comprise 10-20 blades.

20. The system of claim 18 wherein the shaft is vertical and the blades are positioned at an angle relative to horizontal that is 25-75°.

21. The system of claim 18 wherein each blade comprises a base, having a first length, attached to a hub that is further attached to the shaft, and a tip, distal to the proximal base and having a second length, wherein the surface of the tip is adjacent to but not in contact with the cylindrical chamber.

22. The system of claim 21 wherein a ratio of the second length to the first length is 0.2-0.8.

23. The system of claim 18 wherein the cylinder is vertical and the conduit is positioned at an angle to the cylinder of 30-60° from vertical

24. The system of claim 17 wherein the impact mixer comprises an exit through which cementitious product exits the mixer.

25. The system of claim 24 further comprising a processing system operably connected to the exit for processing the cementitious product.

26. The system of claim 25 wherein the processing system is configured to package the cementitious product for transport to an end user.

27. The system of claim 17 further comprising one or more pre-processing units operably connected to the one or more sources of starting materials, to pre-process the starting materials before introduction into the impact mixer, wherein the pre-processing units are configured to crush starting materials, treat starting materials with ultrasound, treat starting materials with microwave, or any combination thereof.

28. The system of claim 18 wherein the system is configured to rotate the shaft, e.g., by a motor, at a speed of 500-5000 RPM.

29. The system of claim 18 wherein the system is configured for continuous operation.

30. The system of claim 18 wherein the system is configured to treat the starting materials to produce a cementitious product in 2 to 200 seconds.
